(19) United States
(12) Patent Application Publication
(10) Pub. No.: US 2014/0071255 A1
(43) Pub. Date: Mar. 13, 2014

(54) LIGHT SOURCE CONTROL DEVICE AND VIDEO DISPLAY DEVICE

(71) Applicant: Panasonic Corporation, Osaka (JP)

(72) Inventors: Tetsuro Okuyama, Osaka (JP); Akio Nishimura, Osaka (JP); Toshikazu Ohtsuki, Osaka (JP); Daisuke Miyazaki, Nara (JP)

(73) Assignee: PANASONIC CORPORATION, Osaka (JP)

(21) Appl. No.: 14/001,579

(22) PCT Filed: Dec. 27, 2012
(86) PCT No.: PCT/JP2012/008405

§ 371 Date: Aug. 26, 2013

(30) Foreign Application Priority Data
Dec. 28, 2011 (JP) 2011-289716

(51) Int. Cl. H04N 13/04; F21V 13/00

(52) U.S. Cl. CPC H04N 13/0418; F21V 13/00
USPC 348/55; 362/269; 362/259; 348/54

(57) ABSTRACT

A light source control device comprises a light source unit which emits parallel beams from an arbitrary position along a second axial direction which is orthogonal to a first axial direction, a light source control unit which controls an emitting position of the parallel beams of the light source unit, one or more deflectors which deflects the parallel beams emitted from the light source unit, and a first diffuser which diffuses the light beam, deflected by the deflector, in a third axial direction which is orthogonal to the first axial direction and the second axial direction, wherein the deflector is disposed to be tilted relative to the first axial direction, and yields a different deflection operation in a first element direction which is orthogonal to the deflector's own optical axis direction and in a second element direction which is orthogonal to both the optical axis direction and the first element direction.

### TECHNICAL FIELD

The present invention relates to a video display device such as a display and to a light source control device that is used in such a video display device, and in particular relates to a video display device and a light source control device which allow a plurality of persons to view a 3D video, without having to use any special glasses, from unconfined positions.

### BACKGROUND ART

In recent years, as a system of displaying a 3D video, a system which realizes a stereoscopic view by using glasses and showing, via time division, the parallax images of the right-eye and the left-eye respectively only to the viewer's right eye or left eye, has been put into practical application. Nevertheless, with this system, a viewer is required to constantly wear glasses, and there was a drawback in that the glasses are extremely bothersome.

Meanwhile, as a system which enables a stereoscopic view without the viewer having to wear glasses or the like, known are a parallax barrier system and a lenticular lens system.

The parallax barrier system is a system where, for instance, by installing a barrier in front of the display, the light beams that reach the viewer's left and right eyes are subject to space division for each pixel. With this parallax barrier system, upon displaying a video on the display, a stereoscopic view with a naked eye is realized by synthesizing the video and displaying the video on the entire screen such that the parallax image of the left eye is displayed as the pixels corresponding to the left eye and the parallax image of the right is displayed as the pixels corresponding to the right eye.

Meanwhile, the lenticular lens system is a system where, for example, by installing a lenticular lens array in front of the display, the light that reaches the viewer's left and right eyes is subject to space division based on the refractive effect of the lens. The remaining video displaying method is the same as the parallax barrier system.

These systems are based on a simple principle and an environment for enabling a stereoscopic view can be easily constructed, but have the following three drawbacks.

The first drawback is that, as described above, since the pixels of the display are respectively allocated to the left-eye and the right-eye, the video viewed by the viewer will have a resolution that has deteriorated to at least ½ in comparison to the original resolution of the display.

The second drawback is that, based on the positional relation of the display and the barrier or lenticular lens array, the optimal position of viewing a 3D video will be limited. With respect to this point, while the viewable range can be expanded by broadening the opening, this in turn will prevent the video of the left eye and the video of the right eye from becoming separated, thereby generating crosstalk. Since the crosstalk and the viewable range are of a trade-off relation, there is a drawback in that the viewer cannot view a 3D video from an unconfined position. In addition, in relation to the drawback in which the viewing position is limited, there is also the drawback of a pseudoscopic view in which the correspondence of the parallax video that enters the left and right eyes becomes reversed.

The third drawback is that standard 2D video and 3D video cannot be switched and displayed.

In order to resolve the foregoing problems, with the 3D image display device of Patent Document 1, a mask pattern in which openings and shielding parts are aligned and a lenticular lens are disposed between a surface light source and a transmissive display so as to enable the switching and display of a 2D video and a 3D video. Here, the 3D video display method is in accordance with the lenticular lens system.

Moreover, the 3D image display device of Patent Document 2 uses an imaging device and the like in addition to the configuration of Patent Document 1 so as to detect the viewer's pupil position, and comprises means for optimizing the placement of a checkered mask pattern. Consequently, the range that the viewer can view a favorable 3D video is expanded.

In addition, a stereoscopic view system that is different from the parallax barrier system and the lenticular lens system is also being proposed. For example, Patent Document 3 discloses a 3D video display device configured from a lens array, a plurality of light sources that are incidental to the respective lenses, an optical element for diffusing the light beam in a vertical direction, and a video-displaying transmissive display.

With this 3D video display device, the lens array is configured such that a plurality of cylindrical lenses are overlapped in the longitudinal direction of the display while little by little displacing the optical axis of the respective cylindrical lenses in the horizontal direction. With this lens array, for instance, a plurality of LED (Light Emitting Diode) light sources are incidental on the entrance plane side, and the direction of the emitted light beams can be changed by selecting the light source to emit light among the plurality of light sources. Moreover, by providing an aperture inside the cylindrical lens, the emitted light beam will become a light beam with a defined width in the horizontal direction based on the aperture. As a result of using the foregoing lens array, a light beam having a defined width in the horizontal direction can be emitted while controlling the horizontal deflection angle.

Moreover, by using an optical element which diffuses the light beam in a vertical direction to diffuse a plurality of light beams emitted from the lens array, in which the deflection thereof in the horizontal direction has been controlled, to be greater than the height of the video-displaying transmissive display, the entire video-displaying transmissive display can be irradiated.

Moreover, by forming an exit pupil at a pupil position of the viewer of the video-displaying transmissive display while satisfying the conditions of the entire video-displaying transmissive display being irradiated regarding each of the deflected light beams, the video displayed on the video-displaying transmissive display can be viewed only at the viewer's viewpoint position.

In addition, by forming an exit pupil at the viewer's left/right pupil positions based on time division and synchronously displaying the left and right parallax videos on the video-displaying transmissive display, a stereoscopic view can be realized without requiring any glasses.

With the foregoing system, since an exit pupil can be formed at an arbitrary position within the viewable range, there is an advantage in that the restriction of the viewable range can be reduced in comparison to the parallax barrier system and the lenticular lens system by dynamically changing the exit pupil simultaneously with detecting the viewer's pupil position using an imaging device or the like. Moreover, since the 3D video display is based on time division, there is no degradation of resolution in comparison to a 2D video display.

Nevertheless, while the 3D image display device of Patent Document 1 has cleared the problem of switching between a 2D video display and a 3D video display described above, since the 3D video display system is based on the lenticular lens system, the remaining two drawbacks; namely, degradation of resolution and restriction of viewing position still remain.

Among the two drawbacks described above, with regard to the issue of viewable range, the 3D image display device of Patent Document 2 enables some improvement, it does not allow a completely unconfined viewpoint, and in particular it is unable to deal with changes in the viewing position in the depth direction.

Meanwhile, since the 3D image display device of Patent Document 3 adopts the time division system, there is no degradation in resolution and, since the exit pupil position can also be controlled freely, the viewable range is dramatically improved in comparison to the parallax barrier system and the lenticular lens system.

Nevertheless, this system also has the following three drawbacks.

The first drawback is that, when the video-displaying transmissive display is irradiated with a plurality of light beams that were longitudinally diffused, an uneven brightness occurs at the boundary of the longitudinally diffused light beams.

The second drawback is that, while an LED is currently used as the light source that is incidental to the lens array, an LED has a limit in the mounting density due to the size of the light source. Consequently, the horizontal angle capable of deflecting the light beams will become a desultory discrete value.

The third drawback is that, upon longitudinally diffusing the light beams, a distance from the optical element to the video-displaying transmissive display which enables the diffusion of light beams in the amount of the height of the video-displaying transmissive display is required. With respect to this point, while there is a possibility that the distance from the optical element to the video-displaying transmissive display can be shortened by using a reflecting optical system, this is not realistic since the optical system will become complex.
Patent Document 1: Japanese Patent Application Publication No. H9-311295
Patent Document 2: Japanese Patent Application Publication No. 2002-182153
Patent Document 3: Japanese Translation of PCT Application No. 2005-527852

### SUMMARY OF THE INVENTION

An object of this invention is to provide a video display device which allows the viewing of a 3D video, without restriction, in the same manner as a 2D video display without having to use glasses or the like, and a light source control device to be used in the foregoing video display device.

The light source control device according to one aspect of the present invention is a light source control device for controlling a direction of a light beam in a predetermined first axial direction, including a light source unit which emits parallel beams from an arbitrary position along a second axial direction which is orthogonal to the first axial direction, a light source control unit which controls an emitting position of the parallel beams of the light source unit, one or more deflectors which deflects the parallel beams emitted from the light source unit, and a first diffuser which diffuses the light beam, deflected by the deflector, in a third axial direction which is orthogonal to the first axial direction and the second axial direction, wherein the deflector is disposed to be tilted relative to the first axial direction, and yields a different deflection operation in a first element direction which is orthogonal to the deflector's own optical axis direction, and in a second element direction which is orthogonal to both the optical axis direction and the first element direction.

With the video display device using the foregoing light source control device, a viewer can view a 3D video, without restriction, in the same manner as a 2D video display without having to use glasses or the like.

### BRIEF DESCRIPTION OF THE DRAWINGS

FIG. 1 is a schematic perspective view schematically showing the configuration of the video display device in Embodiment 1 of the present invention.

FIG. 2 is a schematic perspective view showing the configuration of the surface light source shown in FIG. 1.

FIG. 3 is a top view of the video display device shown in FIG. 1.

FIG. 4 is a side view of the video display device shown in FIG. 1.

FIG. 5 is a perspective view showing the configuration of an example of the deflector shown in FIG. 1.

FIG. 6 is a schematic diagram explaining the optical property of the cylindrical lens shown in FIG. 5.

FIG. 7 is a perspective view showing the disposed state of the cylindrical lens in the video display device shown in FIG. 1.

FIG. 8 is a diagram schematically showing the emitted light from the cylindrical lens when the parallel light enters the cylindrical lens at an angle that is tilted at a tilt angle 9 from a horizontal state.

FIG. 9 is a cross section showing the configuration of the slit shown in FIG. 1.

FIG. 10 is a perspective view showing the configuration of the slit shown in FIG. 1.

FIG. 11 is a schematic diagram showing the configuration of an example of the vertical diffuser shown in FIG. 1.

FIG. 12 is a schematic diagram showing the first diffusion state of the lenticular lens shown in FIG. 11.

FIG. 13 is a schematic diagram showing the second diffusion state of the lenticular lens shown in FIG. 11.

FIG. 14 is a schematic diagram explaining the limiting conditions on the cylindrical lens and the video-displaying transmissive display of the video display device shown in FIG. 1.

FIG. 15 is a schematic diagram explaining the limiting conditions on the cylindrical lens and the viewpoint position of the video display device shown in FIG. 1.

FIG. 16 is a conceptual diagram of the stereoscopic view based on the video-displaying transmissive display of the video display device shown in FIG. 1.

FIG. 17 is a schematic perspective view showing the configuration of the light source unit for emitting a plurality of parallel beams from an arbitrary position when using a surface light source and a mask pattern part in the video display device shown in FIG. 1.

FIG. 18 is a diagram showing an example of the mask pattern generated by the mask pattern part shown in FIG. 1.

FIG. 19 is a top view of the surface light source, the mask pattern part, the cylindrical lens, and the video-displaying transmissive display extracted from the configuration of Embodiment 1 shown in FIG. 1.

FIG. 20 is a diagram showing an example of the shape of the mask pattern generated by the mask pattern part for emitting parallel beams to become the light beams to be condensed at the viewpoint position.

FIG. 21 is a diagram showing the parallel beams to enter the cylindrical lends from the mask pattern shown in FIG. 20.

FIG. 22 is a schematic diagram showing the light beam path when the light beams projected on the xz coordinates from the exit pupil.

FIG. 23 is a diagram showing the status of the light beams in the video-displaying transmissive display when the configuration shown in FIG. 22 is adopted.

FIG. 24 is a schematic diagram showing the light beam path when a vertical diffuser is added to the configuration shown in FIG. 22.

FIG. 25 is a schematic diagram showing the light beam path, to the viewing position, of the light beams emitted from the right end of the cylindrical lens when a vertical diffuser is added to the configuration shown in FIG. 22.

FIG. 26 is a diagram showing a state of the light beams in the video-displaying transmissive display when the configuration shown in FIG. 25 is adopted.

FIG. 27 is a schematic diagram showing the light beam path when a vertical diffuser is added to the configuration shown in FIG. 25.

FIG. 28 is a diagram showing a state of the light beams in the video-displaying transmissive display when the configuration shown in FIG. 27 is adopted.

FIG. 29 is a schematic diagram showing the light beam path when the entire video-displaying transmissive display is irradiated using the configuration shown in FIG. 27.

FIG. 30 is a diagram showing a state of the light beams in the video-displaying transmissive display when the configuration shown in FIG. 29 is adopted.

FIG. 31 is a schematic diagram showing the parallel beam pattern and the light beam path when forming the exit pupil at the left-side viewpoint position.

FIG. 32 is a schematic diagram showing the parallel beam pattern and the light beam path when forming the exit pupil at the right-side viewpoint position.

FIG. 33 is a schematic diagram showing the formable range of the exit pupil in the video display device shown in FIG. 1.

FIG. 34 is a schematic diagram explaining the presentation method of a 3D video based on time division in the video display device shown in FIG. 1.

FIG. 35 is a schematic perspective view schematically showing the configuration of the video display device in Embodiment 2 of the present invention.

FIG. 36 is a conceptual diagram explaining the configuration of shortening the depth in Embodiment 2.

FIG. 37 is a schematic diagram explaining an example of the deflector array shown in FIG. 35.

FIG. 38 is a perspective view showing the configuration of the slit shown in FIG. 35.

FIG. 39 is a schematic diagram showing the light beam path when two light beams are emitted from the right end of the deflector array in the video display device shown in FIG. 35.

FIG. 40 is a diagram showing a state of the light beams in the video-displaying transmissive display when the configuration shown in FIG. 39 is adopted.

FIG. 41 is a schematic diagram showing the light beam path when three light beams are emitted from the deflector array in the video display device shown in FIG. 35.

FIG. 42 is a diagram showing a state of the light beams in the video-displaying transmissive display when the configuration shown in FIG. 41 is adopted.

FIG. 43 is a diagram showing an example of the entrance trajectory pattern that is used upon presenting a 3D video based on time division.

FIG. 44 is a schematic diagram showing the light beam path of the video display device shown in FIG. 35 when the entrance trajectory pattern shown in FIG. 43 is used.

FIG. 45 is a diagram showing an example of the entrance trajectory pattern that is used when presenting a 3D view based on time division to a plurality of viewers.

FIG. 46 is a schematic diagram showing the light beam path of the video display device shown in FIG. 35 when the entrance trajectory pattern shown in FIG. 45 is used.

FIG. 47 is a schematic diagram in which the decaying state of brightness has been added to the light beam path shown in FIG. 39.

FIG. 48 is a diagram in which the decaying state of brightness has been added to the state of the light beam shown in FIG. 40.

FIG. 49 is a schematic diagram in which the decaying state of brightness has been added to the light beam path shown in FIG. 41.

FIG. 50 is a diagram in which the decaying state of brightness has been added to the state of the light beam shown in FIG. 42.

FIG. 51 is a diagram showing an example of controlling the aperture ratio of the mask pattern part based on the light source control unit in the video display device shown in FIG. 35.

FIG. 52 is a diagram showing the state of brightness of the display corresponding to the control example of the aperture ratio of the mask pattern part shown in FIG. 51.

FIG. 53 is a schematic perspective view schematically showing the configuration of the video display device in Embodiment 3 of the present invention.

FIG. 54 is a schematic diagram showing the light beam path when two light beams are emitted from the right end of the deflector array in the video display device shown in FIG. 53.

FIG. 55 is a diagram showing a state of the light beams in the video-displaying transmissive display when the configuration shown in FIG. 54 is adopted.

FIG. 56 is a schematic diagram showing the light beam path when a plurality of parallel beams are emitted from the deflector array in the video display device shown in FIG. 53.

FIG. 57 is a diagram showing a state of the light beams in the video-displaying transmissive display when the configuration shown in FIG. 56 is adopted.

FIG. 58 is a schematic diagram explaining the relation of a small tilt angle θ of the deflector array and the deflecting range of the light beams.

FIG. 59 is a schematic diagram explaining the relation of a large tilt angle θ of the deflector array and the deflecting range of the light beams.

FIG. 60 is a schematic perspective view schematically showing the configuration of the video display device in Embodiment 4 of the present invention.

FIG. 61 is a schematic diagram explaining the light source utilization efficiency-enhancing effect based on the up-down mirror shown in FIG. 60.

FIG. 62 is a schematic perspective view schematically showing the configuration of the video display device in Embodiment 5 of the present invention.

FIG. 63 is a plan view showing the paths of the light beams that pass through the field lens shown in FIG. 62.

FIG. 64 is a schematic diagram explaining the expansion effect of the viewable range based on the field lens shown in FIG. 62.

FIG. 65 is a schematic perspective view schematically showing the configuration of the video display device in Embodiment 6 of the present invention.

FIG. 66 is a schematic diagram showing the configuration of the mirror and the lens shown in FIG. 65.

FIG. 67 is a schematic perspective view schematically showing the configuration of the video display device in Embodiment 7 of the present invention.

### BEST MODE FOR CARRYING OUT THE INVENTION

The respective embodiments of the present invention are now explained with reference to the drawings. Note that each of the embodiments explained below is a preferred concrete example of the present invention. The constituent elements and the arrangement of the constituent elements in the ensuing embodiments are merely examples, and are not intended to limit the present invention. The present invention is limited only by the scope of its claims. Thus, while the constituent elements that are not claimed in the independent claims that indicate the most significant concept of the present invention among the constituent elements in the ensuing embodiments are not necessarily required for achieving the object of the present invention, they are explained as constituent elements that configure a more preferable mode.

### Embodiment 1

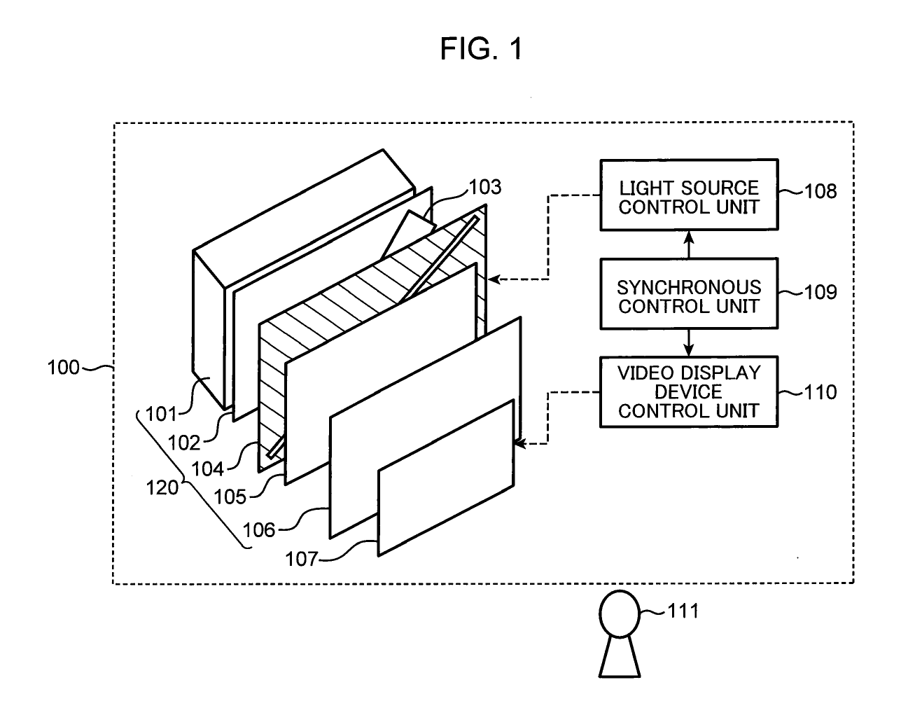

The configuration of the video display device in Embodiment 1 of the present invention is foremost explained with reference to FIG. 1 to FIG. 34. FIG. 1 is a schematic perspective view schematically showing the configuration of the video display device in Embodiment 1 of the present invention.

In FIG. 1, the video display device 100 comprises a light source control device 120, a video-displaying transmissive display 107, a synchronous control unit 109, and a video display device control unit 110. The light source control device 120 comprises a surface light source 101 for emitting parallel beams, a mask pattern part 102, a deflector 103, a slit 104, a vertical diffuser (first vertical diffuser) 105, a vertical diffuser (second vertical diffuser) 106, and a light source control unit 108, and controls the direction of the light beams in the x axis direction (first axial direction) described later.

The light source unit is configured from the surface light source 101 and the mask pattern part 102, and the light source unit (mask pattern part 102) emits a plurality of parallel beams from an arbitrary position of the mask pattern part 102 along an z axis direction (second axial direction) which is orthogonal to an x axis direction (first axial direction) described later.

Based on the foregoing configuration, in this embodiment, as explained below, a viewer 111 can view a 3D video, without restriction, in the same manner as a 2D video display without having to use glasses or the like.

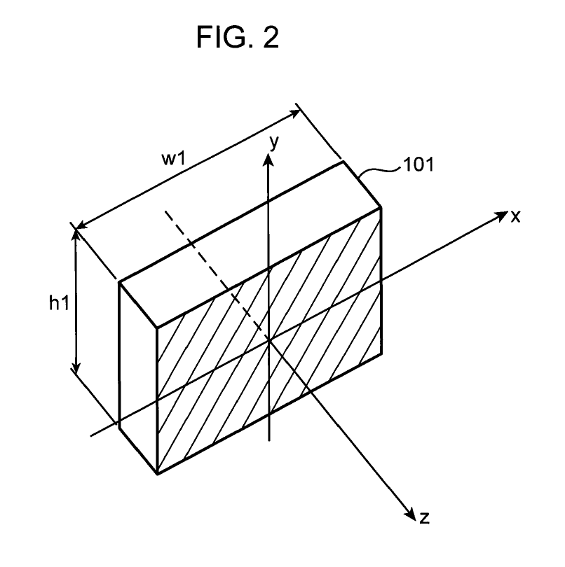

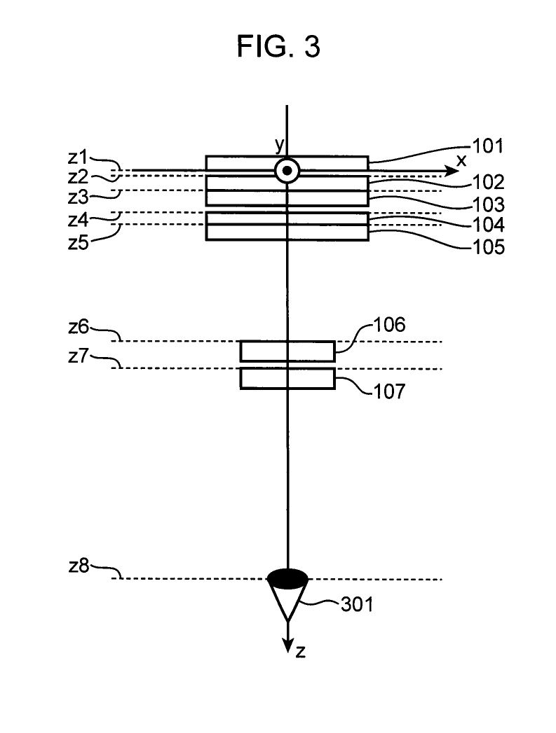

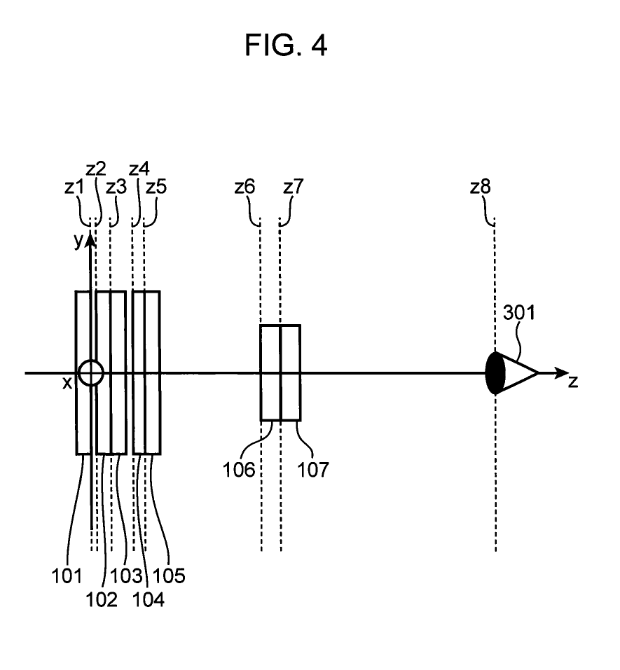

FIG. 2 is a schematic perspective view showing the configuration of the surface light source 101 shown in FIG. 1. FIG. 3 is a top view of the video display device 100 shown in FIG. 1, and FIG. 4 is a side view of the video display device 100 shown in FIG. 1. Here, the coordinate system of the video display device 100 to be used in the ensuing explanation is defined with reference to FIG. 2 to FIG. 4.

In this embodiment, as the surface light source 101, used is a surface light source which emits parallel beams from an overall rectangular area (hatched area in FIG. 2) having a width w1 and a height h1. In the ensuing explanation, with the center of the rectangular area (light beam emission face) as the parallel beam emitting part of the surface light source 101 as the origin, the parallel beam emitting direction shall be the forward direction of the z axis, the direction that is parallel to the height direction of the surface light source 101 and which is an upward direction when viewed from the viewer 111 shall be the forward direction of the y axis, and the direction that is parallel to the width direction of the surface light source 101 and which is a rightward direction when viewed from the viewer 111 shall be the forward direction of the x axis. Moreover, with regard to the surface light source 101, the position on the z coordinate of the light beam emission face shall be considered the reference of the z coordinate, and the z coordinate of the light beam emission face of the surface light source 101 shall be z1=0.

The surface light source 101 comprises, for example, a light source (not shown) such as an LED (Light Emitting Diode) with a small emission area, and a convex lens (not shown), and, by installing the light source at the focal position of the convex lens, emits parallel beams having an area via the convex lens. Thereupon, the surface light source 101 may also be realized by arranged a plurality of pairs of the convex lens and the light source. Moreover, in order to achieve a thinner profile of the device, an optical element such as a Fresnel lens, which has the same optical property as a convex lens, may be used as the convex lens.

Note that the parallel light emitted from the surface light source 101 does not have to be perfect parallel light, and the same effects as this embodiment can be yielded to the extent that the parallel light does not cause the left and right image areas to get mixed and consequently generate crosstalk, which will interfere with the stereoscopic view, when the viewer 111 views the 3D video displayed on the video-displaying transmissive display 107.

FIG. 3 and FIG. 4 are diagrams in which the coordinate systems explained with reference to FIG. 2 have been added to the top view and the side view of the video display device 100 comprising the light source control device 120. In FIG. 3, the viewpoint position of one eye of the viewer 111 is indicated with reference numeral 301. The shape and size of the respective constituent elements in this embodiment are now explained.

The mask pattern part 102 has a rectangular area with a width w2 and a height h2, and the thickness of the mask pattern part 102 is t2. When the z coordinate of the entrance plane of the rectangular area is z2, then z2≧z1. The mask pattern part 102 is configured, for example, from a transmissive display such as a liquid crystal panel. When using a transmissive display, the mask pattern part 102 is configured such that it can emit a plurality of parallel beams by changing the transmittance of the respective pixels, dynamically switch an arbitrary area in the rectangular area between an opening through which the parallel beams pass and a shielding part which shields the parallel beams, thereby generate a mask pattern of an intended shape, and emit the parallel beams from the opening of the mask pattern. In other words, the mask pattern part 102 includes an opening and a light shielding part, is configured such that the position and shape of the opening can be changed arbitrarily, and configured so that it can emit the parallel beams from an arbitrary position of the emission face of the rectangular area, and emit parallel beams of an arbitrary pattern.

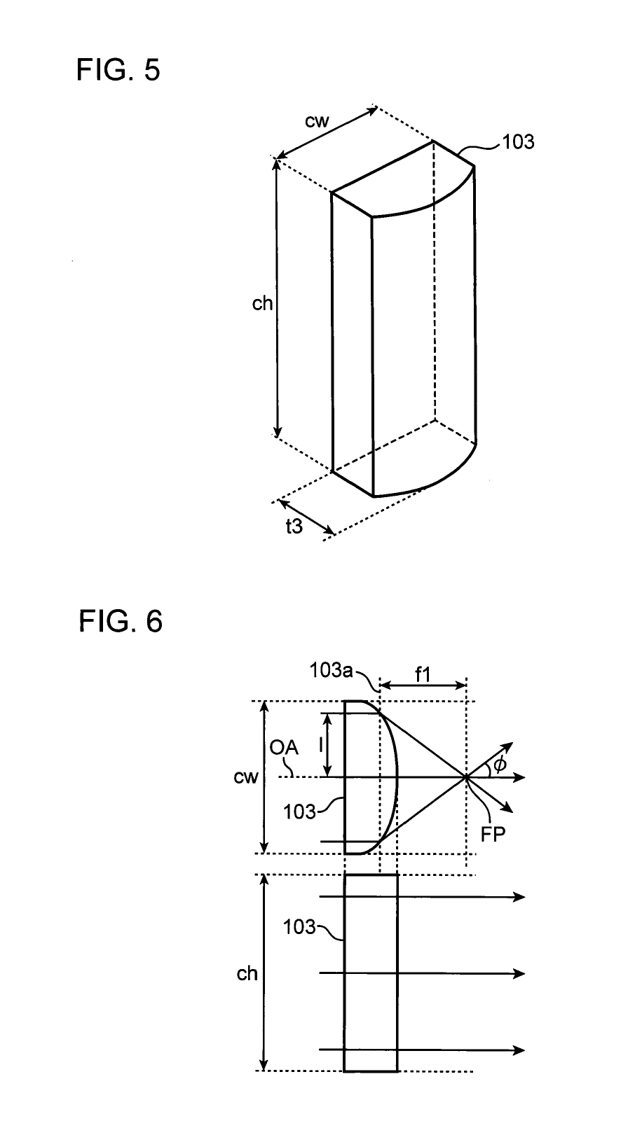

FIG. 5 is a perspective view showing the configuration of an example of the deflector 103 shown in FIG. 1. In this embodiment, as the deflector 103, for instance, used is a planoconvex cylindrical lens having a curvature only in the lens width direction. The deflector 103 has a rectangular area with a width cw and a height ch, and the thickness of the deflector (hereinafter also referred to as the “cylindrical lens”) 103 is t3.

Note that, in this embodiment, while the explanation is provided with reference to a planoconvex cylindrical lens, various types of cylindrical lens; for instance, a biconvex, a plano-concave, or a biconcave cylindrical lens may also be used, or other thin lenses such as a cylindrical Fresnel lens having the same optical property may also be used. In addition, so as long as an optical element that can deflect the parallel beams in a predetermined axial direction is used, the same effects as this embodiment can be yielded.

FIG. 6 is a schematic diagram explaining the optical property of the cylindrical lens 103 shown in FIG. 5, and the upper level is a cross section in the lens width direction and the lower level is a cross section in the lens height direction. The cylindrical lens 103 is a lens having a curvature only in one direction within the lens, and, when the width of the cylindrical lens 103 is cw and the height is ch, in this diagram, only has a curvature in the width direction (first element direction) which is orthogonal to the direction of the optical axis OA, and does not have a curvature in the height direction (second element direction) which is orthogonal to the direction of the optical axis OA and the width direction. Note that the effective diameter of the cylindrical lens 103 shall be equivalent to the width cw.

As described above, the cylindrical lens 103 yields a different deflection operation in a first element direction which is orthogonal to its own optical axis direction, and in a second element direction which is orthogonal to both the optical axis direction and the first element direction, and is disposed in a manner of being tilted relative to the x axis direction (horizontal direction). Accordingly, by changing the entrance position of the parallel beams of the cylindrical lens 103, the direction of the light beam emitted from the cylindrical lens 103 can be changed in the x axis direction (horizontal direction).

In the cross section of the upper level of FIG. 6 in the lens width direction, light that enters the principal plane of the lens perpendicularly is deflected based on the refractive effect of the lens, and condenses at the focal point FP. Here, when the focal length of the cylindrical lens 103 is f1, the focal length is the distance in the optical axis direction from the principal plane 103a on the light beam emitting side in the cylindrical lens 103 to the focal point FP. The deflection angle φ in the width direction is determined, as shown in the upper level of FIG. 6, based on the distance f1 up to the focal point on the other side of the entrance plane, and the width cw. Accordingly, in the local coordinate system of the lens, when the center of the lens width is the origin, the deflection angle φ at a certain width direction position 1 is represented by formula (1) below. Note that, in an actual lens, the emitted light beam will contain some error since it will pass through a position that is displaced from the focal point due to the influence of aberration.

φ=tan⁻¹(1/f1) (1)

Meanwhile, since the cylindrical lens 103 does not have a curvature in the height direction, as shown in the cross section of the lower level of FIG. 6 in the lens height direction, light that entered the cylindrical lens 103 in parallel is not deflected in the height direction. Note that, in the lower level of FIG. 6, while parallel beams enter from the plane of the planoconvex cylindrical lens 103 without a curvature, the configuration may also be such that the parallel beams enter from the curved surface on the opposite side.

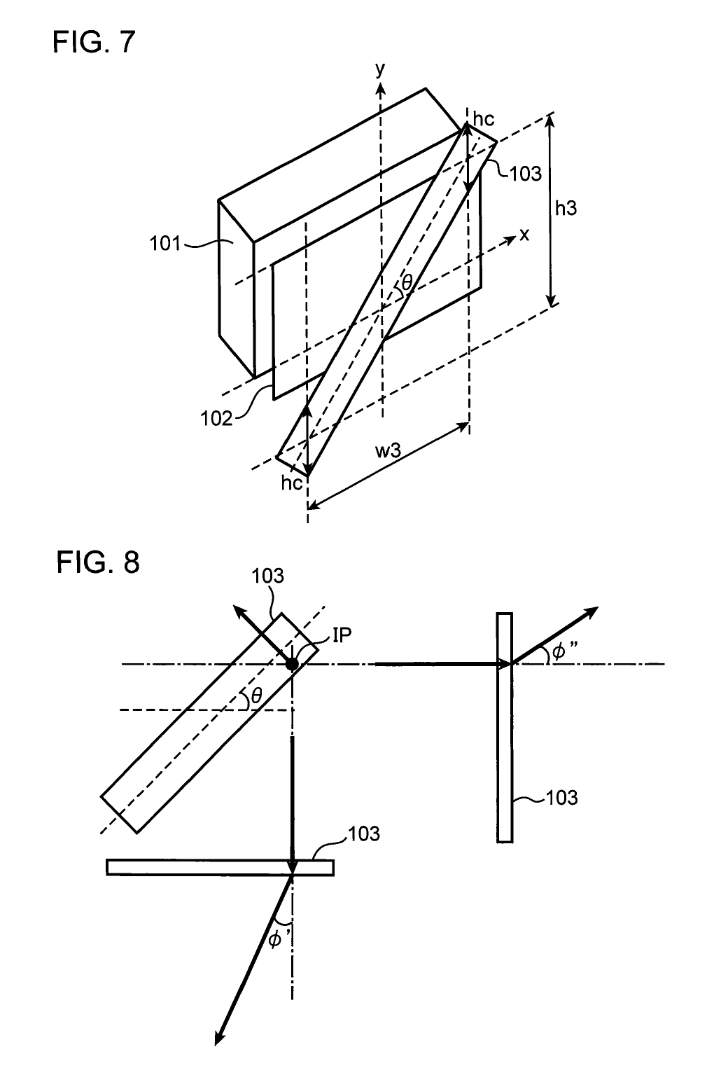

FIG. 7 is a perspective view showing the disposed state of the cylindrical lens 103 in the video display device 100 shown in FIG. 1. When the state in which the cylindrical lens 103 is disposed such that the width direction of the rectangular area in the cylindrical lens 103 is parallel to the y axis and the height direction is parallel to the x axis is defined as the horizontal state, as shown in FIG. 7, the cylindrical lens 103 is disposed in a manner of being tilted at a tilt angle θ (0≦θ<2π [rad]) from the horizontal state based on the x axis.

FIG. 8 is a diagram schematically showing the emitted light from the cylindrical lens 103 when the parallel light enters the cylindrical lens 103 at an angle that is tilted at a tilt angle θ from a horizontal state. Moreover, the upper left level of FIG. 8 is the front view of the cylindrical lens 103, the lower left level is the top view of the cylindrical lens 103, the right side is the side view of the cylindrical lens 103, and the black circle IP shown in the front view of the upper left side shows the entrance position of light.

When the cylindrical lens 103 is disposed in a manner of being tilted at an tilt angle θ, the deflection angle φ′ to the x axis direction is represented by following formula (2) when giving consideration to the tilt angle θ, and the deflection angle φ″ to the y axis direction is represented by following formula (3).

φ′=tan⁻¹(1×sin θ/f1) (2)

φ″=tan⁻¹(1×cos θ/f1) (3)

Here, referring once again to FIG. 7, when the length of the direction, which is parallel to the x axis, of the tilted cylindrical lens 103 in the foregoing coordinate system is w3, and the length which is parallel to the y axis is h3, the length hc of the cylindrical lens in the y axis direction when x=±(w3/2) shall satisfy following formula (4).

hc=cw/cos θ (4)

Here, when the z coordinate of the entrance plane of the rectangular area of the cylindrical lens 103 disposed as described above is z3, then z3≧(z2+t2).

With the cylindrical lens 103 disposed as described above, by changing the entrance position of the parallel beams in the y axis direction (vertical direction) at the same x coordinate position (horizontal position), the direction of the light beam in the x axis direction (horizontal direction) can be changed.

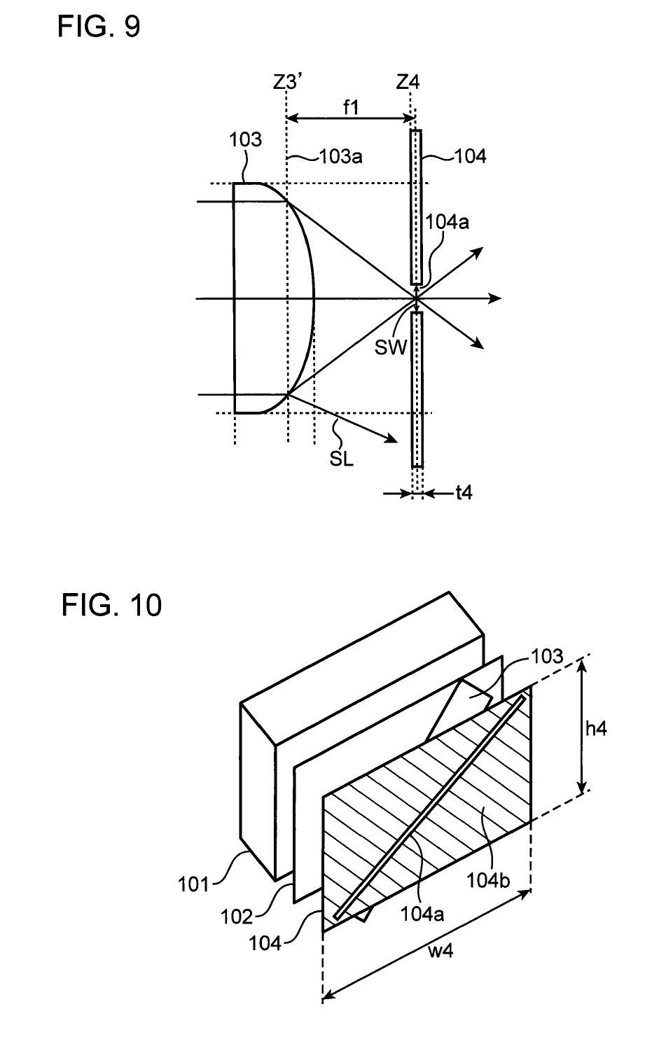

FIG. 9 is a cross section showing the configuration of the slit 104 shown in FIG. 1, and FIG. 10 is a perspective view showing the configuration of the slit 104 shown in FIG. 1. The slit 104 has a rectangular area with a width w4 and a height h4, and the thickness of the slit 104 is t4. When the z coordinate of the entrance plane of the rectangular area of the slit 104 is z4, and the z coordinate of the principal plane 103a when viewed from the light beam emission face of the cylindrical lens 103 is z3′, z4 is set to be a value that is approximate to (z3′+f1).

The slit 104 has an opening 104a (white portion) disposed diagonally in correspondence with the tilted cylindrical lens 103, and the remaining hatched portion is the shielding part 104b. This kind of slit 104 is provided at the lens focal position.

Here, due to the nature of the cylindrical lens 103, for instance, stray light SL is generated due to internal reflection or the like, and the slit 104 is provided in order to eliminate the influence of such stray light SL. Specifically, when a cylindrical lens or a cylindrical Fresnel lens is used as the deflector 103, the parallel beams that enter the lens are deflected based on the refractive effect of the lens, and thereafter once condense at the lens focal point. Accordingly, as shown in FIG. 9 and FIG. 10, by providing the slit 104 having the opening 104a with a width SW only near the focal position of the cylindrical lens 103, stray light can be eliminated without losing the light that entered the cylindrical lens 103 in parallel.

Note that, while the light beam that was deflected by the cylindrical lens 103 will theoretically pass through the lens focal position, in reality the light beam will pass through a position that is slightly displaced from the focal point due to the influence of aberration or the like. Thus, the width SW of the opening 104a of the slit 104 needs to be a size that will not be a practical problem.

The vertical diffuser 105 diffuses the light beam, in which its direction in the x direction (horizontal direction) was changed by the cylindrical lens 103, only in the y direction (vertical direction). The vertical diffuser 105 is disposed at a position so as to only diffuse the light beam that passed through the slit 104, has a rectangular area with a width w5 and a height h5, and the thickness thereof is t5. When the z coordinate of the entrance plane of the rectangular area of the vertical diffuser 105 is z5, then z5≧z4+t4.

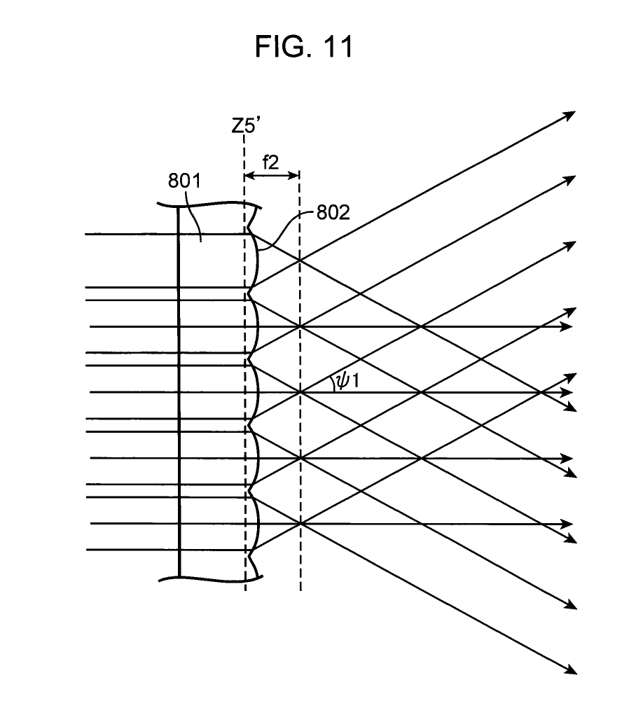

FIG. 11 is a schematic diagram showing the configuration of an example of the vertical diffuser 105 shown in FIG. 1. In this embodiment, for example, the lenticular lens 801 shown in FIG. 11 is used as the vertical diffuser 105. Let it be assumed that the diffusion by the lenticular lens 801 only occurs in a direction that is parallel to the y axis direction.

Note that, in this embodiment, while the explanation is provided using a lenticular lens as the vertical diffuser 105, without limitation to this example, the same effects as this embodiment can be yielded by using an optical element capable of diffusing the incident light beam only in one direction. Moreover, the diffusion direction of the vertical diffuser 105 does not have to be strictly one direction, and the same effects as this embodiment can be yielded by using an optical element having characteristics that will not cause the left and right image areas to get mixed and consequently generate crosstalk, and interfere with the stereoscopic view when the viewer 111 views the 3D video at the viewing position.

As shown in FIG. 11, the lenticular lens 801 is configured from a plurality of minute planoconvex cylindrical lenses 802 arranged in the diffusion direction, and diffuses light beams in one direction. When perpendicular parallel beams enter from the plane surface side of the lenticular lens 801, the parallel beams once condense at a position that is separated by the focal length f2 of the cylindrical lens 802, and are thereafter diffused. The divergence angle 1 in the foregoing case is determined based on the curvature and material of the cylindrical lens 802. Note that, in FIG. 11, while light enters from the plane surface side of the lenticular lens 801, the same diffusion effect can be yielded when light enters from the curved surface side.

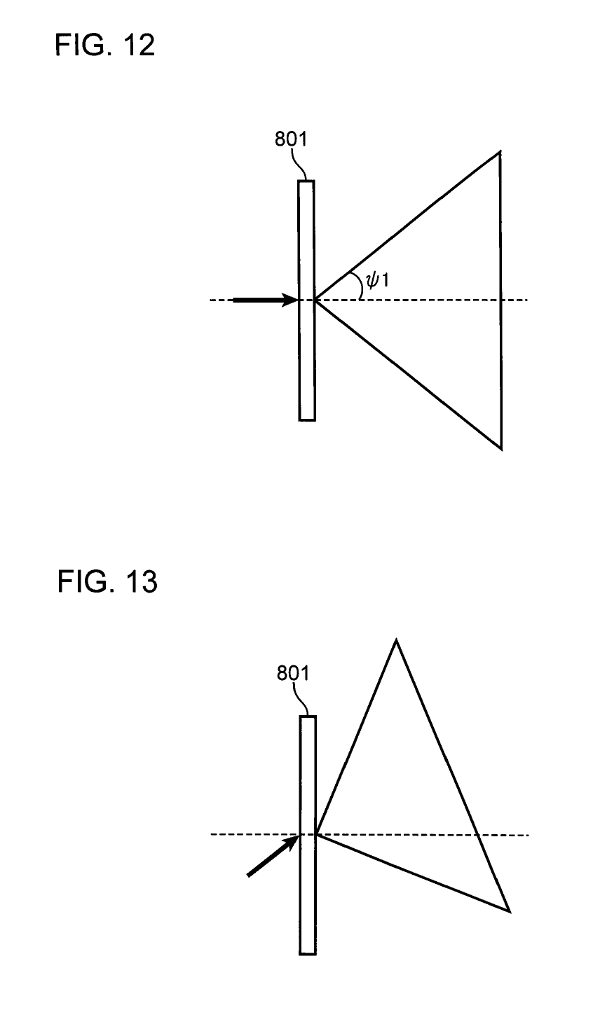

FIG. 12 is a schematic diagram showing the first diffusion state of the lenticular lens 801 shown in FIG. 11, and FIG. 13 is a schematic diagram showing the second diffusion state of the lenticular lens 801 shown in FIG. 11. When the lens pitch of the lenticular lens 801 (arrangement pitch of the planoconvex cylindrical lenses 802) is sufficiently small, diffusion by the lenticular lens 801 can be deemed to be diffusion without any space in between within a certain range as shown in FIG. 12. Diffusion by the lenticular lens 801 is thereinafter represented with FIG. 12.

Meanwhile, when the light beam that enters the lenticular lens 801 is not perpendicular to the lens plane, the diffusion range will change depending on the angle formed by the incident light beam and the lenticular lens 801. For example, as shown in FIG. 13, when the light beam enters the lenticular lens 801 obliquely from below, the diffusion range will move obliquely upward.

The vertical diffuser 106 additionally diffuses the light beam that was diffused by the vertical diffuser 105 only in the y direction (horizontal direction). The vertical diffuser 106 has a rectangular area with a width w6 and a height h6, and the thickness thereof is t6. When the z coordinate of the entrance plane of the rectangular area of the vertical diffuser 106 is z6, and the z coordinate of the principal plane viewed from the light beam emission face of the lenticular lens 801 used as the vertical diffuser 105 is z5′ (refer to FIG. 11), then z6(z5′+f2).

In this embodiment, for example, the lenticular lens 801 shown in FIG. 11 is also used as the vertical diffuser 106. Let it be assumed that the diffusion by the lenticular lens 801 used as the vertical diffuser 106 only occurs in a direction that is parallel to the y axis direction.

However, the divergence angle ψ2 of the lenticular lens 801 used as the vertical diffuser 106 does not need to be the same as the divergence angle ψ1 of the lenticular lens used as the vertical diffuser 105. Here, the focal length of the lenticular lens 801 used in the vertical diffuser 106 when viewed from the light beam emission face shall be f3.

Note that, in this embodiment, while the explanation is provided using the lenticular lens 801 also as the vertical diffuser 106, without limitation to this example, the same effects as this embodiment can be yielded by using an optical element capable of diffusing the incident light beam only in one direction. Moreover, the diffusion direction of the vertical diffuser 106 does not have to be strictly one direction, and the same effects as this embodiment can be yielded by using an optical element having characteristics that will not cause the left and right image areas to get mixed and consequently generate crosstalk, and interfere with the stereoscopic view during the viewing of the 3D video at the viewing position.

The video-displaying transmissive display 107 is configured, for example, from a transmissive display such as a liquid crystal panel, and displays images using the diffused light emitted from the vertical diffuser 106. The video-displaying transmissive display 107 has a rectangular display area with a width w7 and a height h7, and the thickness thereof is t7. When the z coordinate of the entrance plane of the rectangular area of the video-displaying transmissive display 107 is z7, and the z coordinate of the principal plane when viewed from the lenticular lens 801 used as the vertical diffuser 106 is z6′, z7 is set to be a value that is approximate to (z6′+f3).

The light source control unit 108 controls the emitting position of the parallel beams of the mask pattern part 102 by controlling the surface light source 101 and the mask pattern part 102 according to the control signals from the synchronous control unit 109. For example, when the mask pattern part 102 is configured from a transmissive display, the light source control unit 108 controls the shape of the opening and the shielding part of the mask pattern part 102, and thereby controls the surface light source 101 and the mask pattern part 102 so as to generate an intended mask pattern. As described above, by changing the position of the opening of the mask pattern part 102, the light source control unit 108 changes the emitting position of the parallel beams emitted from the mask pattern part 102.

As described above, since the light source control unit 108 can control the entrance position of the parallel beams of the cylindrical lens 103 by controlling the emitting position of the parallel beams of the mask pattern part 102, it is possible to control the direction of the light beam in the x axis direction (horizontal direction) according to the emitting position of the parallel beams, and diffuse the light beam, in which the direction thereof in the x axis direction (horizontal direction) was controlled, in the y axis direction (vertical direction) with the vertical diffusers 105, 106. It is thereby possible to emit light beams that diffuse in the y axis direction (vertical direction) while controlling the direction in the x axis direction (horizontal direction).

Moreover, preferably, the light source control unit 108 stops the irradiation of the parallel beams from the surface light source 101 during a screen transition which occurs upon changing the position of the opening and the light shielding part of the mask pattern part 102 configured from a transmissive display, and resumes the irradiation of the parallel beams from the surface light source 101 after the screen transition of the mask pattern part 102 is complete. In the foregoing case, it is possible to prevent unstable light beams from being emitted during screen transition.

The synchronous control unit 109 controls the light source control unit 108 and the video display device control unit 110 so that the light source control unit 108 and the video display device control unit 110 will operate in synchronization. For example, the synchronous control unit 109 controls the video display device control unit 110 so as to determine the video to be displayed on the video-displaying transmissive display 107 in synchronization with the mask pattern generated by the mask pattern part 102.

The light source control unit 108 controls the emitting position of the parallel beams of the mask pattern part 102 so that the condensing position of the diffused light becomes the viewer's left eye and right eye, for instance, by switching the condensing position of the diffused light emitted from the vertical diffuser 106 based on time division according to the controls signals from the synchronous control unit 109.

The video display device control unit 110 controls the video to be displayed on the video-displaying transmissive display 107, for instance, by controlling the video-displaying transmissive display 107 to display a parallax video corresponding to the condensing position in synchronization with the switching of the condensing position by the light source control unit 108 according to the control signals from the synchronous control unit 109.

The viewer 111 is a person viewing the video-displaying transmissive display 107. When the x coordinate and the y coordinate of the viewpoint position of one eye of the viewer are on the z axis, the z coordinate of the viewpoint position shall be z8. Here, z8≧z7+t7.

Note that, in this embodiment, the surface light source 101, the mask pattern part 102, the tilted deflector 103, the slit 104, the vertical diffuser 105, the vertical diffuser 106, and the video-displaying transmissive display 107 are arranged so that the width direction of the respective rectangular areas is parallel to the x axis and the height direction is parallel to the y axis, and the z axis passes through the center of the rectangular area, but the arrangement method is not limited to the foregoing arrangement method so as long as the viewer can enjoy a stereoscopic view by controlling the direction of the light beam that is ultimately output from the light source control device 120 relative to a predetermined axial direction.

Moreover, the shape of the respective parts is not limited to a rectangle so as long as it is a shape in which the viewer can enjoy a stereoscopic view by controlling the direction of the light beam that is ultimately output from the light source control device 120 relative to a predetermined axial direction.

Next, with regard to the tilted cylindrical lens 103 and the video-displaying transmissive display 107 in this embodiment, the following conditions need to be satisfied for the viewer 111 to observe the overall screen of the video-displaying transmissive display 107.

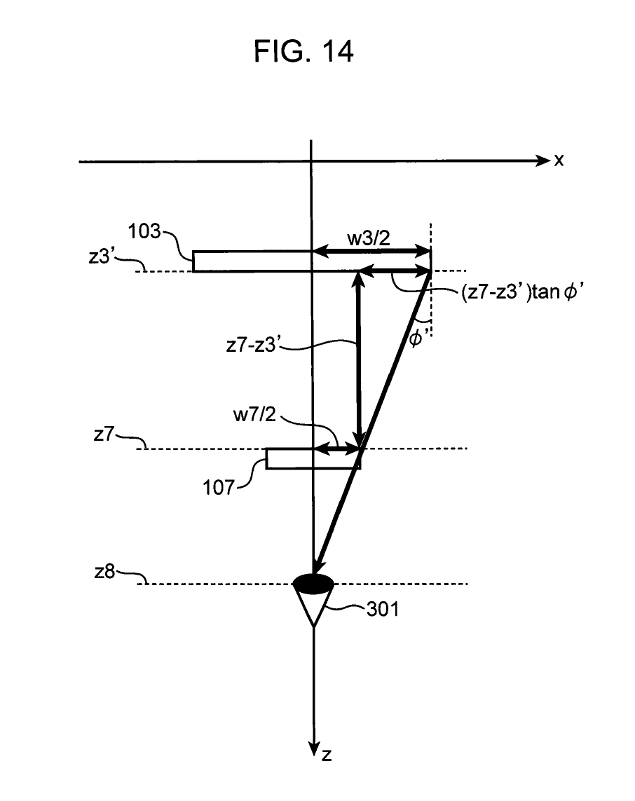

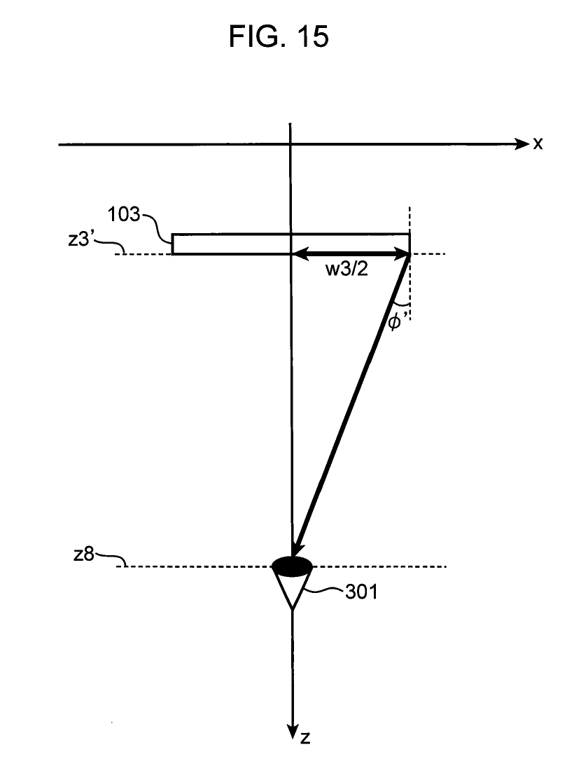

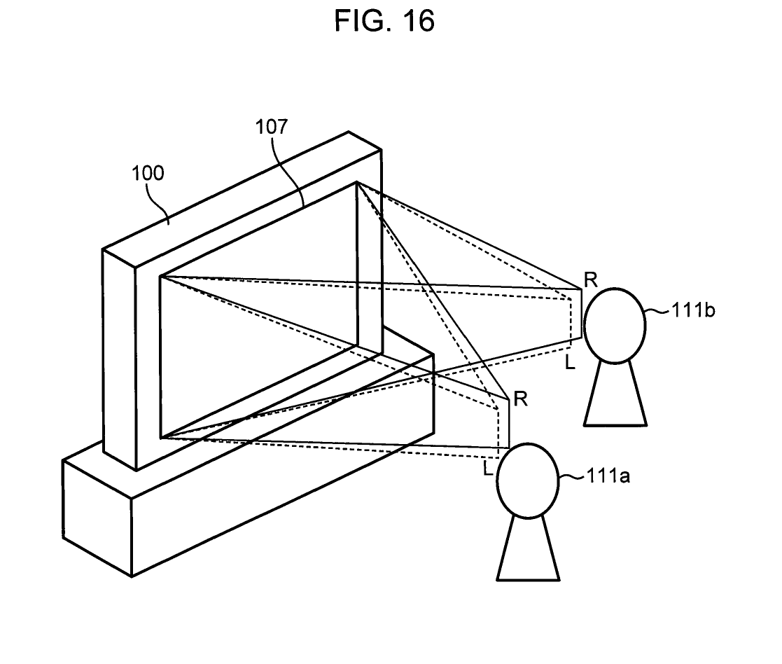

FIG. 14 is a schematic diagram explaining the limiting conditions on the cylindrical lens 103 and the video-displaying transmissive display 107 of the video display device shown in FIG. 1, and FIG. 15 is a schematic diagram explaining the limiting conditions on the cylindrical lens 103 and the viewpoint position of the video display device shown in FIG. 1.

When the maximum horizontal deflection angle that can be emitted from the coordinates (w3/2) of the ends, in the x axis direction, of the tilted cylindrical lens 103 used as the deflector is φ′_{MAX}, following formula (5) will be established as the limiting conditions as shown in FIG. 14 in the coordinates (w7/2) of the screen ends of the video-displaying transmissive display 107 in the x axis direction and in the coordinates (w3/2) of the ends, in the x axis direction, of the tilted cylindrical lens 103.

w3/2≧w7/2+(z7−z3′)tan φ′_{MAX} (5)

As a result of satisfying formula (5) above, light beams that pass through the coordinates of both ends of the video-displaying transmissive display 107 in the x axis direction will exist.

Moreover, with regard to the z coordinate z8 of the viewpoint position 301, in order for the deflected light beams to form an exit pupil at the viewpoint position 301, following formula (6) needs to be established as shown in FIG. 15 in the end coordinates (w3/2) in the x axis direction, which are the width ends of the tilted cylindrical lens 103 in the x axis direction.

φ′_{MAX}≧tan⁻¹(w3/2(z8−z3′)) (6)

Accordingly, the viewer's viewpoint position 301 is set forth so as to satisfy foregoing formula (6). Note that, with regard to the deflection angle φ′_{MAX} used in formula (5) and formula (6), the theoretical value can be obtained from formula (2), but with an actual lens, it will not necessarily coincide with the value of formula (2) due to an error caused by aberration. Thus, in reality, conditional expression (5) and formula (6) need to be set forth using a measured value. Moreover, with regard to the surface light source 101, the mask pattern part 102, the slit 104, the vertical diffuser 105, and the vertical diffuser 106 also, the width in the x axis direction needs to be set appropriately so that the light beam passes through an effective range of the respective constituent elements.

FIG. 16 is a conceptual diagram of the stereoscopic view based on the video-displaying transmissive display 107 of the video display device 100 shown in FIG. 1 in the case of using the foregoing configuration. With the video display device 100 of this embodiment, based on the foregoing configuration, since the exit pupil of the vertical striped light beams emitted from the video-displaying transmissive display 107 can be simultaneously formed at the left/right viewpoint positions of the respective viewers 111a, 111b, a plurality of viewers can consequently view a 3D video with the naked eye simultaneously.

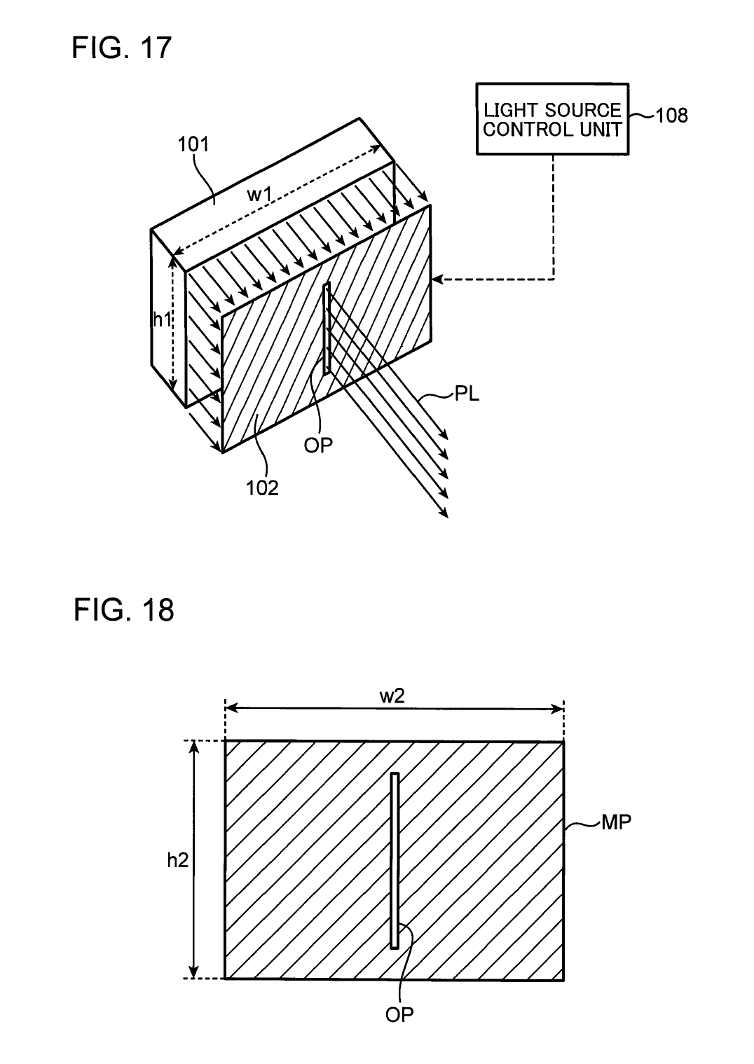

The exit pupil forming method of the light source control device 120 for realizing the stereoscopic view shown in FIG. 16 is now explained. FIG. 17 is a schematic perspective view showing the configuration of the light source unit for emitting a plurality of parallel beams from an arbitrary position when using the surface light source 101 and the mask pattern part 102 in the video display device shown in FIG. 1, and FIG. 18 is a diagram showing an example of the mask pattern generated by the mask pattern part 102.

As shown in FIG. 17, the light source control unit 108 controls the surface light source 101 and the mask pattern part 102, the surface light source 101 emits parallel beams from the overall rectangular area with a width w1 and a height h1, the mask pattern part 102 generates the mask pattern MP shown in FIG. 18, and the parallel beams PL are emitted from the lengthwise quadrangle opening OP at the midsection. In other words, with the example shown in FIG. 18, a mask pattern MP that only allows the parallel beams PL of the midsection to pass through is displayed on the transmissive display used as the mask pattern part 102, and, with this mask pattern MP, only the white line portion at the center becomes the opening OP, and the remaining hatched portion becomes the shielding part. Accordingly, when the mask pattern part 102 configured from a transmissive display is disposed at the light beam emitting part of the surface light source 101, which is a parallel light source, the parallel beams PL are emitted only from the opening OP at the center of the screen. As described above, the shape of the opening of the mask pattern can be changed to an arbitrary shape by the light source control unit 108 controlling the mask pattern part 102.

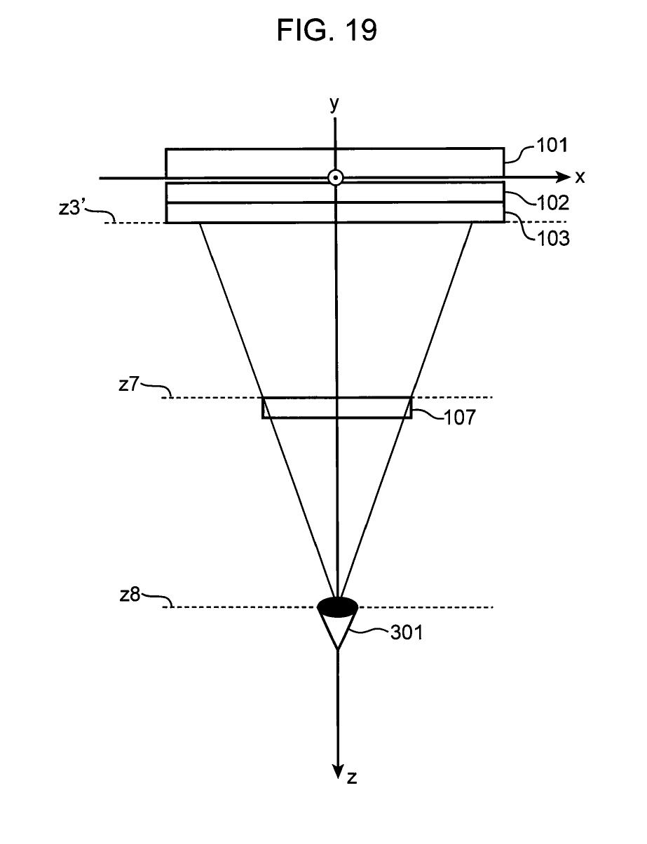

The method of controlling the parallel beams emitted from the light source unit and forming the exit pupil at an arbitrary position is now explained with reference to FIG. 19 to FIG. 30. The roles of the respective constituent elements are now explained, with a part of the configuration being extracted.

FIG. 19 is a top view of the surface light source 101, the mask pattern part 102, the cylindrical lens (deflector) 103, and the video-displaying transmissive display 107 extracted from the configuration of Embodiment 1 shown in FIG. 1. Note that, in the subsequent diagrams, the illustration of the slit 104 is omitted for the sake of simplification.

Foremost, considered are the light beams projected on the xz plane when w3, w7, z3′, z7, and z8 are set to satisfy formulas (5) and (6) above. In the foregoing case, as shown in FIG. 19, when the respective light beams emitted from the cylindrical lens 103 pass through all x coordinates on the video-displaying transmissive display 107 and the respective light beams are projected on the xz plane, there is a method of emitting the parallel beams to become the light beams that condense at the viewpoint position 301.

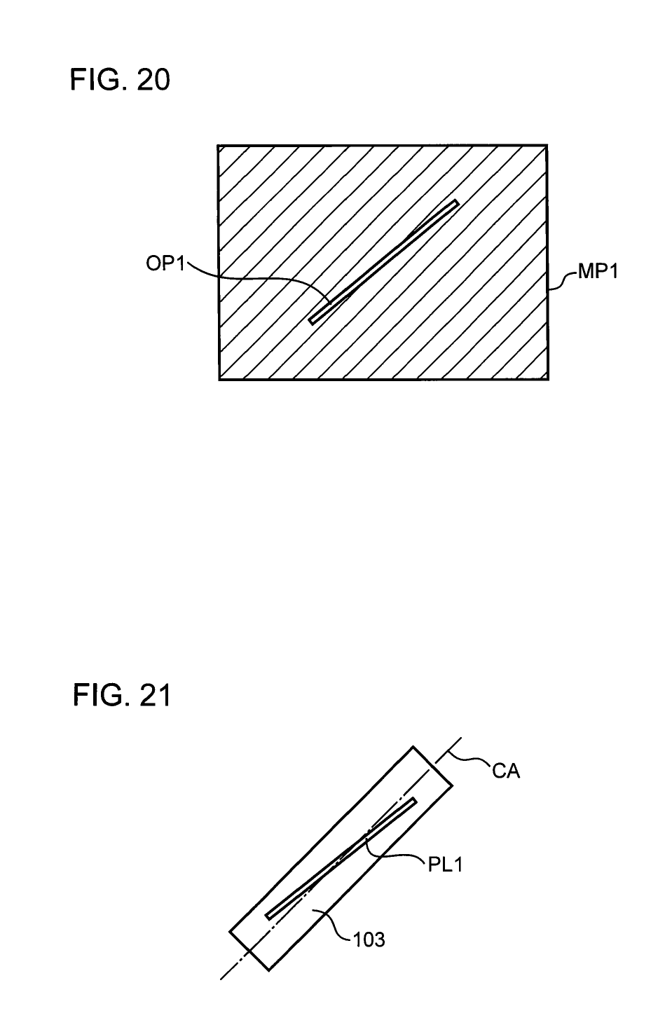

FIG. 20 is a diagram showing an example of the shape of the mask pattern generated by the mask pattern part 102 for emitting parallel beams to become the light beams to be condensed at the viewpoint position 301, and FIG. 21 is a diagram showing the parallel beams to enter the cylindrical lends 103 from the mask pattern shown in FIG. 20.

Let it be assumed that the method of emitting the parallel beams to become the light beams that condense at the viewpoint position 301 is the parallel beams that are emitted when the mask pattern MP1 shown in FIG. 20 is set as the mask pattern part 102. The mask pattern MP1 has a tilted rectangular opening OP1, and the parallel beams are emitted from the opening OP1. Here, as shown in FIG. 21, the parallel beams PL1 emitted from the opening OP1 enter the cylindrical lens 103 in a state of being further titled in the clockwise direction relative to the central axis CA of the tilted cylindrical lens 103.

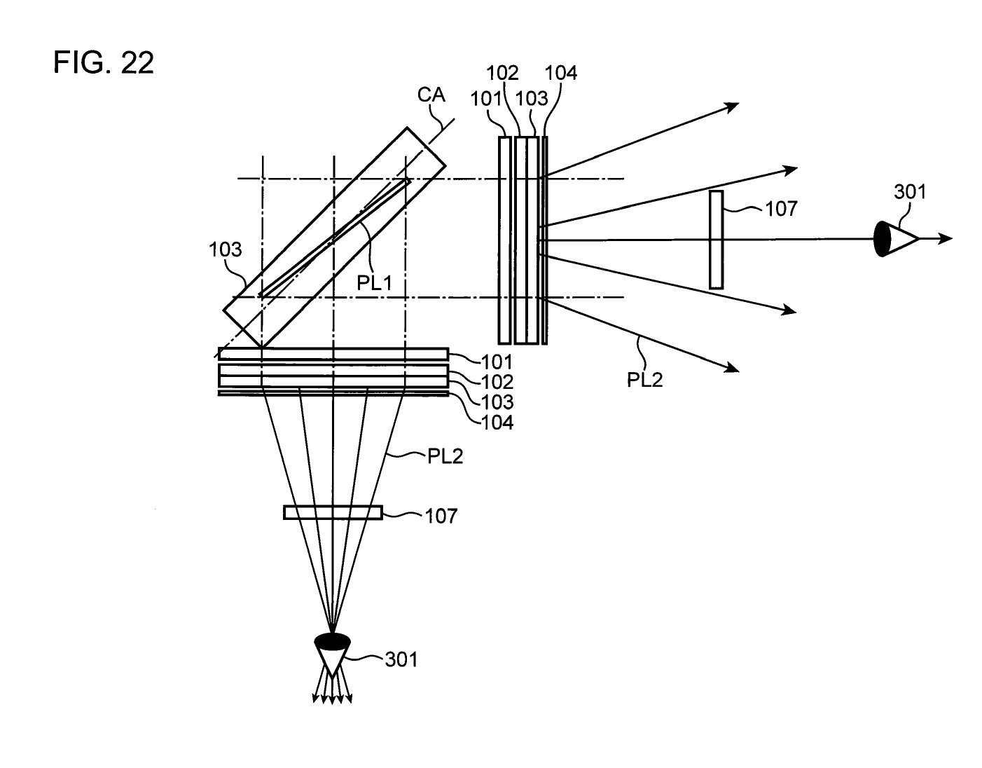

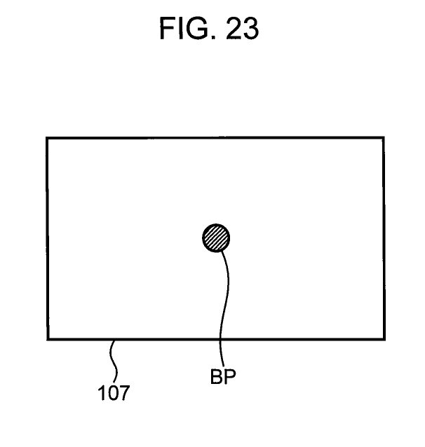

FIG. 22 is a schematic diagram showing the light beam path when the light beams projected on the xz coordinates form the exit pupil, and FIG. 23 is a diagram showing the status of the light beams in the video-displaying transmissive display 107 when the configuration shown in FIG. 22 is adopted.

Here, the upper left level of FIG. 22, as with FIG. 21, is the front view of the cylindrical lens 103 showing the parallel beams PL1 entering the cylindrical lens 103, the lower left level is the top view upon extracting only the surface light source 101, the mask pattern part 102, the cylindrical lens 103, the slit 104 and the video-displaying transmissive display 107, and the upper right side is the side view upon extracting only the surface light source 101, the mask pattern part 102, the cylindrical lens 103, the slit 104 and the video-displaying transmissive display 107. Note that, in FIG. 22, in order to simplify the illustration, only five light beams PL2 among a plurality of light beams are representatively indicated.

The parallel beams PL1 that entered the cylindrical lens 103 shown in the upper left level of FIG. 22 are deflected by the cylindrical lens 103 and emitted as the light beams PL2, and, as shown in the lower left level of FIG. 22, the light beams PL2 converge at the viewpoint position 301 in the horizontal direction (x axis direction) on the xz coordinate plane.

When the light beams PL2 projected on the xz coordinates are forming the exit pupil at the viewpoint position 301, upon viewing the emitting direction of the light beams PL2 in the vertical direction (y axis direction), as shown in the upper right level of FIG. 22, the light beams PL2 in the vertical direction are not irradiated such that the entire surface of the video-displaying transmissive display 107 is irradiated, nor do they converge at the viewpoint position 301 after passing through the video-displaying transmissive display 107.

Here, upon viewing the video-displaying transmissive display 107 from the viewpoint position 301, as shown in FIG. 23, only the screen midsection BP of the video-displaying transmissive display 107 will appear bright. Thus, the vertical diffuser 105 using the lenticular lens 801 is disposed at the position of the z coordinate z5 between the cylindrical lens 103 and the video-displaying transmissive display 107.

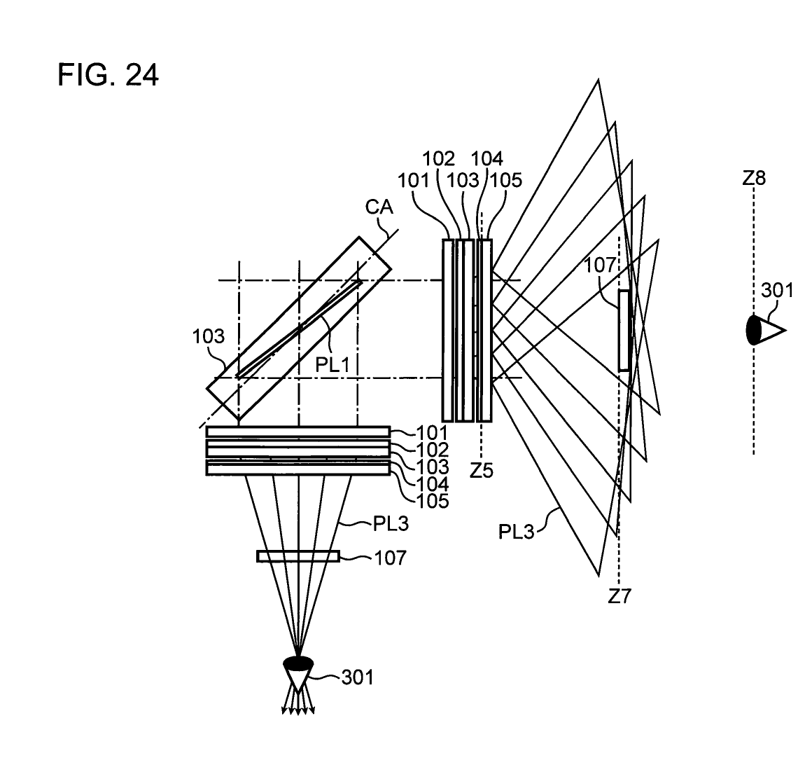

FIG. 24 is a schematic diagram showing the light beam path when a vertical diffuser 105 is added to the configuration shown in FIG. 22. The vertical diffuser 105 is disposed at a position of the z coordinate z5 between the cylindrical lens 103 and the video-displaying transmissive display 107, and the z coordinates z5, z7, and the divergence angle ψ1 are set appropriately so that the light beams that longitudinally diffuse in the y axis direction (vertical direction) are irradiated in a vertically striped shape across the screen height direction of the video-displaying transmissive display 107. Consequently, as shown in the upper right level of FIG. 24, the diffused light PL3 that was longitudinally diffused by the vertical diffuser 105 can be irradiated such that the entire surface of the video-displaying transmissive display 107 is irradiated.

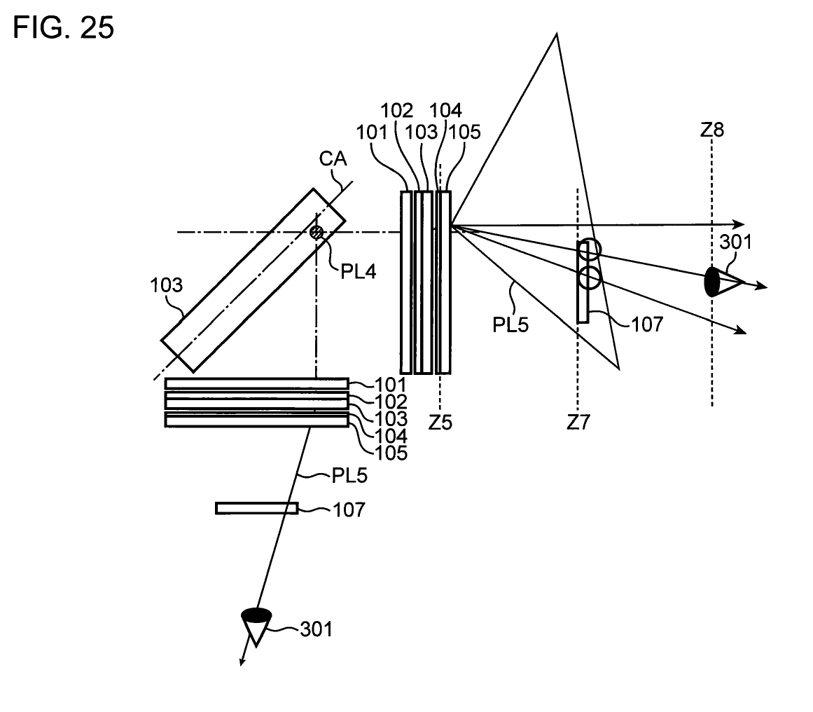

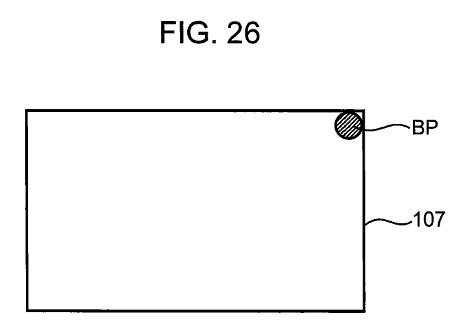

The light beams emitted from the right end of the cylindrical lens 103 are now considered. FIG. 25 is a schematic diagram showing the light beam path, to the viewing position, of the light beams emitted from the right end of the cylindrical lens 103 when the vertical diffuser 105 is added to the configuration shown in FIG. 22, and FIG. 26 is a diagram showing a state of the light beams in the video-displaying transmissive display 107 when the configuration shown in FIG. 25 is adopted.

As shown in the upper left level of FIG. 25, when the light beams PL4 are emitted from the right end of the cylindrical lens 103, while the right end of the video-displaying transmissive display 107 will be irradiated at all positions in the height direction with the diffused light PL5 that was longitudinally diffused by the vertical diffuser 105, as shown in the upper right level of FIG. 25, the light beams PL4 still do not condense at the viewpoint position 301. When the video-displaying transmissive display 107 is viewed from the viewpoint position 301 in the foregoing case, as shown in FIG. 26, only one part BP at the upper right part of the screen of the video-displaying transmissive display 107 will be viewed brightly. Thus, finally, the vertical diffuser 106 using the lenticular lens 801 is disposed at the position of the coordinate z6 between the vertical diffuser 105 and the video-displaying transmissive display 107.

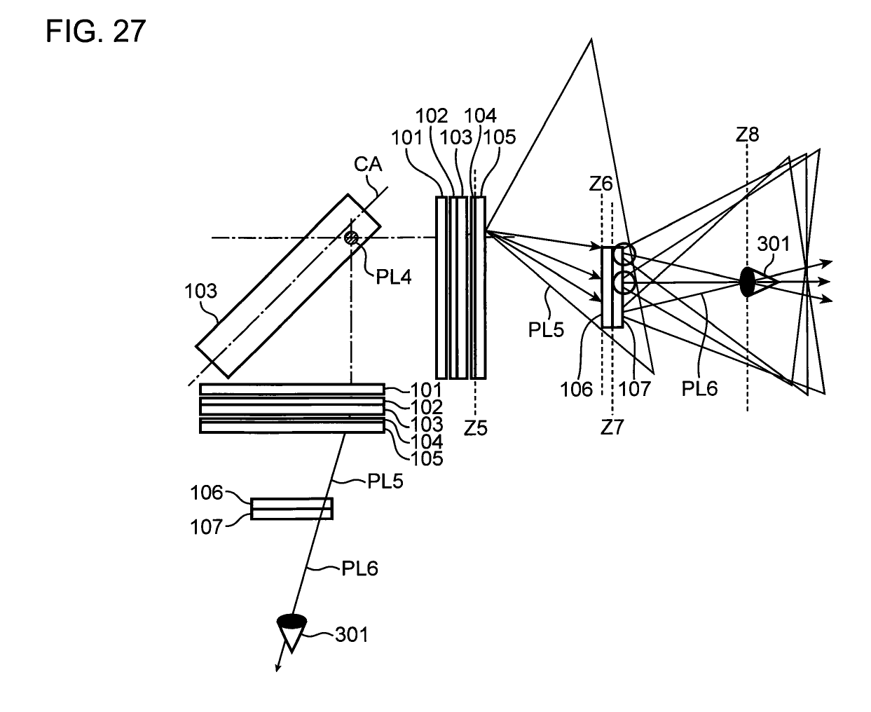

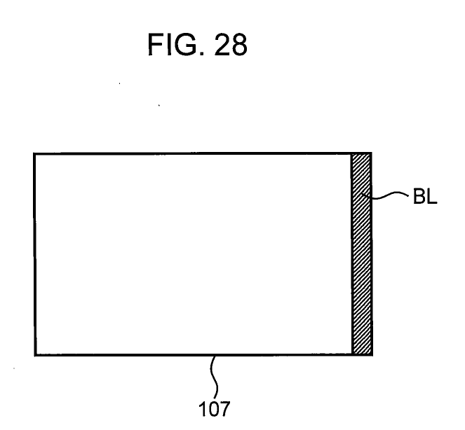

FIG. 27 is a schematic diagram showing the light beam path when the vertical diffuser 106 is added to the configuration shown in FIG. 25, and FIG. 28 is a diagram showing a state of the light beams in the video-displaying transmissive display 107 when the configuration shown in FIG. 27 is adopted.

As shown in the upper left level of FIG. 27, when considering the light beams PL4 that are emitted from the right end of the cylindrical lens 103, the right end of the video-displaying transmissive display 107 will be irradiated with the diffused light PL5 across its entire height based on the longitudinal diffusion by the vertical diffuser 105, and, in addition, there are light beams PL6 which advance from all positions at the right end of the screen on the video-displaying transmissive display 107 to the viewpoint position 301 based on the longitudinal diffusion of the vertical diffuser 106. Here, when the video-displaying transmissive display 107 is viewed from the viewpoint position 301, as shown in FIG. 28, a vertical stripe area BL across the entire height of the right end of the screen of the video-displaying transmissive display 107 will be irradiated and visible.

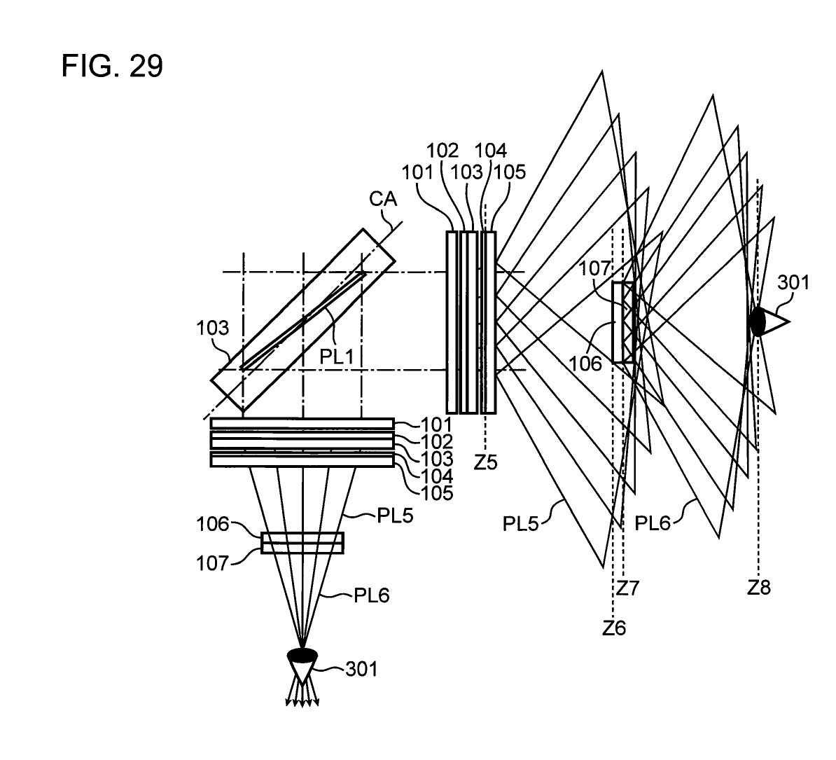

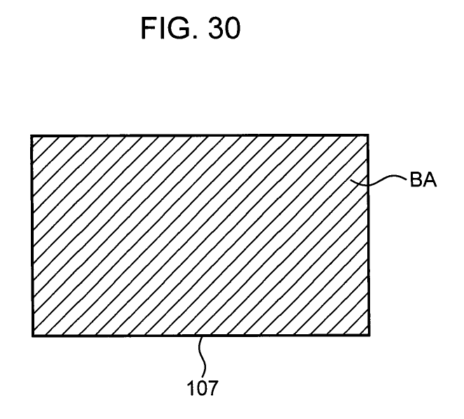

FIG. 29 is a schematic diagram showing the light beam path when the entire video-displaying transmissive display 107 is irradiated using the configuration shown in FIG. 27, and FIG. 30 is a diagram showing a state of the light beams in the video-displaying transmissive display 107 when the configuration shown in FIG. 29 is adopted.

In the configuration added with vertical diffuser 105 and the vertical diffuser 106, the light beam path of the linear parallel beams PL1 emitted from all positions of the cylindrical lens 103 is shown in FIG. 29. When viewing the video-displaying transmissive display 107 from the viewpoint position 301, since there are the light beams PL6 that advance toward the viewpoint position 301 from the entire display surface of the video-displaying transmissive display 107, as shown in FIG. 30, an overall screen BA of the video-displaying transmissive display 107 will be irradiated and visible.

Note that, in the foregoing explanation, the longitudinal diffusion by the vertical diffusers 105, 106 was explained on the assumption of performing the diffusion only to an ideal perpendicular direction. Nevertheless, with actual longitudinal diffusion, the diffused light curves in the x axis direction as the divergence angle in the longitudinal direction increases according to the deflection angle, in the x axis direction, of the light beams that enter the vertical diffusers 105, 106. Thus, for instance, in order to irradiate the entire screen ends of the video-displaying transmissive display 107 in the x axis direction, the light beam emitting position needs to be fine-tuned relative to the emitting position that is calculated from the theoretical formula. Moreover, with regard to the condensing position, since the light beams emitted from the light source control device 120 are light beams with a width, the exit pupil is not concentrated at one point, and has a predetermined size. The size of this area is determined based on the parallelism of the light beams emitted from the surface light source 101 and the size of the opening of the mask pattern part 102.

The method of controlling the light emitted from the light source unit configured from the surface light source 101 and the mask pattern part 102 and thereby forming the exit pupil was explained above with reference to FIG. 19 to FIG. 30.

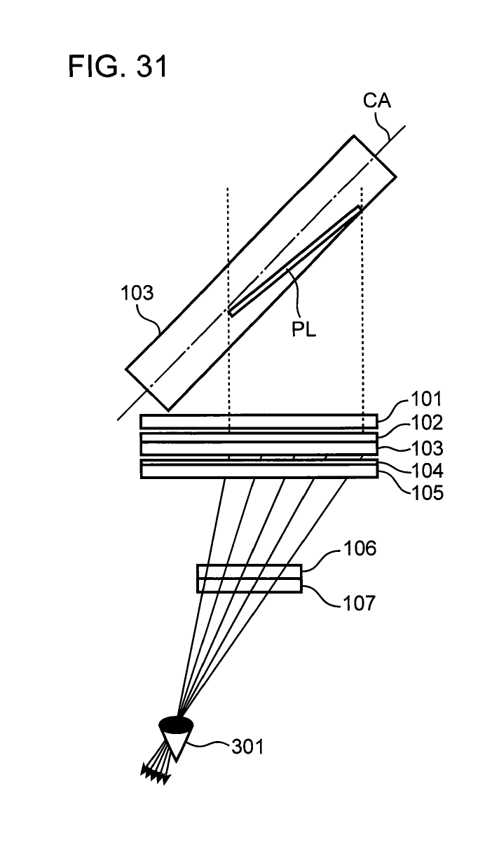

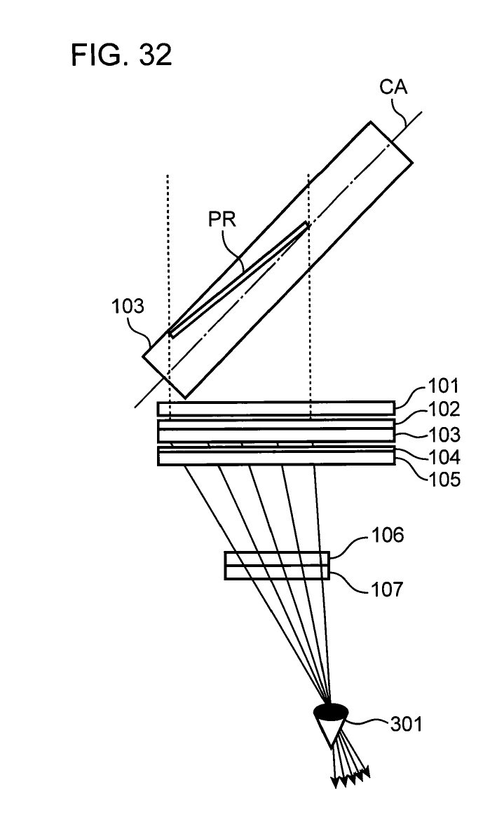

The method of forming the exit pupil at an arbitrary position is now explained. While the foregoing explanation was based on the premise that the viewpoint position is on the z axis, in reality it is not limited thereto. FIG. 31 is a schematic diagram showing the parallel beam pattern and the light beam path when forming the exit pupil at the left-side viewpoint position, and FIG. 32 is a schematic diagram showing the parallel beam pattern and the light beam path when forming the exit pupil at the right-side viewpoint position.

As shown in FIG. 31, when the exit pupil is formed at the left-side viewpoint position 301, the mask pattern part 102 generates a mask pattern for emitting the parallel beams PL, the parallel beams PL are emitted from the opening of the mask pattern, and enter the cylindrical lens 103. Here, the parallel beams PL enter from a position that is lower than the central axis CA, and enter closer to the central axis CA as they move leftward. Accordingly, the parallel beams PL are deflected by the cylindrical lens 103 such that the deflection angle decreases as they move leftward, and the exit pupil is formed at the left-side viewpoint position 301.

Meanwhile, as shown in FIG. 32, when the exit pupil is formed at the right-side viewpoint position 301, the mask pattern part 102 generates a mask pattern for emitting the parallel beams PR, the parallel beams PR are emitted from the opening of the mask pattern, and enter the cylindrical lens 103. Here, the parallel beams PR enter from a position that is higher than the central axis CA, and enter closer to the central axis CA as they move rightward. Accordingly, the parallel beams PR are deflected by the cylindrical lens 103 such that the deflection angle decreases as they move rightward, and the exit pupil is formed at the right-side viewpoint position 301.

As described above, in this embodiment, the position of forming the exit pupil can be changed by controlling the mask pattern of the mask pattern part 102 and changing the irradiating position of the parallel beams with which the cylindrical lens 103 are irradiated.

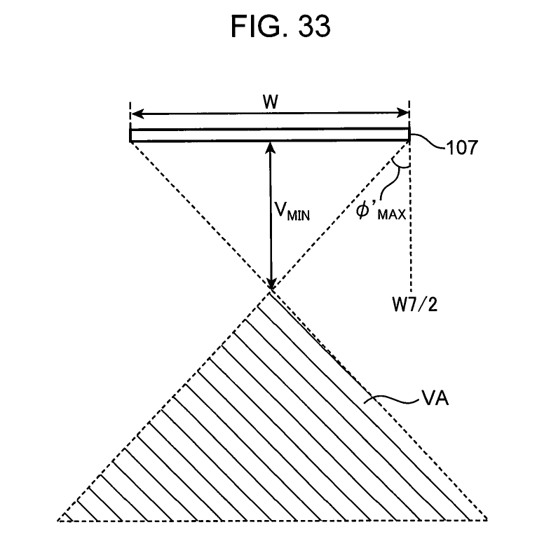

Moreover, in this embodiment, since the mask pattern part 102 can form a mask pattern of an arbitrary shape, the parallel beams PL shown in FIG. 31 and the parallel beams PR shown in FIG. 32 can be emitted simultaneously, and an exit pupil can be formed simultaneously at two viewpoints. Consequently, a video can also be presented to a plurality of viewers simultaneously. The formable range of the exit pupil in the foregoing case is now explained with reference to FIG. 33. FIG. 33 is a schematic diagram showing the formable range of the exit pupil.

When the configuration of this embodiment satisfies formula (5), light beams can be emitted from the screen end coordinates (w7/2) of the video-displaying transmissive display 107 in the x direction at the deflection angle φ′_{MAX} in the horizontal direction. Consequently, the viewable area VA will become the hatched area of FIG. 33. Here, the minimum viewing distance V_{MIN} becomes following formula (7).

V_{MIN}=w7/(2 tan φ′_{MAX}) (7)

Here, the minimum viewing distance V_{MIN} is desirably shorter than the optimal viewing distance Vd which is determined based on the resolution of the video-displaying transmissive display 107.

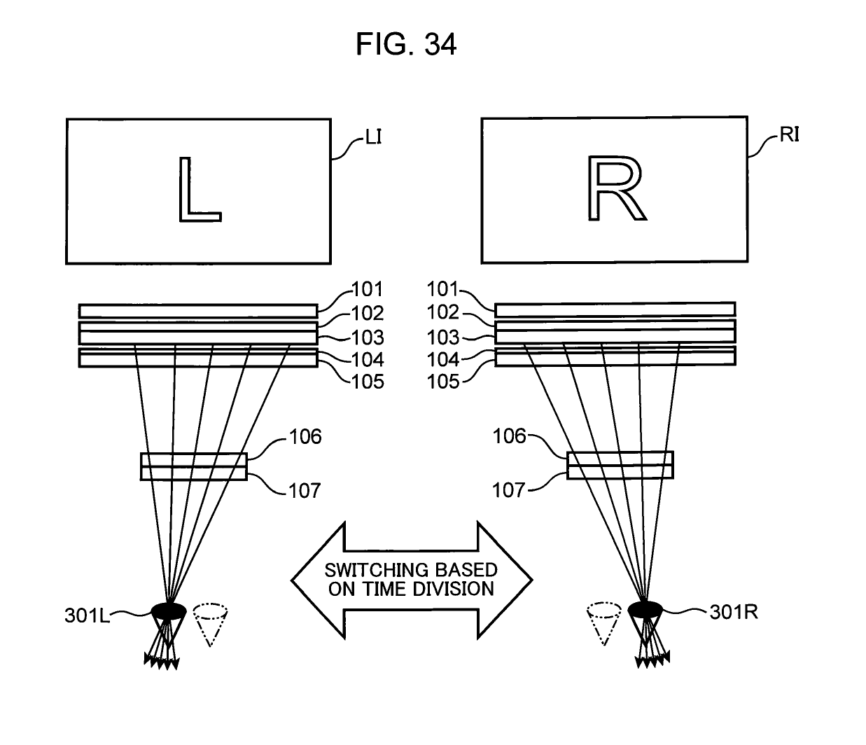

Finally, the presentation method of a 3D view to the viewer is explained. FIG. 34 is a schematic diagram explaining the presentation method of a 3D video, based on time division, in the video display device 100 shown in FIG. 1. When presenting a 3D video to a viewer, the synchronous control unit 109 synchronously control the light source control unit 108 and the video display device control unit 110. The video display device control unit 110 switches and displays the left-eye parallax image LI and the right-eye parallax image RI on the video-displaying transmissive display 107 at a time division speed that will not cause the viewer to experience any flickering. The light source control unit 108 controls, in synchronization with the switching of the parallax images, the mask pattern part 102 so as to switch the left-eye mask pattern forming the exit pupil at the viewer's left pupil position 301L and the right-eye mask pattern forming the exit pupil at the viewer's right pupil position 301R. The viewer can thereby view a 3D view with the naked eye.

Embodiment 1 was explained above with reference to FIG. 1 to FIG. 34. Accordingly, based on the foregoing configuration, in this embodiment, while maintaining the depth to be roughly the same level as the currently available displays and without degrading the resolution of the displayed image and degrading the picture quality such as through uneven brightness or the like, a plurality of viewers can simultaneously view a 3D view without using glasses, and it is also possible to display a 3D video with minimal restrictions in the viewable range, and easily switch between the 2D video display and the 3D video display. Consequently, viewers can view a 3D video, without restriction, in the same manner as a 2D video display without having to use glasses or the like.

Note that, preferably, the video display device 100 broadens the width of the diffused light to be wider than the pupil distance of the viewer. In the foregoing case, the viewer can view a brighter video.

Moreover, preferably, the video display device 100 broadens the width of the striped light beams formed by the diffused light to be wider than the pupil distance of the viewer, and displays the same video, as the video to be displayed on the video-displaying transmissive display 107, regardless of the condensing position. In the foregoing case, a bright 2D video can be displayed even with the condensing position control based on time division.

Moreover, preferably, in the mask pattern part 102 the opening of the transmissive display may be formed in a full-face opening. In the foregoing case, the video of the video-displaying transmissive display 107 can be viewed within the direction control range of the diffused light.

### Embodiment 2

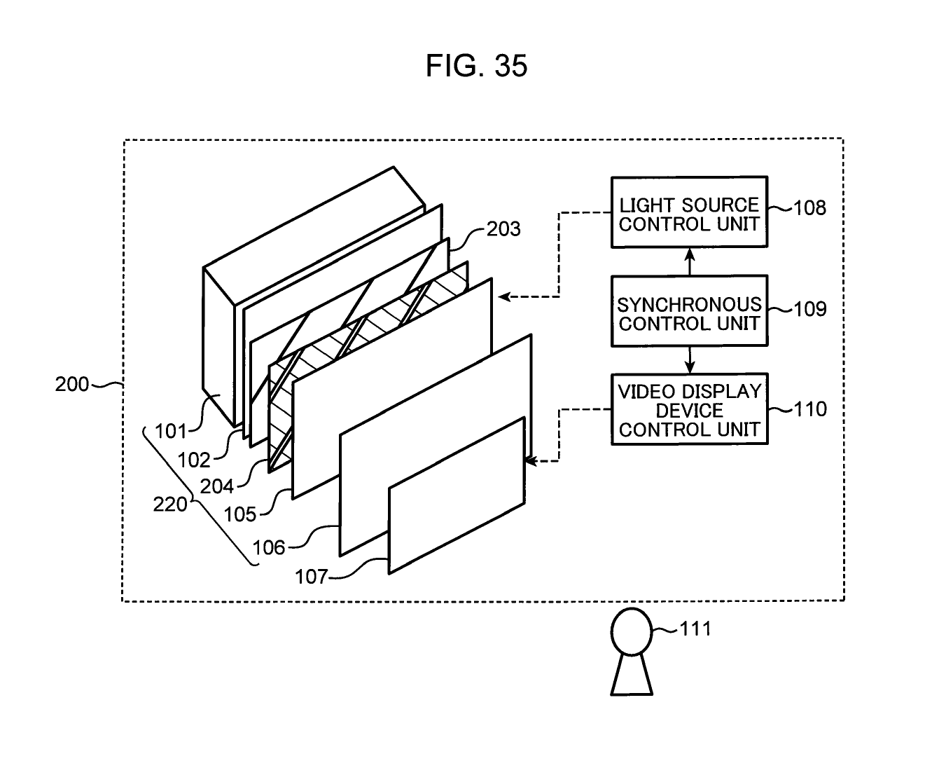

The configuration of the video display device in Embodiment 2 of the present invention is now explained with reference to FIG. 35 to FIG. 52. FIG. 35 is a schematic perspective view schematically showing the configuration of the video display device in Embodiment 2 of the present invention.

In FIG. 35, the video display device 200 comprises a light source control device 220, a video-displaying transmissive display 107, a synchronous control unit 109, and a video display device control unit 110. The light source control device 220 comprises surface light source 101 for emitting parallel beams, a mask pattern part 102, a deflector array 203, a slit 204, a vertical diffuser 105, a vertical diffuser 106, and a light source control unit 108.

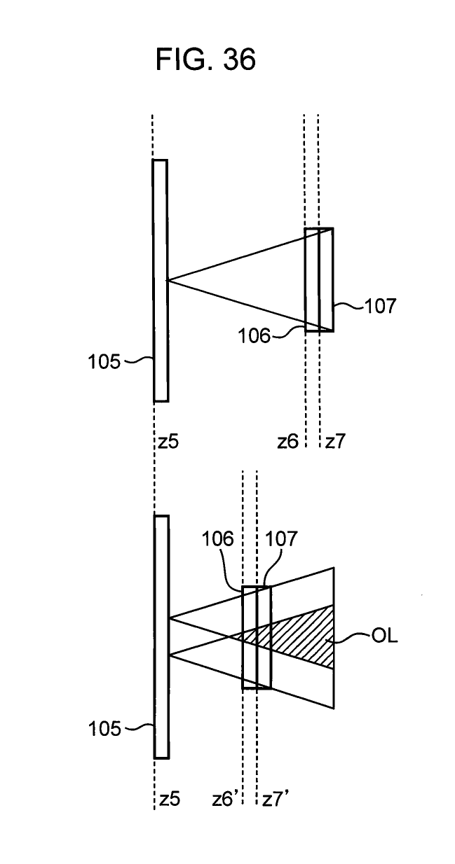

This embodiment adopts a configuration for shortening the depth of the device in comparison to Embodiment 1, and the conceptual diagram for realizing this configuration is shown in FIG. 36. FIG. 36 is a conceptual diagram explaining the configuration of shortening the depth in Embodiment 2.

The upper level of FIG. 36 is a side view upon extracting the first vertical diffuser 105, the second vertical diffuser 106 and the video-displaying transmissive display 107 in Embodiment 1. Here, in order for the light that was longitudinally diffused by the vertical diffuser 105 to be irradiated such that the entire longitudinal direction of the video-displaying transmissive display 107 is irradiated, the distance (z7−z5) between the vertical diffuser 105 and the video-displaying transmissive display 107 needs to be determined from the divergence angle ψ1 of the vertical diffuser 105. In order to shorten this distance, with the configuration of Embodiment 1, it is necessary to increase the divergence angle ψ1 of the vertical diffuser 105, but there are limits in the characteristics of the lenticular lens 801 used as the vertical diffuser 105 in Embodiment 1 in order to increase the divergence angle ψ1.

Thus, in this embodiment, as shown in the lower level of FIG. 36, by increasing the number of light beams (number of emitting positions of the light beams) emitted from the vertical diffuser 105 in the y axis direction (vertical direction), the distance (z7′−z5) between the vertical diffuser 105 and the video-displaying transmissive display 107 can be shortened in comparison to the distance (z7−z5) of Embodiment 1 while the entire video-displaying transmissive display 107 is irradiated. Note that, when the number of positions of light beams emitted from the vertical diffuser 105 is increased in the y axis direction, it is desirable to provide an overlapping area OL where the light beams overlap when the video-displaying transmissive display 107 is irradiated with the respective longitudinally diffused light beams in order to alleviate the unevenness of brightness.

Since the foregoing configuration is adopted, while the configuration of this embodiment is basically the same as the configuration of Embodiment 1, this embodiment differs from Embodiment 1 with respect to the point that the deflector 103 and the slit 104 are respectively replaced with a deflector array 203 and a slit 204. This point is now explained in detail and, since the remaining points are the same as Embodiment 1, the detailed explanation thereof is omitted.

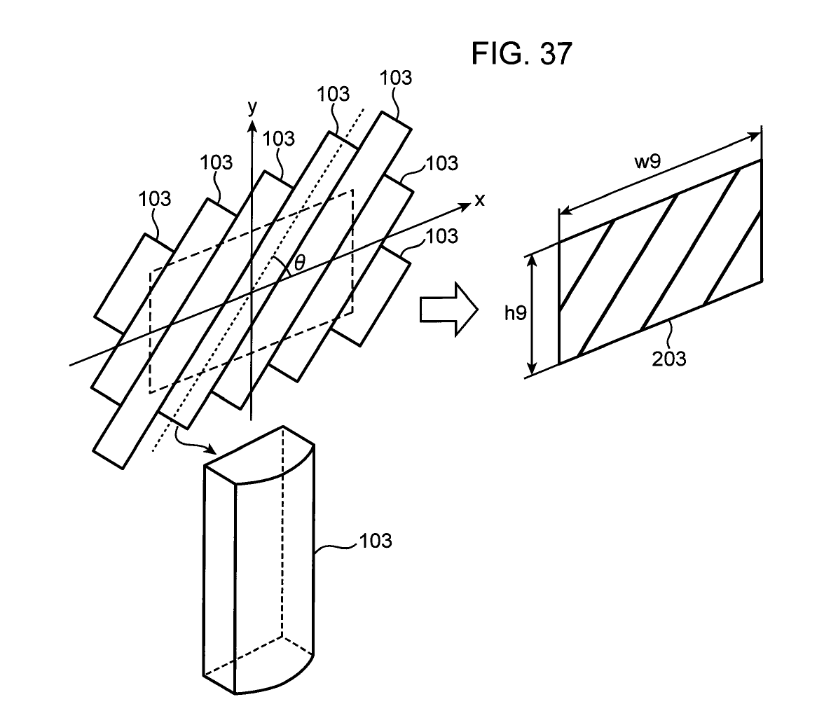

FIG. 37 is a schematic diagram explaining an example of the deflector array 203 shown in FIG. 35. As shown in the upper left level of FIG. 37, the deflector array 203 in this embodiment is an optical element array in which a plurality of deflectors 103 having a rectangular area with a width cw and a height ch, and a thickness of t3 are arranged in a manner of being tilted at a tilt angle θ relative to the x axis. In this embodiment, as the deflector 103, for instance, used is a cylindrical lens having a curvature only in the lens width direction as with Embodiment 1.

The deflector array 203 configured as described above has, as shown in the upper right level of FIG. 37, a rectangular area with a width w9 and a height h9 as the optical function plane, and the center of the deflector array 203 is on the center line of the deflector 103 in the height direction. Note that, in this embodiment, while the explanation is provided by referring to planoconvex cylindrical lenses as the deflectors configuring the deflector array 203, various types of cylindrical lens; for instance, a biconvex, a plano-concave, or a biconcave cylindrical lens may also be used, or other thin lenses such as a cylindrical Fresnel lens having the same optical property may also be used. In addition, so as long as an optical element that can deflect the parallel beams in a predetermined axial direction is used, the same effects as this embodiment can be yielded.

Here, the deflection angle of the light beams that entered the respective cylindrical lenses 103 tilted at a tilt angle θ relative to the horizontal direction is the same as formula (2) and formula (3). When the z coordinate of the entrance plane of the rectangular area of the deflector array 203 is z9, then z9≧(z2+t2).

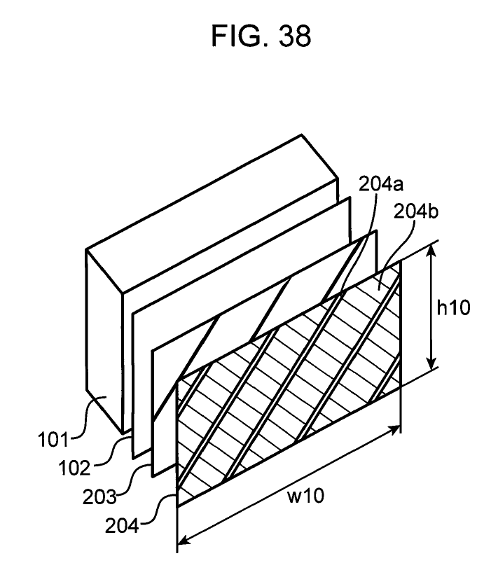

FIG. 38 is a perspective view showing the configuration of the slit 204 shown in FIG. 35. The slit 204 has a rectangular area with a width w10 and a height h10, and the thickness thereof is t10. When the z coordinate of the entrance plane of the rectangular area of the slit 204 is z10, and the z coordinate of the principal plane viewed from the light beam emission face of the deflector array 203 is z9′, when z10 is set to be a value that is approximate to (z9′+f1).

As shown in FIG. 38, the slit 204 has a plurality of openings 204a (white portions) disposed diagonally in correspondence with the respective tilted cylindrical lenses 103 of the deflector array 203, and the remaining hatched portion becomes the shielding part 204b. This kind of slit 104 is provided at the respective focal positions of the deflector array 203 to become the lens array.

Note that, while the light beams that were deflected by the deflector array 203 will theoretically pass through the respective lens focal positions, in reality the light beams will pass through a position that is slightly displaced from the focal point due to the influence of aberration or the like. Thus, the width of the openings 204a of the slit 204 needs to be a size that will not be a practical problem.

In the ensuing explanation, let it be assumed that, when the z coordinate of the vertical diffuser 105 is z11, then z11≧z10+t10, when the z coordinate of the vertical diffuser 106 is z12, then z12≧z11+t5, when the z coordinate of the video-displaying transmissive display 107 is z13, then z13≧z12+t6, and when the z coordinate of the viewpoint position 301 is z14, then z14≧z13+t7.

Note that, in this embodiment, while the deflector array 203 and the slit 204 are arranged such that the width direction of the respective rectangular areas is parallel to the x axis and the height direction is parallel to the y axis and the center of the rectangular area passes through the z axis, there is no particular limitation to the foregoing arrangement method and may be variously modified so as long as the length of the overall device in the z axis direction can be shortened in a video display device which allows a viewer to enjoy a stereoscopic view by controlling the direction of the light beams that are ultimately output from the light source control device 220 in the predetermined axial direction.

Moreover, with regard to the shape also, there is no particular limit to the foregoing shape and may be variously modified so as long as the length of the overall device in the z axis direction can be shortened in a video display device which allows a viewer to enjoy a stereoscopic view by controlling the direction of the light beams that are ultimately output from the light source control device 220 in the predetermined axial direction.

Next, with regard to the tilted deflector array 203 and the video-displaying transmissive display 107 in this embodiment, the following conditions need to be satisfied for the viewer to observe the overall screen of the video-displaying transmissive display 107.

When the z coordinate of the principal plane viewed from the light beam emission face of the tilted cylindrical lens used as the deflector 103 within the deflector array 203 is z9′, and the maximum horizontal deflection angle that can be emitted from the coordinates (w9/2) of the ends, in the x axis direction, of the deflector array 203 is φ′_{MAX}, following formula (8) will be established as the conditions in the coordinates (w7/2) of the screen ends of the video-displaying transmissive display 107 in the x axis direction and in the coordinates (w9/2) of the ends, in the x axis direction, of the deflector array 203.

w9/2≧w7/2+(z13−z9′)tan φ′_{MAX} (8)

As a result of satisfying formula (8) above, light beams that pass through the coordinates of both ends of the video-displaying transmissive display 107 in the x axis direction will exist.

Moreover, with regard to the z coordinate z14 of the viewpoint position 301, in order for the deflected light beams to form an exit pupil at the viewpoint position 301, following formula (9) needs to be established in the end coordinates (w9/2) in the x axis direction, which are the width ends of the deflector array 203 in the x axis direction.

φ′_{MAX}≧tan⁻¹(w9/2(z14−z9′)) (9)

Accordingly, the viewer's viewpoint position 301 is set forth so as to satisfy foregoing formula (9). Note that, with regard to the deflection angle φ′_{MAX} used in formula (8) and formula (9), the theoretical value can be obtained from formula (2), but with an actual lens, it will not necessarily coincide with the value of formula (2) due to an error caused by aberration. Thus, in reality, conditional expression (8) and formula (9) need to be set forth using a measured value. Moreover, with regard to the surface light source 101, the mask pattern part 102, the slit 204, the vertical diffuser 105, and the vertical diffuser 106 also, the width in the x axis direction needs to be set appropriately so that the light beam passes through an effective range of the respective constituent elements.

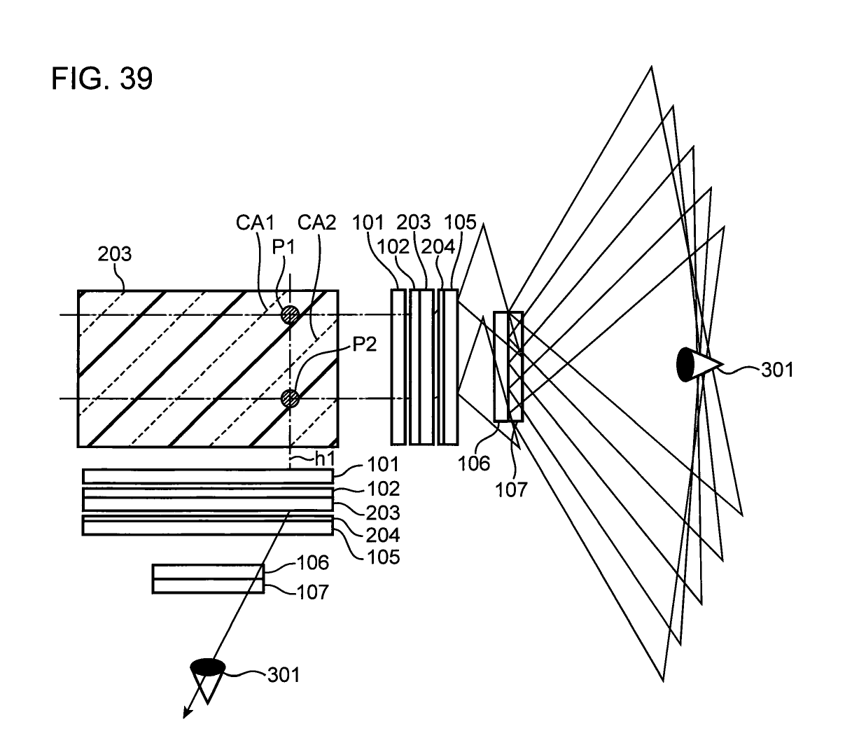

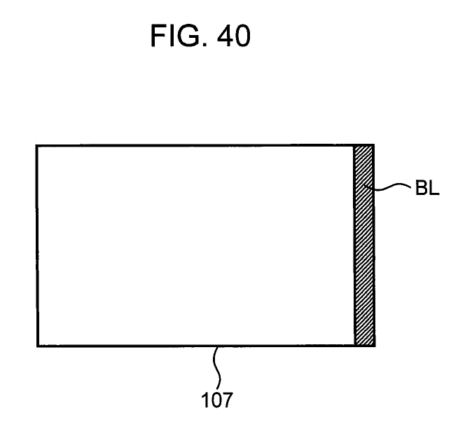

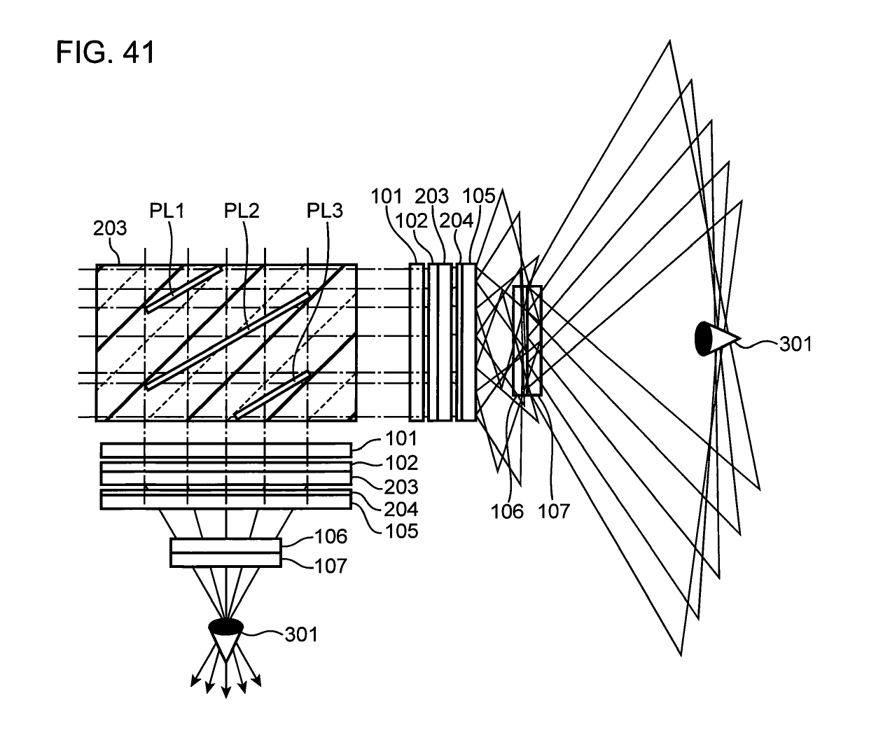

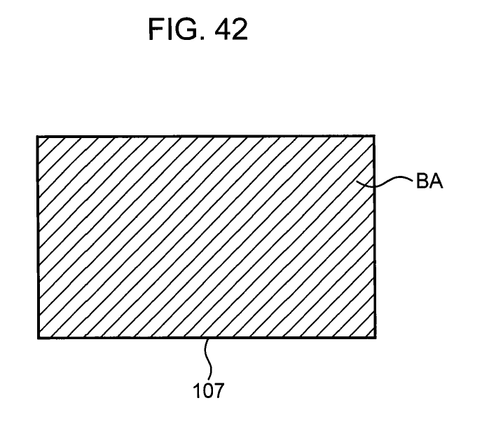

Details of Embodiment 2 using the deflector array 203 are now explained with reference to FIG. 39 to FIG. 42. FIG. 39 is a schematic diagram showing the light beam path when two light beams are emitted from the right end of the deflector array 203 in the video display device shown in FIG. 35, FIG. 40 is a diagram showing a state of the light beams in the video-displaying transmissive display when the configuration shown in FIG. 39 is adopted, FIG. 41 is a schematic diagram showing the light beam path when three light beams are emitted from the deflector array 203 in the video display device shown in FIG. 35, and FIG. 42 is a diagram showing a state of the light beams in the video-displaying transmissive display when the configuration shown in FIG. 41 is adopted.

Foremost, when w7, w9, z9′, z13, and z14 are set to satisfy formula (8) and formula (9), in terms of the xz plane, there is a method of emitting parallel beams to become the light beams that will condense at the viewpoint position 301 when the respective light beams emitted from the deflector array 203 pass through so as to satisfy all x coordinates in the video-displaying transmissive display 107 and the respective light beams are projected on the xz plane.

When the respective constituent elements are arranged so as to satisfy the foregoing conditions, a case of emitting light beams that pass through the right end of the video-displaying transmissive display 107 in the x axis direction is shown in FIG. 39. The difference between this case and FIG. 27 which shows a similar case in Embodiment 1 is the following two points.

The first point is that the number of light beams emitted from the deflector array 203 in the upper left level of FIG. 39 is now two light beams, and two parallel beams P1, P2 are emitted. This is because, since the number of cylindrical lenses in the deflector array 203 at the x coordinate h1 has increased, in the top view of the upper left level of FIG. 39, the number of positions capable of emitting the light beam path shown with the arrow in the diagram mapped on the xz plane has increased.

The second point is that, as shown with the side view of the upper right level of FIG. 39, the number of light beam emitting positions has increased at the x coordinate h1, and the distance between the vertical diffuser 105 and the video-displaying transmissive display 107 has been shortened. Thus, when the divergence angle ψ1 of the vertical diffuser 105 is the same as Embodiment 1, upon comparing the distance (z13−z11) in which the light beams that are longitudinally diffused in the y axis direction covers the screen height direction of the video-displaying transmissive display 107 as explained in FIG. 24 with the similar distance (z7-z5) in Embodiment 1, the relation of formula (10) is established.

z13−z11<z7−z5 (10)

Consequently, even when the depth of the overall configuration is shortened, as shown in FIG. 40, the vertical stripe area BL of the right ends of the screen of the video-displaying transmissive display 107 viewed from the viewpoint position 301 will be bright.

As described above, with the deflector array 203, since a plurality of cylindrical lenses are tilted and arranged, in the respective cylindrical lenses, there will be a plurality of positions where the x coordinate positions (incident horizontal positions) and the distance from the central axes CA1, CA2 will be the same, a plurality of parallel beams having the same horizontal deflection angle can be emitted from a specific x coordinate position (horizontal position) in the plurality of cylindrical lenses. Moreover, with the deflector array 203, by changing the entrance position of the parallel beams in the y axis direction (vertical direction) at the same x coordinate position (horizontal position), it is possible to emit a plurality of light beams in which the direction thereof in the x axis direction (horizontal direction) was simultaneously changed.

The light beam path upon changing the foregoing light beams into light beams that are emitted from all positions of the deflector array 203 is illustrated in FIG. 41. As the light beams to be emitted from all positions of the deflector array 203, as shown in the upper left level of FIG. 41, for instance, when the three linear parallel beams PL1 to PL3 are emitted from the deflector array 203, when the video-displaying transmissive display 107 is viewed from the viewpoint position 301, since there are light beams that advance toward the viewpoint position 301 from the overall display surface of the video-displaying transmissive display 107, as shown in FIG. 42, the overall screen BA of the video-displaying transmissive display 107 will be irradiated and visible.

Note that, with regard to the condensing position, since the light beams emitted from the light source control device 220 are light beams with a width, the exit pupil is not concentrated at one point, and has a predetermined size. The size of this area is determined based on the parallelism of the light beams emitted from the surface light source 101 and the size of the opening of the mask pattern part 102.

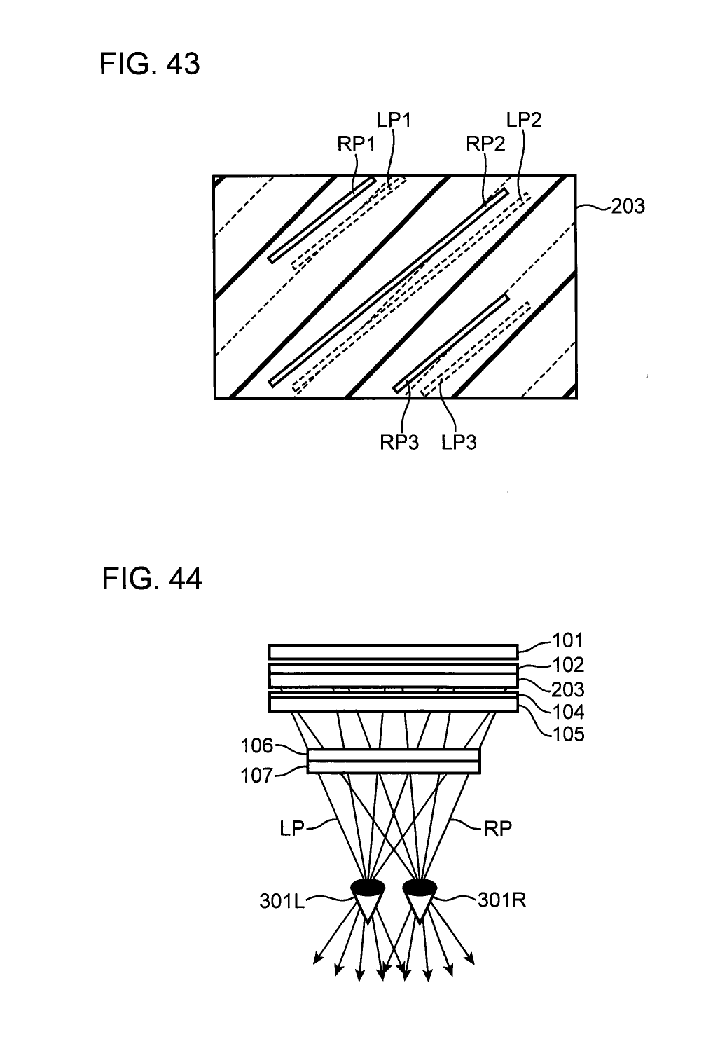

The presentation method of a 3D video to a viewer is now explained. FIG. 43 is a diagram showing an example of the entrance trajectory pattern that is used upon presenting a 3D video based on time division, and FIG. 44 is a schematic diagram showing the light beam path of the video display device 200 shown in FIG. 35 when the entrance trajectory pattern shown in FIG. 43 is used.

When presenting a 3D video to a viewer, the synchronous control unit 109 synchronously control the light source control unit 108 and the video display device control unit 110, and the video display device control unit 110 switches and displays the left-eye parallax image and the right-eye parallax image on the video-displaying transmissive display 107 at a time division speed that will not cause the viewer to experience any flickering.

Here, the light source control unit 108 controls, in synchronization with the switching of the parallax images, the mask pattern part 102 so as to switch the left-eye mask pattern forming the exit pupil at the viewer's left pupil position 301L and the right-eye mask pattern forming the exit pupil at the viewer's right pupil position 301R. As a result of the foregoing switching of the mask pattern, as shown in FIG. 43, the three linear left-eye parallel beams LP1 to LP3 and the three linear right-eye parallel beams RP1 to RP3 are emitted from the deflector array 203 based on time division.

Subsequently, as shown in FIG. 44, the left-eye parallel beams LP1 to LP3 become the light beams LP to form the exit pupil at the viewer's left pupil position 301L and the right-eye parallel beams RP1 to RP3 become the light beams RP to form the exit pupil at the viewer's right pupil position 301R, and the viewer can thereby view a 3D video with the naked eye.

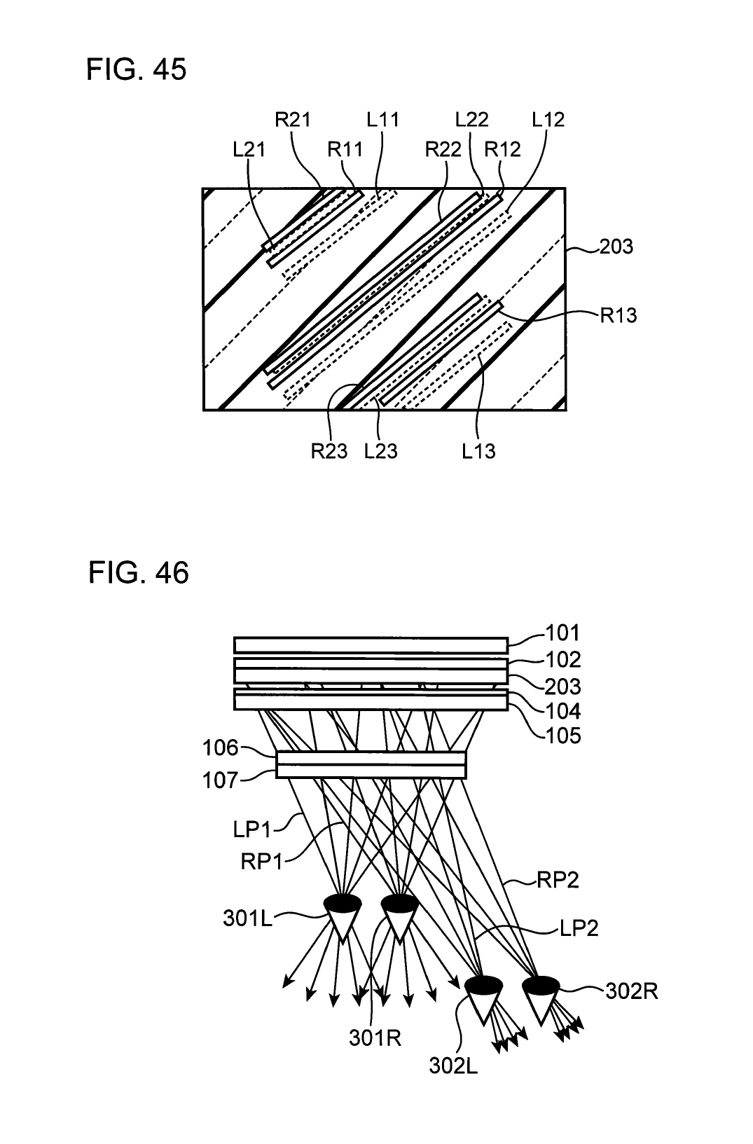

The presentation method of a 3D video to a plurality of viewers is now explained. FIG. 45 is a diagram showing an example of the entrance trajectory pattern that is used when presenting a 3D view based on time division to a plurality of viewers, and FIG. 46 is a schematic diagram showing the light beam path of the video display device 200 shown in FIG. 35 when the entrance trajectory pattern shown in FIG. 45 is used.

When presenting a 3D video to a plurality of viewers, the synchronous control unit 109 synchronously control the light source control unit 108 and the video display device control unit 110, and the video display device control unit 110 switches and simultaneously displays to the plurality of viewers the left-eye parallax image and the right-eye parallax image on the video-displaying transmissive display 107 at a time division speed that will not cause the plurality of viewers to experience any flickering.

Here, the light source control unit 108 controls, in synchronization with the switching of the parallax images, the mask pattern part 102 so as to switch, based on time division, the left-eye mask pattern forming the exit pupil at the first viewer's left pupil position 301L and forming the exit pupil at the second viewer's left pupil position 302L, and the right-eye mask pattern forming the exit pupil at the first viewer's right pupil position 301R and forming the exit pupil at the second viewer's right pupil position 302R.

As described above, as a result of switching the mask pattern, as shown in FIG. 45, based on the left-eye mask pattern, the three linear left-eye parallel beams L11 to L13 for the first viewer and the three linear left-eye parallel beams L21 to L23 for the second viewer are simultaneously emitted from the deflector array 203, and, based on the right-eye mask pattern, the three linear right-eye parallel beams R11 to R13 for the first viewer and the three linear right-eye parallel beams R21 to R23 for the second view are simultaneously emitted from the deflector array 203. Accordingly, the left-eye parallel beams L11 to L13 for the first viewer and the left-eye parallel beams L21 to L23 for the second viewer, and the right-eye parallel beams R11 to R13 for the first viewer and the right-eye parallel beams R21 to R23 for the second viewer can be emitted from the deflector array 203 based on time division.

Subsequently, as shown in FIG. 46, the left-eye parallel beams L11 to L13 for the first viewer become the light beams LP 1 to form the exit pupil at the first viewer's left pupil position 301L, the right-eye parallel beams R11 to R13 for the first viewer become the light beams RP1 to form the exit pupil at the first viewer's right pupil position 301R, and the first viewer can thereby view a 3D video with the naked eye. Moreover, the left-eye parallel beams L21 to L23 for the second viewer become the light beams LP2 to form the exit pupil at the second viewer's left pupil position 302L, the right-eye parallel beams R21 to R23 for the second viewer become the light beams RP2 to form the exit pupil at the second viewer's right pupil position 302R, and the second viewer can thereby view a 3D video with the naked eye. Consequently, a plurality of viewers can simultaneously view a 3D video with the naked eye.

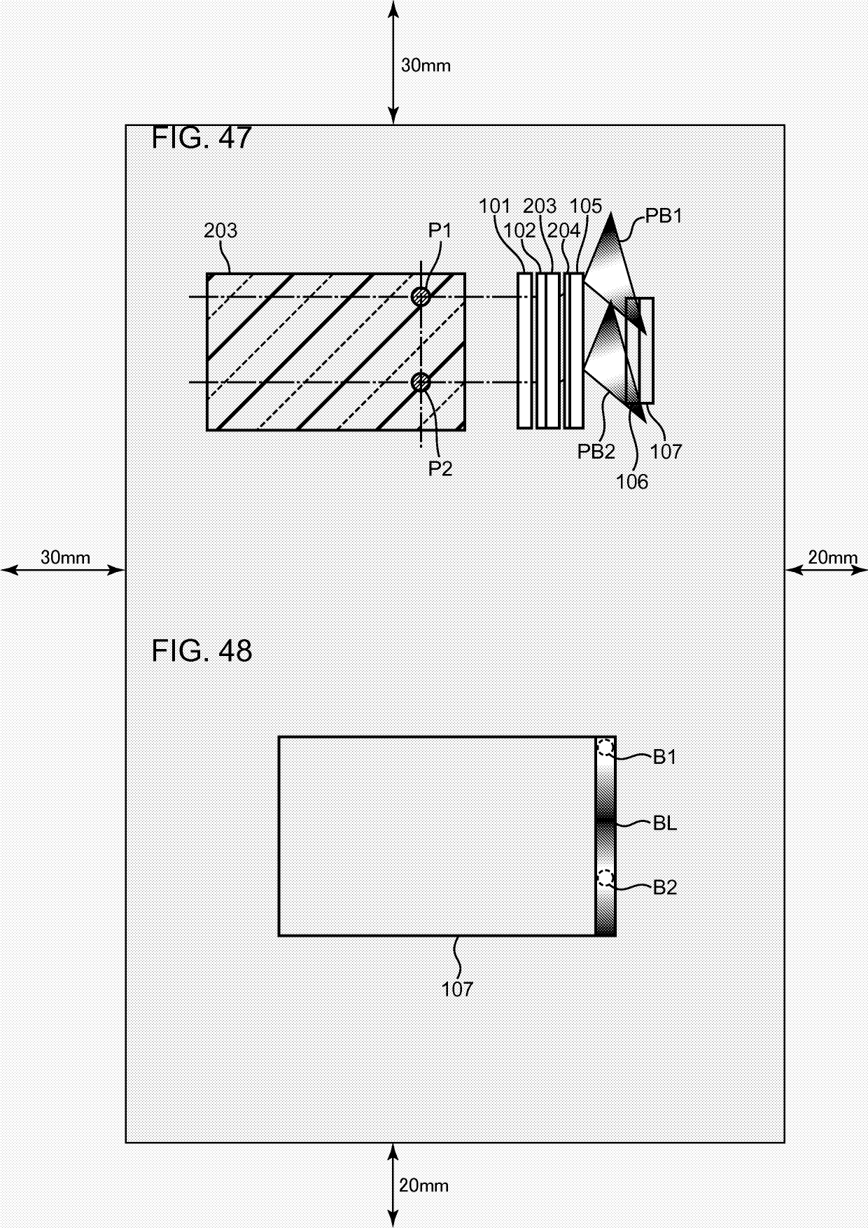

Note that, in the foregoing explanation, while the brightness distribution of a certain horizontal area was explained as being entirely uniform regardless of the height of the screen as with the front view of the video-displaying transmissive display 107 shown in FIG. 40, in reality the brightness attenuates according to the distance from the center of the diffusion point. FIG. 47 is a schematic diagram in which the decaying state of brightness has been added to the light beam path shown in FIG. 39, and FIG. 48 is a diagram in which the decaying state of brightness has been added to the state of the light beam shown in FIG. 40. Note that, in FIG. 47 and FIG. 48, the portion with high brightness is indicated in white and the portion with low brightness is indicated in black.

As shown in FIG. 47, with the diffused light PB1, PB2 emitted from the vertical diffuser 105, since the brightness will attenuate according to the distance from the center of the diffusion point, as shown in FIG. 48, in the vertical stripe area BL on the video-displaying transmissive display 107, the brightness of the center part B1 of the diffused light PB1 and the center part B2 of the diffused light PB2 becomes the highest, and the brightness decreases as the position is separated from the center parts B1, B2, and the brightness change in the longitudinal direction becomes discontinued within the horizontal area. Meanwhile, since a person's eyes are sensitive to the discontinuity of brightness, the brightness change in the longitudinal direction will be recognized as an uneven brightness. In order to avoid this, the diffusion characteristics of the vertical diffuser 105 must be selected so that the brightness change becomes smooth.

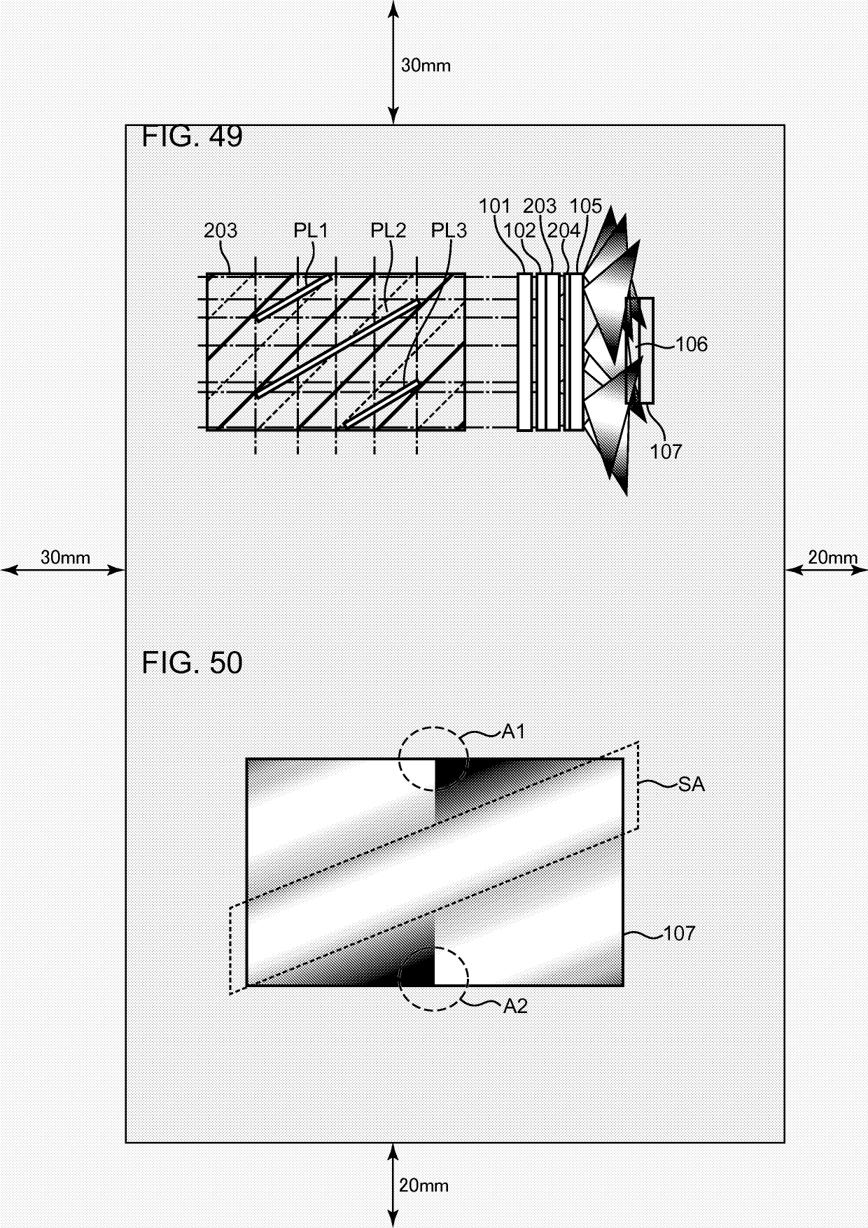

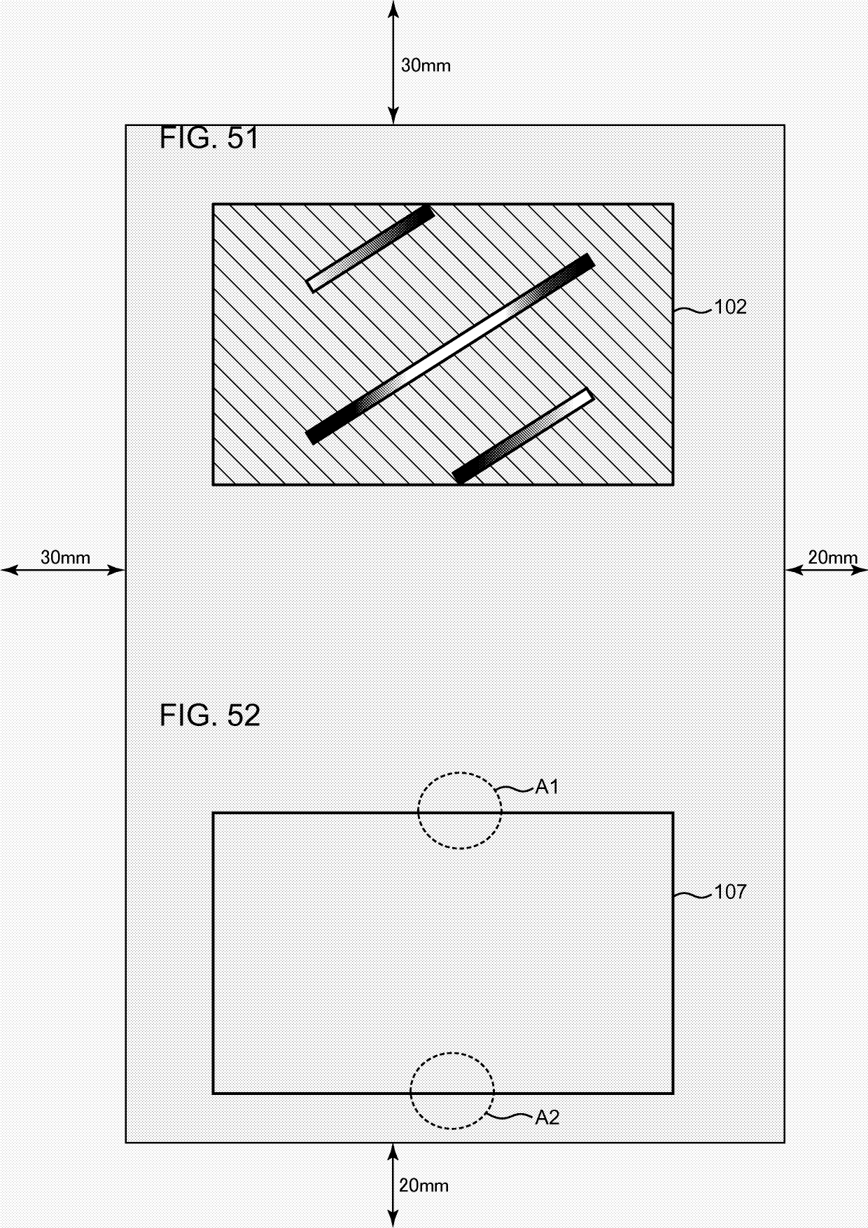

FIG. 49 is a schematic diagram in which the decaying state of brightness has been added to the light beam path shown in FIG. 41, and FIG. 50 is a diagram in which the decaying state of brightness has been added to the state of the light beam shown in FIG. 42.

Foremost, as a continuous pattern, considered is a case of emitting three linear parallel beams PL1 to PL3 as shown in FIG. 49. The brightness change in the video-displaying transmissive display 107 in the foregoing case will be the state shown in FIG. 50. The parallel beams PL2 that entered the center of the deflector array 203 will diffuse as shown with a square area SA enclosed with a dotted line in FIG. 50. Here, the square area SA will attenuate as explained with reference to FIG. 48 according to the distance from the position corresponding to the parallel beams PL2.

Meanwhile, as with the circular portions A1, A2 circled with a broken line in FIG. 50, there are areas where a considerably brightness difference in the horizontal direction occurs at the boundary of each cylindrical lens of the deflector array 203. This will occur without fail regardless of the characteristics of the vertical diffuser 105.

Thus, in order to alleviate the discontinuity of brightness in the horizontal direction, the light source control unit 108 causes the diffusion distribution of the light beams emitted from the vertical diffuser 105 to be uniform by gradually changing the aperture ratio of the opening of the mask pattern part 102 according to the vertical direction position on the mask pattern. FIG. 51 is a diagram showing an example of controlling the aperture ratio of the mask pattern part 102 based on the light source control unit 108, and FIG. 52 is a diagram showing the state of brightness of the video-displaying transmissive display 107 corresponding to the control example of the aperture ratio of the mask pattern part 102 shown in FIG. 51.

As shown in FIG. 51, the light source control unit 108 controls the aperture ratio of the opening of the mask pattern part 102 so that the brightness of the midsection of the opening of the mask pattern in the vertical direction (y direction) becomes highest, and the brightness decreases as the position is separated from the midsection.

As described above, by controlling the aperture of the opening of the mask pattern part 102, as shown in FIG. 52, it is possible to eliminate the brightness difference, in the horizontal direction, of the circular portions A1, A2 circled with a broken line corresponding to the boundary of each cylindrical lens of the deflector array 203, and alleviate the discontinuity of the horizontal direction brightness on the video-displaying transmissive display 107 and, consequently, it will be difficult for the viewer to feel any uneven brightness.

Embodiment 2 was explained above with reference to FIG. 34 to FIG. 52. Accordingly, based on the foregoing configuration, in this embodiment, in addition to yielding the same effects as Embodiment 1, it is possible to shorten the depth of the device in comparison to Embodiment 1 and, therefore, the depth of the device can be made to be roughly the same level as the currently available displays, and the degradation of the picture quality such as through uneven brightness or the like can be prevented.

### Embodiment 3

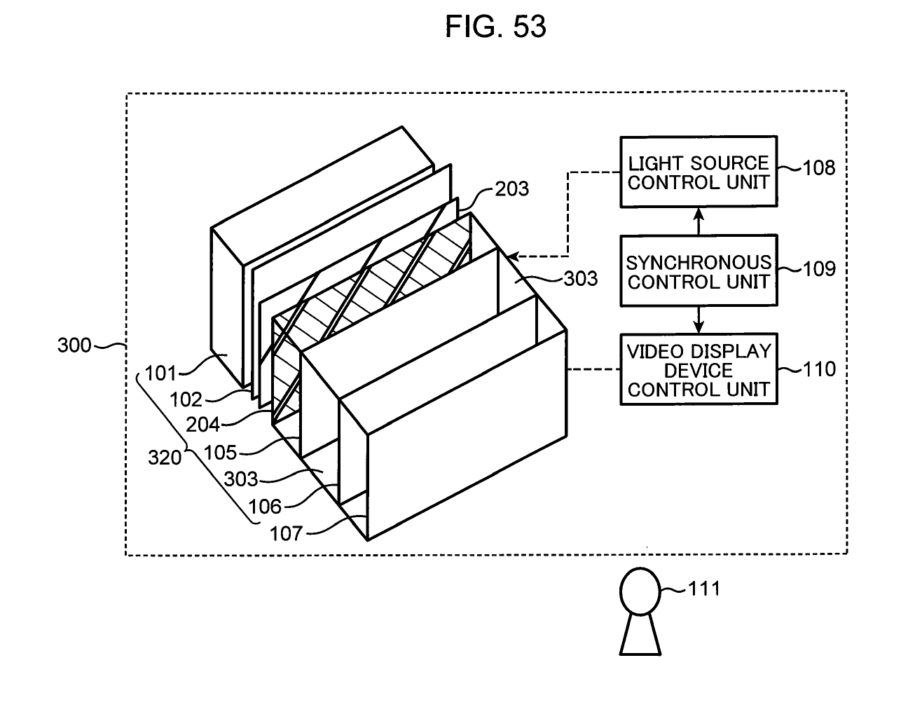

The configuration of the video display device in Embodiment 3 of the present invention is now explained with reference to FIG. 53 to FIG. 59. FIG. 53 is a schematic perspective view schematically showing the configuration of the video display device in Embodiment 3 of the present invention.

In FIG. 53, the video display device 300 comprises a light source control device 320, a video-displaying transmissive display 107, a synchronous control unit 109, and a video display device control unit 110. The light source control device 220 comprises a surface light source 101 for emitting parallel beams, a mask pattern part 102, a deflector array 203, a slit 204, a vertical diffuser 105, a vertical diffuser 106, two left-right mirrors 303, and a light source control unit 108.

This embodiment adopts a configuration for shortening the horizontal width of the overall device in comparison to Embodiment 2, and, while the configuration is basically the same as the configuration of Embodiment 2, this embodiment differs from Embodiment 2 with respect to the point that a left-right mirror 303 has been added.

In this embodiment, the left-right mirror 303 is disposed on the left-side face and the right-side face of the video display device 300 (light source control device 320), and is a mirror which reflects the light beams emitted from the deflector array 203 into the device. The left-right mirror 303 has a rectangular area with a width w15 and a height h15, and the thickness thereof is t15. The left-right mirror 303 is disposed at the left-side face and the right-side face between the slit 204 and the video-displaying transmissive display 107 so that the rectangular area is parallel to the yz plane. Thereupon, when the x coordinate of the reflective surface in the rectangular area is x15 and the z coordinate on the side of the surface light source 101 of the reflective surface is z15, the left-right mirror 303 is disposed so as to satisfy conditional expressions (11) to (13) below. Note that the symbol of x15 is determined depending on whether the left-right mirror 303 is to be mounted on the left side or right side of the device.

w15=z14−z10 (11)

x15=±w10/2 (12)

z15=z10 (13)

In Embodiments 1 and 2, formula (5) and formula (8) were limiting conditions, and the size of the video-displaying transmissive display 107 in the width direction was small in comparison to the size of the deflector 103 or the deflector array 203 in the width direction. Nevertheless, in this embodiment, by using the left-right mirror 303, the foregoing restriction can be eliminated. Consequently, for instance, the video display screen of the video display device 300 can be configured to be roughly the same size as the outer shape of currently available flat-screen TVs.

However, with regard to the surface light source 101, the mask pattern part 102, the deflector array 203, the slit 204, the vertical diffuser 105, the vertical diffuser 106, and the video-displaying transmissive display 107, the width in the x axis direction and the height in the y axis direction need to be set appropriately so that the light beams will pass through the effective range of the respective constituent elements.

Note that, in this embodiment, while the left-right mirror 303 is disposed so that the width direction of the respective rectangular areas is parallel to the z coordinate and the height direction is parallel to the y axis, there is no particular limitation to the foregoing arrangement method and may be variously modified so as long as a length is reduced in the x axis direction in a video display device which allows a viewer to enjoy a stereoscopic view by controlling the direction of the light beams that are ultimately output from the light source control device 320 in the predetermined axial direction.

Moreover, with regard to the shape of the left-right mirror 303 also, there is no particular limitation to the foregoing shape and may be variously modified so as long as the length of the device in the x axis direction can be shortened in a video display device which allows a viewer to enjoy a stereoscopic view by controlling the direction of the light beams that are ultimately output from the light source control device 320 in the predetermined axial direction.

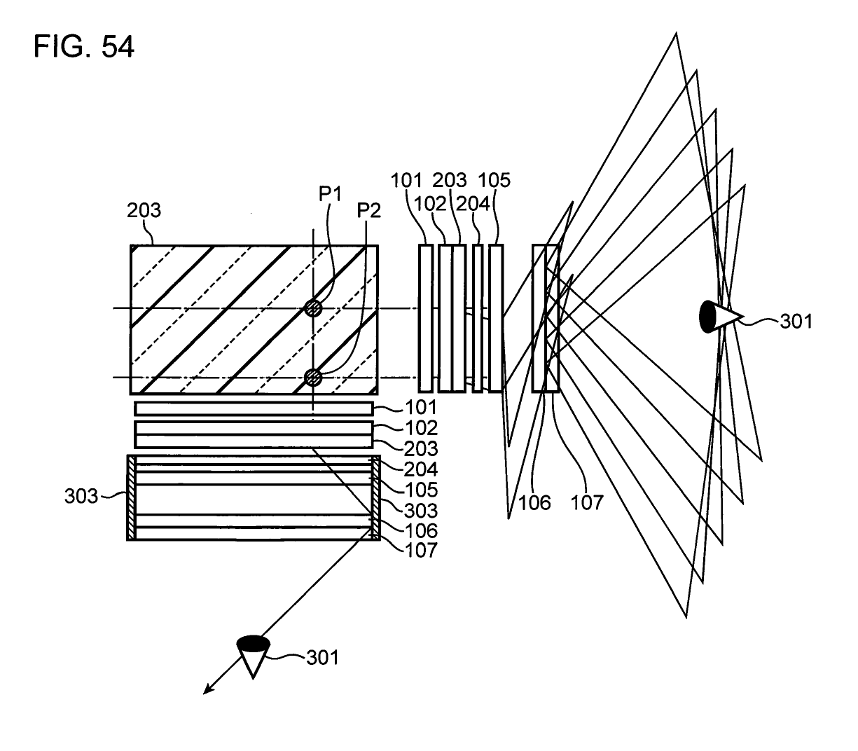

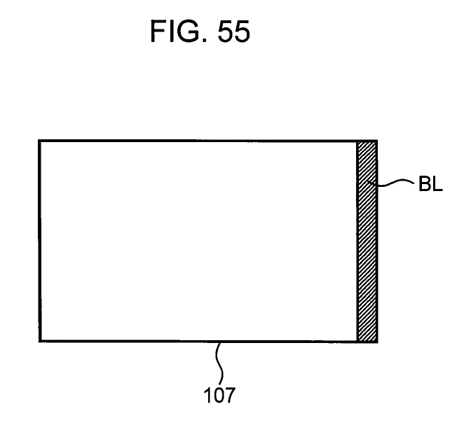

Next, when the respective constituent elements including the left-right mirror 303 are disposed so as to satisfy the foregoing conditions, the case of emitting light beams that pass through the right end of the video-displaying transmissive display 107 in the x axis direction is shown in FIG. 54. FIG. 54 is a schematic diagram showing the light beam path when two light beams are emitted from the right end of the deflector array 203 in the video display device shown in FIG. 53, and FIG. 55 is a diagram showing a state of the light beams in the video-displaying transmissive display 107 when the configuration shown in FIG. 54 is adopted.

The difference between FIG. 54 and FIG. 39 which shows a similar example in Embodiment 2 is as follows. In other words, in the case of Embodiment 2, in order to emit laser beams that pass through the right end of the screen of the video-displaying transmissive display 107 and also pass through the viewpoint position 301, the light beams needed to be emitted from a position in which the x coordinate in the deflector array 203 is greater than (w7/2) based on conditional expression (8).

Nevertheless, in this embodiment, by providing the left-right mirror 303 at the left side and right side of the device, as shown in FIG. 54, the light beams P1, P2 emitted from a position in which the x coordinate in the deflector array 203 is smaller than (w7/2) are reflected by the left-right mirror 303, and then reach the viewpoint position 301. Consequently, even when the length of the overall configuration in the width direction is shortened, as shown in FIG. 55, the brightness of the vertical stripe area BL of the right end of the screen of the video-displaying transmissive display 107 viewed from the viewpoint position 301 will increase.

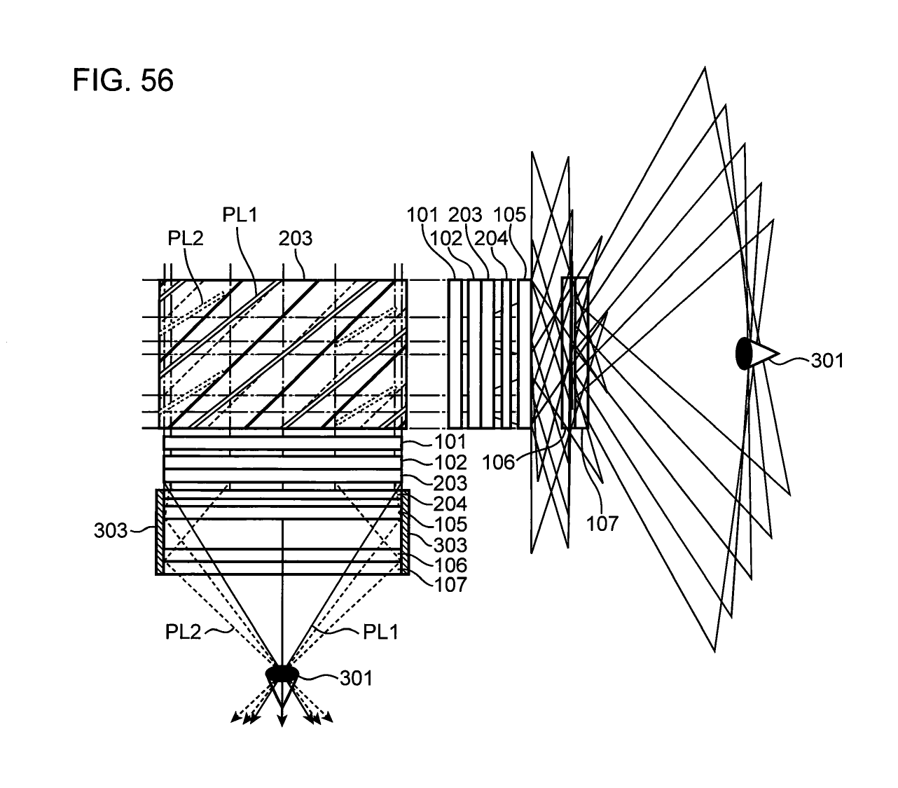

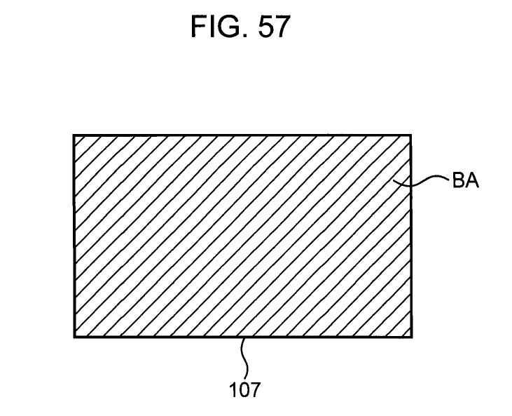

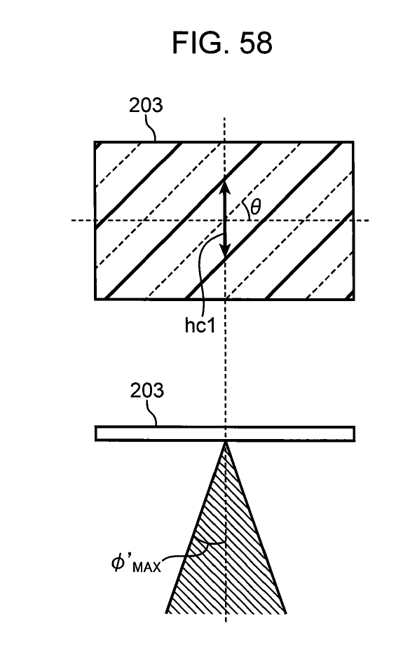

The light beam path when the foregoing light beams are changed to the light beams emitted from all positions of the deflector array 203 is illustrated in FIG. 56. FIG. 56 is a schematic diagram showing the light beam path when a plurality of parallel beams are emitted from the deflector array in the video display device shown in FIG. 53, and FIG. 57 is a diagram showing a state of the light beams in the video-displaying transmissive display when the configuration shown in FIG. 56 is adopted.

In the lower left level of FIG. 56, the light beams PL1 that directly pass through the viewpoint position 301 after being emitted from the deflector array 203 are indicated with a solid line, and the light beams PL2 that pass through the viewpoint position 301 after being reflected off the left-right mirror 303 are shown with a broken line. As shown in the upper left level of FIG. 56, when the plurality of linear parallel beams PL1, PL2 are emitted from the deflector array 203, since there are light beams that advance toward the viewpoint position 301 from the overall display surface of the video-displaying transmissive display 107 when viewing the video-displaying transmissive display 107 from the viewpoint position 301, as shown in FIG. 57, the overall screen BA of the video-displaying transmissive display 107 will be irradiated and visible.

Note that, with regard to the condensing position, since the light beams emitted from the light source control device 320 are light beams with a width, the exit pupil is not concentrated at one point, and has a predetermined size. The size of this area is determined based on the parallelism of the light beams emitted from the surface light source 101 and the size of the opening of the mask pattern part 102.

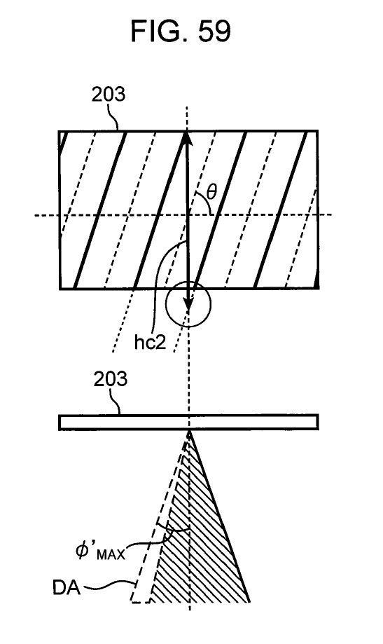

The desirable range of the tilt angle θ from the x axis of the cylindrical lens, which is a constituent element of the deflector array 203, in this embodiment is now explained. FIG. 58 is a schematic diagram explaining the relation of a small tilt angle θ of the deflector array 203 and the deflecting range of the light beams, and FIG. 59 is a schematic diagram explaining the relation of a large tilt angle θ of the deflector array 203 and the deflecting range of the light beams.

FIG. 58 and FIG. 59 differ with respect to the tilt angle θ of the deflector array 203, and, in comparison to FIG. 58, with the case of FIG. 59, the tilt angle θ of the cylindrical lens configuring the deflector array 203 is greater. Here, the lengths hc1, hc2 of the cylindrical lens in the y axis direction shown with the arrow are represented as hc in formula (4).

Here, the lower level of FIG. 58 shows the horizontal deflectable range (hatched area in the diagram) of the light beams at the x coordinate position of the deflector array 203 corresponding to the length hc1 in the y axis direction in the upper level, and the horizontal deflectable range follows φ′_{MAX}. Meanwhile, as shown in FIG. 59, when the lens tilt angle θ increases and the length hc2 of the cylindrical lens in the y axis direction becomes greater than the height h9 of the deflector array 203, there will be an area that cannot be deflected such as the portion DA enclosed with a dotted line shown in the lower level. This portion DA enclosed with the dotted line corresponds to the circled portion in the upper level.

As described above, the occurrence of an area that cannot be deflected in the deflector array 203 means that an area where the overall screen cannot be viewed will also occur within the viewable area VA shown with the diagonal lines in FIG. 33. In order to avoid this, as shown in FIG. 58, it is necessary to restrict the lens tilt angle θ from becoming too great.

In order to satisfy the foregoing condition, the length hc of the cylindrical lens in the y axis direction needs to be smaller than the height h9 of the deflector array 203, and following formula (14) needs to be satisfied.

θ≦cos⁻¹(cw/h9) (14)

Furthermore, in order to suppress the uneven brightness in the longitudinal direction during the diffusion by the vertical diffuser 105, preferably, there are two positions (points) on the same x coordinate of the deflector array 203 that can emit the light beams. In order to satisfy this condition, the length that is double the length hc of the cylindrical lens in the y axis direction needs to be smaller than the height of the deflector array 203, and following formula (15) needs to be satisfied.

θ≦cos⁻¹(2cw/h9) (15)

Formula (14) above shows the minimum requirements, and practically speaking it would be desirable to satisfy formula (15).

The lower limit of the tilt angle θ of the deflector array 203 is now explained. With regard to the minimum viewing distance V_{MIN}, and the optimal viewing distance Vd that is determined based on the resolution of the video-displaying transmissive display 107, following formula (16) needs to be satisfied for the viewer to view an optimal video.

Vd≧V_{MIN} (16)

Here, the minimum viewing distance V_{MIN} is determined by the deflection angle φ′_{MAX} in the horizontal direction from the screen end coordinates (w7/2) of the video-displaying transmissive display 107 in the x direction based on FIG. 22. Since the deflection angle φ′_{MAX} can be represented with formula (2), when formula (2) is arranged with tan φ′_{MAX}, this will result in following formula (17).

tan φ′_{MAX}=(cw/2f1)sin θ (17)

Moreover, when the minimum viewing distance V_{MIN} is represented with the deflection angle φ′_{MAX} from FIG. 33, this will result in following formula (18).

V_{MIN}=w7/(2 tan φ′_{MAX}) (18)

Based on formulas (16) to (18) above, the lower limit of the tilt angle θ of the deflector array 203 will be following formula (19).

θ≧sin⁻¹((f1×w7)/(cw×Vd)) (19)

Accordingly, the tilt angle θ of the deflector array 203 preferably satisfies the following formula.

sin⁻¹((f1×w7)/(cw×Vd)≦θ≦cos⁻¹(cw/h9) (20)

In the foregoing case, the viewer can view the overall screen of the video-displaying transmissive display 107 within the viewing area, and view an optimal video that matches the resolution of the video-displaying transmissive display 107.

The configuration of shortening the depth in Embodiment 3 was explained above with reference to FIG. 53 to FIG. 59. Note that, in this embodiment, while the left-right mirror 303 was added to the configuration of Embodiment 2, the horizontal width of the overall device can also be shortened by adding the left-right mirror 303 to the configuration of Embodiment 1.

### Embodiment 4

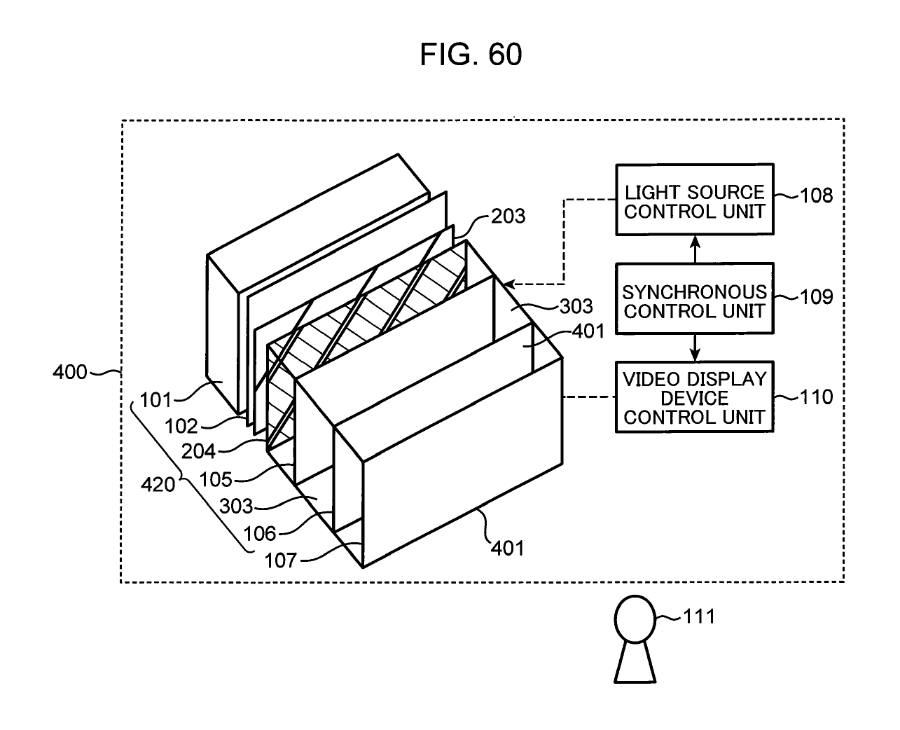

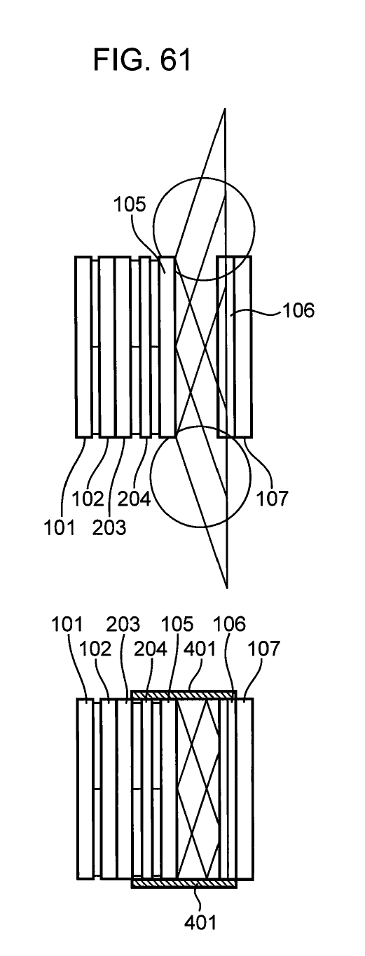

The configuration of the video display device in Embodiment 4 of the present invention is now explained with reference to FIG. 60 and FIG. 61. FIG. 60 is a schematic perspective view schematically showing the configuration of the video display device in Embodiment 4 of the present invention.

In FIG. 60, the video display device 400 comprises a light source control device 420, a video-displaying transmissive display 107, a synchronous control unit 109, and a video display device control unit 110. The light source control device 420 comprises a surface light source 101 for emitting parallel beams, a mask pattern part 102, a deflector array 203, a slit 204, a vertical diffuser 105, a vertical diffuser 106, two left-right mirrors 303, two up-down mirrors 401, and a light source control unit 108.

This embodiment adopts a configuration for enhancing the utilization efficiency of the light source in comparison to Embodiment 3 and, while this embodiment is basically the same as Embodiment 3, this embodiment differs from Embodiment 3 with respect to the point that an up-down mirror 401 has been added.

In this embodiment, the up-down mirror 401 is disposed at the upper face and the bottom face of the video display device 400 (light source control device 420), and is a mirror which reflects the light beams emitted from the deflector array 203 into the device. The up-down mirror 401 has a rectangular area with a width w16 and a height h16, and the thickness thereof is t16. The up-down mirror 401 is disposed at the upper face and the bottom face between the slit 204 and the video-displaying transmissive display 107 so that the rectangular area is parallel to the xz plane. Thereupon, when the y coordinate of the reflective surface in the rectangular area is y16 and the z coordinate on the side of the surface light source 101 of the reflective surface is z16, the up-down mirror 401 is disposed so as to satisfy conditional expressions (21) to (23) below. Note that the symbol of y16 is determined depending on whether the up-down mirror 401 is to be mounted on top or bottom of the device.

w16=z14−z10 (21)

y16=±h10/2 (22)

z16=z10 (23)

However, with regard to the surface light source 101, the mask pattern part 102, the deflector array 203, the slit 204, the vertical diffuser 105, the vertical diffuser 106, and the video-displaying transmissive display 107, the width in the x axis direction and the height in the y axis direction need to be set appropriately so that the light beams will pass through the effective range of the respective constituent elements.

Note that, in this embodiment, while the up-down mirror 401 is disposed so that the width direction of the respective rectangular areas is parallel to the z coordinate and the height direction is parallel to the x axis, there is no particular limitation to the foregoing arrangement method and may be variously modified so as long as the light source utilization efficiency of the device can be enhanced in a video display device which allows a viewer to enjoy a stereoscopic view by controlling the direction of the light beams that are ultimately output from the light source control device 420 in the predetermined axial direction.

Moreover, with regard to the shape of the up-down mirror 401 also, there is no particular limit to the foregoing shape and may be variously modified so as long as the light source utilization efficiency of the device can be enhanced in a video display device which allows a viewer to enjoy a stereoscopic view by controlling the direction of the light beams that are ultimately output from the light source control device 420 in the predetermined axial direction.

Next, the difference in the case of disposing the respective constituent elements including the up-down mirror 401 to satisfy the foregoing conditions and the case of not disposing the up-down mirror 401 is explained taking the light beams that pass through the midsection of the video-displaying transmissive display 107 in the x axis direction. FIG. 61 is a schematic diagram explaining the light source utilization efficiency-enhancing effect based on the up-down mirror 401 shown in FIG. 60.

The upper level of FIG. 61 is a side view of the case in which the up-down mirror 401 is not disposed. When the up-down mirror 401 is not disposed, as shown with the circled portions in the diagram, a part of the light that was longitudinally diffused by the vertical diffuser 105 does not pass through the video-displaying transmissive display 107. Meanwhile, the lower level of FIG. 61 is a side view of the case where the up-down mirror 401 is disposed as in this embodiment. As shown in the lower level of FIG. 61, when the up-down mirror 401 is disposed, the foregoing light can be eliminated. Accordingly, since the light reflected by the up-down mirror 401 is diffused by the vertical diffuser 106, the light beams that ultimately pass through the viewpoint position will increase.

The configuration of enhancing the utilization efficiency of the light source in Embodiment 4 was explained above with reference to FIG. 60 and FIG. 61. Note that, in this embodiment, while the up-down mirror 401 was added to Embodiment 3, the utilization efficiency of the light source can also be enhanced by adding the up-down mirror 401 to Embodiments 1 and 2.

### Embodiment 5

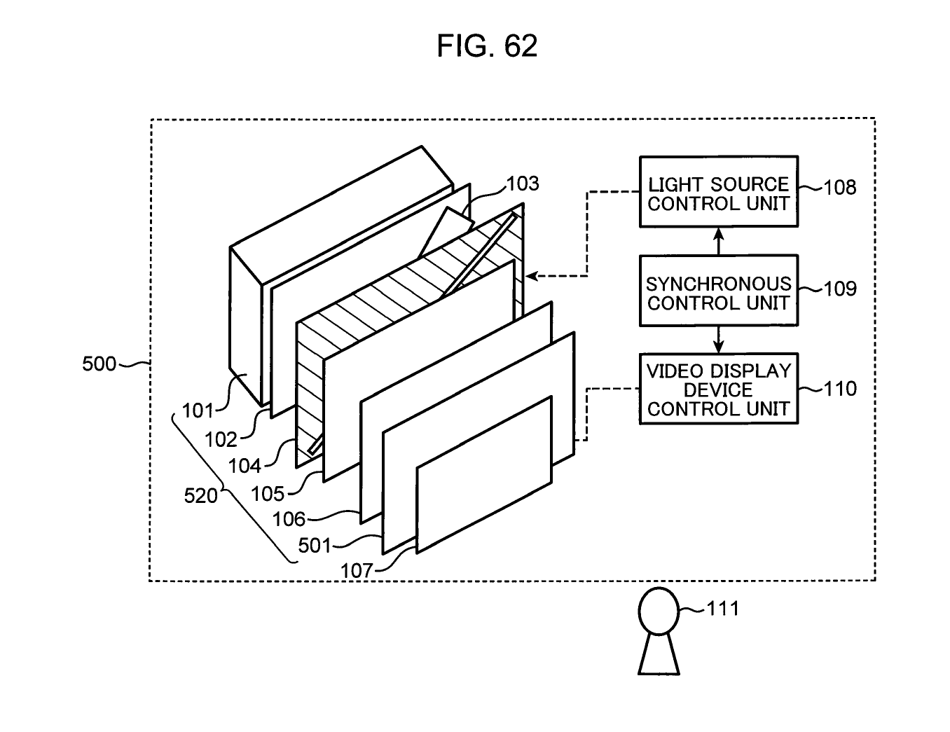

The configuration of the video display device in Embodiment 5 of the present invention is now explained with reference to FIG. 62 to FIG. 64. FIG. 62 is a schematic perspective view schematically showing the configuration of the video display device in Embodiment 5 of the present invention.

In FIG. 62, the video display device 500 comprises a light source control device 520, a video-displaying transmissive display 107, a synchronous control unit 109, and a video display device control unit 110. The light source control device 520 comprises a surface light source 101 for emitting parallel beams, a mask pattern part 102, a deflector 103, a slit 104, a vertical diffuser 105, a vertical diffuser 106, a field lens 501, and a light source control unit 108.

This embodiment adopts a configuration for broadening the viewable range in comparison to Embodiment 1 and, while this embodiment is basically the same as Embodiment 1, this embodiment differs from Embodiment 1 in that a field lens 501 has been added.

In this embodiment, the field lens 501 is disposed between the vertical diffuser 106 and the video-displaying transmissive display 107, and changes the travelling direction of the diffused light that was diffused by the vertical diffuser 106. The field lens 501 has a rectangular area with a width w17 and a height h17, and the thickness thereof is t17. Accordingly, when the z coordinate of the entrance plane of the field lens 501 is z17, then z17≧(z6+t6) is satisfied, and when the z coordinate of the video-displaying transmissive display 107 is z18, then z18≧z17+t17.

As the field lens 501, for instance, a Fresnel lens is used, but a standard lens may also be used, and a cylindrical lens or a cylindrical Fresnel lens having a curvature only in the x axis direction may also be used. In addition, the same effects as this embodiment can be yielded so as long as an optical element capable of deflecting the light beams in a predetermined axial direction is used.

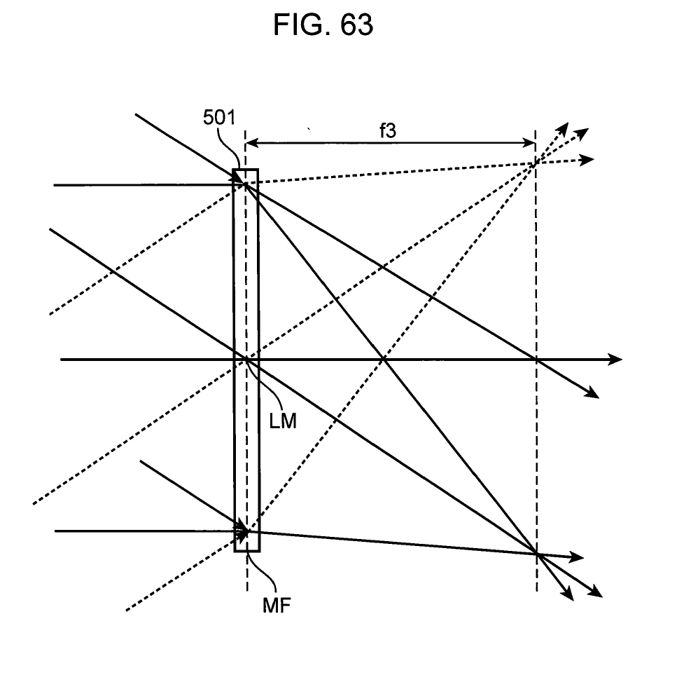

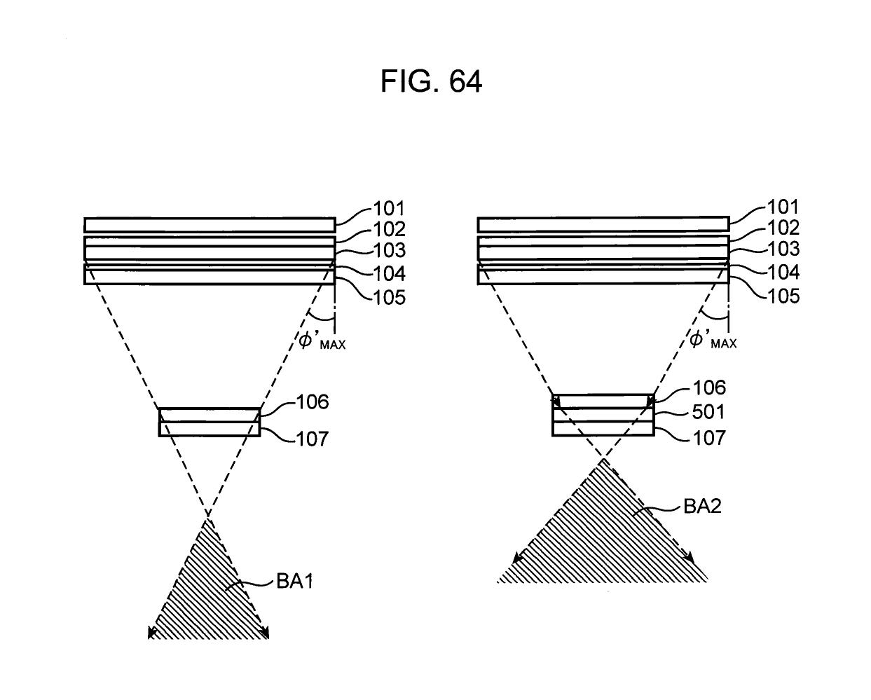

FIG. 63 is a plan view showing the paths of the light beams that pass through the field lens 501 shown in FIG. 62. As shown in FIG. 63, of the light that entered the lens deflect direction at various angles, the light that passes through the lens principal point LM travels straight ahead, and the remaining light condenses at a position that is separated from the principal plane MF at a distance of a focal length f3. Note that, in reality, the condensing position has a measurable size due to the influence of aberration.

Note that, in this embodiment, while the field lens 501 is arranged such that the width direction of the rectangular area is parallel to the x axis and the height direction is parallel to the y axis and the center of the rectangular area passes through the z axis, there is no particular limitation to the foregoing arrangement method and may be variously modified so as long as the viewable range can be expanded in a video display device which allows a viewer to enjoy a stereoscopic view by controlling the direction of the light beams that are ultimately output from the light source control device 520 in the predetermined axial direction.

Moreover, while the z coordinate position of the field lens 501 is set to be between the vertical diffuser 106 and the video-displaying transmissive display 107, similarly, there is no limitation thereto so as long as the arranged position can satisfy the foregoing objective.

In addition, with regard to the shape of the field lens 501 also, the shape is not limited to a rectangle and may be variously modified so as long as the viewable range can be expanded in a video display device which allows a viewer to enjoy a stereoscopic view by controlling the direction of the light beams that are ultimately output from the light source control device 520 in the predetermined axial direction.

The expansion effect of the viewable range based on the field lens 501 is now explained with reference to FIG. 64. FIG. 64 is a schematic diagram explaining the expansion effect of the viewable range based on the field lens 501 shown in FIG. 62. The left side of FIG. 64 is a top view in the case of not disposing the field lens 501, and the right side is a top view in the case of disposing the field lens 501 between the vertical diffuser 106 and the video-displaying transmissive display 107.

As shown on the left side of FIG. 64, when the field lens 501 is not disposed, the viewable area BA1 (hatched area in the diagram) is determined based on the maximum horizontal deflection angle φ′_{MAX} of the deflector 103. Meanwhile, when the field lens 501 is disposed as in this embodiment, as shown on the right side of FIG. 64, the light beams, upon passing through the field lens 501, are additionally deflected in the origin direction in the x axis direction. Consequently, the viewable area BA2 (hatched area in the diagram) is expanded, and the minimum viewing distance is shortened.

Based on the foregoing configuration, in this embodiment, by disposing the field lens 501 between the vertical diffuser 106 and the video-displaying transmissive display 107 and changing the travelling direction of the diffused light that was diffused by the vertical diffuser 106, the diffused light can be condensed at an angle that is greater than the maximum horizontal deflection angle φ′_{MAX} of the deflector 103 and, therefore, it is possible to expand the range that the diffused light can be irradiated and expand the viewable area where the viewer can enjoy a stereoscopic view, as well as shorten the minimum viewing distance.

The configuration of expanding the viewable range in Embodiment 5 was explained above with reference to FIG. 62 to FIG. 64. Note that, in this embodiment, while the field lens 501 was added to Embodiment 1, the viewable range can also be expanded by adding the field lens 501 to Embodiments 2 to 4.

### Embodiment 6

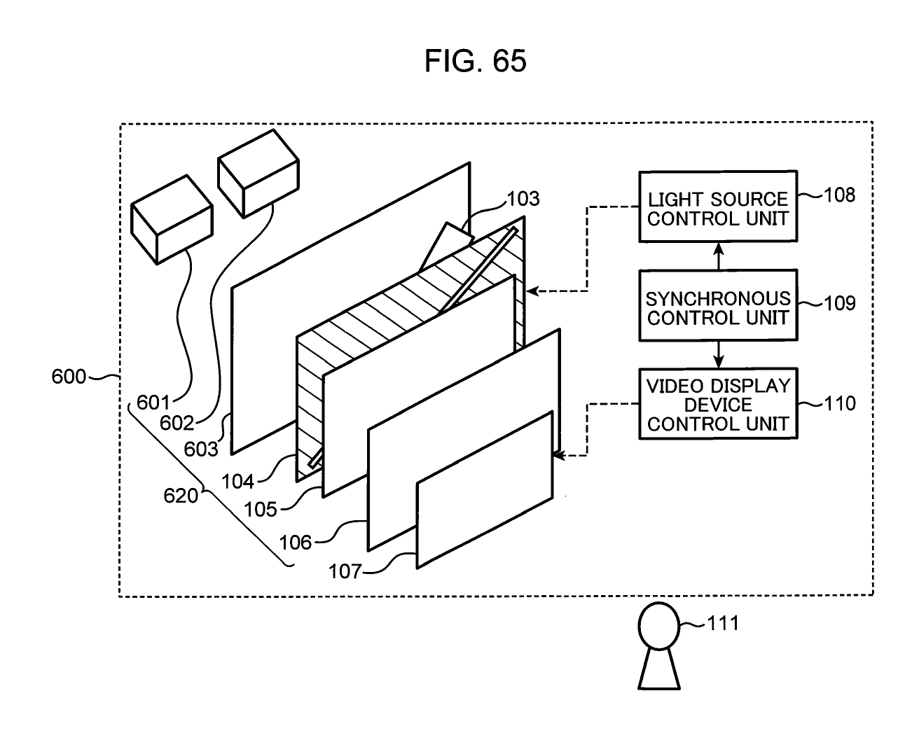

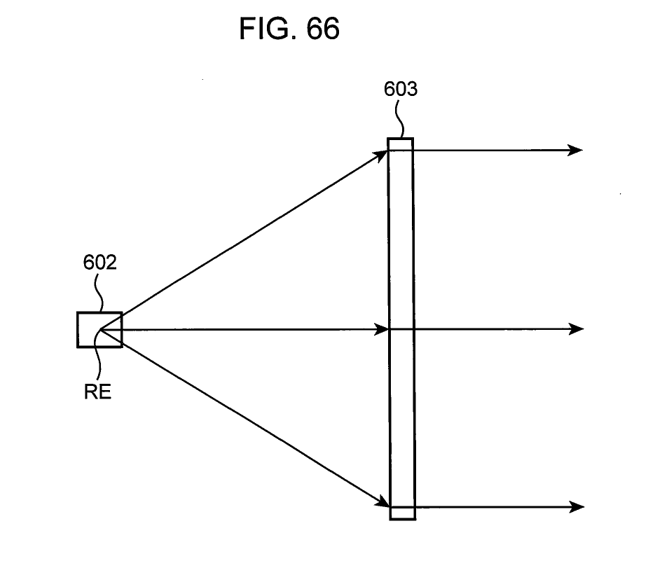

The configuration of the video display device in Embodiment 6 of the present invention is now explained with reference to FIG. 65 and FIG. 66. FIG. 65 is a schematic perspective view schematically showing the configuration of the video display device in Embodiment 6 of the present invention.

In FIG. 65, the video display device 600 comprises a light source control device 620, a video-displaying transmissive display 107, a synchronous control unit 109, and a video display device control unit 110. The light source control device 620 comprises a laser light source 601, a mirror 602 in which the reflection direction can be controlled, a lens 603, a deflector 103, a slit 104, a vertical diffuser 105, a vertical diffuser 106, and a light source control unit 108. The light source unit is configured from the laser light source 601, the mirror 602, and the lens 603, the light source unit is configured such that a plurality of parallel beams can be emitted from the emission face, and emits parallel beams from an arbitrary position of the emission face.

This embodiment adopts a different light source unit and, while this embodiment is basically the same as Embodiment 1, this embodiment replaces the light source unit capable of designating the light beam emitting position and which was realized with the surface light source 101 which emits parallel beams and the mask pattern part 102 with a light source unit which is configured from a laser light source 601, a mirror 602 in which the reflection direction can be controlled, and a lens 603.

The laser light source 601 emits laser beams to the mirror 602. The mirror 602 is disposed at the focal position of the lens 603, and configured such that the reflection direction of the laser beams that entered from the laser light source 601 can be changed. In this embodiment, for instance, a Galvano mirror is used as the mirror 602, but without limitation thereto, any device may be used so as long as it can reflect the entering light beam at a designated angle faster than the screen rewriting rate of the video-displaying transmissive display 107.

The lens 603 converts the laser beams from the mirror 602 into parallel beams and emits the converted parallel beams to the deflector 103. In this embodiment, for example, while a Fresnel lens is used, without limitation thereto, a standard spherical lens or the like may also be used.

The light source control unit 108 controls the laser light source 601 and the mirror 602 and changes the angle of the reflective surface of the mirror 602, and thereby changes the reflection direction of the laser beams and changes the emitting positions of the parallel beams emitted from the lens 603. Specifically, the light source control unit 108 controls the movement pattern of the mirror 602, the mirror 602 emits the light beams at an arbitrary position on the lens 603, and the lens 603 emits the parallel beams in a pattern of an arbitrary shape to the deflector 103.

In this embodiment, the lens 603 has a rectangular area with a width w18 and a height h18, and the thickness thereof is t18. When the z coordinate of the entrance plane of the lens 603 is z18, then z18=0 is satisfied. Here, when the z coordinate of the deflector 103 is z19, then z19≧z18+t18. Note that the constituent elements having a greater z coordinate than the deflector 103 are arranged in accordance with Embodiment 1.

FIG. 66 is a schematic diagram showing the configuration of the mirror 602 and the lens 603 shown in FIG. 65. Note that, in FIG. 66, while the illustration of the laser light source 601 is omitted, with regard to the laser light source 601, the relative positional relation of the laser light source 601 and the mirror 602 may be determined so that light beams can be emitted from the mirror 602 into a designated area of the lens 603.

Here, by placing the reflecting point RE of the mirror 602 at the focal position on the light beam entrance side of the lens 603, all light beams that are emitted from the mirror 602 pass through the lens 603, and thereafter become parallel beams that are perpendicular to the emitting-side plane of the lens 603. Here, by changing the direction of the mirror 602 and controlling the emitting direction of the light beams, it is possible to emit parallel beams that are perpendicular to the principal plane of the lens from an arbitrary position on the emitting-side plane of the lens 603.

Based on the foregoing configuration, since the parallel beams shown in FIG. 15 in Embodiment 1 can also be emitted in this embodiment, the viewer 111 can view a video displayed on the video-displaying transmissive display 107 from the viewpoint position as with Embodiment 1. Moreover, with regard to a stereoscopic view also, by changing the direction of the mirror 602 at a speed that is faster than the screen rewriting rate of the video-displaying transmissive display 107 in accordance with the display timing of the left and right parallax videos of the video-displaying transmissive display 107 and forming the exit pupil at the left/right eye positions, a stereoscopic view can be realized as with Embodiment 1. In other words, by using the foregoing light source unit, this embodiment can also allow a viewer to enjoy a stereoscopic view as with the light source unit used in Embodiment 1.

Note that, in this embodiment, while the explanation was provided with reference to a light source unit that is different from that of Embodiment 1, the same effects can be yielded by also using this light source unit in the configurations of Embodiments 2 to 5.

Moreover, while the reflecting point RE of the mirror 602 changes slightly depending on which way the mirror 602 is facing, in such a case the position near the gravity center of the range of change may be set as the reflecting point RE.

Moreover, in this embodiment, while the lens 603 is arranged such that the width direction of the rectangular area is parallel to the x axis and the height direction is parallel to the y axis and the center of the rectangular area passes through the z axis, there is no particular limitation to the foregoing arrangement method and may be variously modified so as long as the viewable range can be expanded in a video display device which allows a viewer to enjoy a stereoscopic view by controlling the direction of the light beams that are ultimately output from the light source control device 620 in the predetermined axial direction.

In addition, with regard to the shape of the lens 603 also, the shape is not limited to a rectangle and may be variously modified so as long as the viewable range can be expanded in a video display device which allows a viewer to enjoy a stereoscopic view by controlling the direction of the light beams that are ultimately output from the light source control device 620 in the predetermined axial direction.

### Embodiment 7

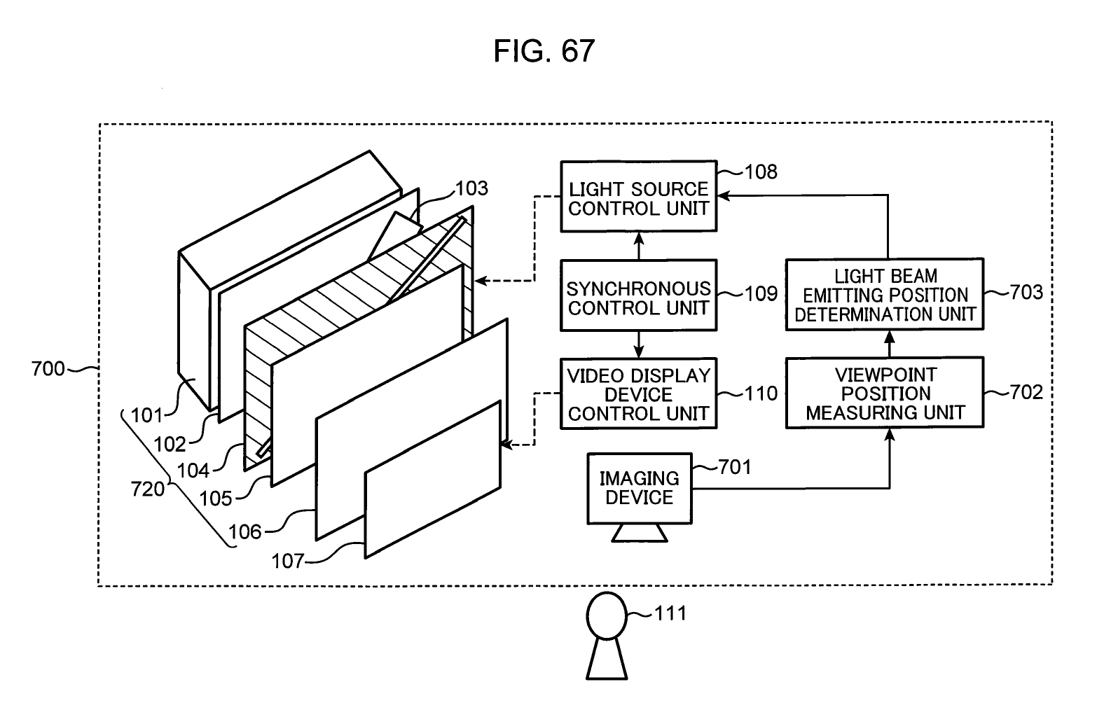

The configuration of the video display device in Embodiment 7 of the present invention is now explained with reference to FIG. 67. FIG. 67 is a schematic perspective view schematically showing the configuration of the video display device in Embodiment 7 of the present invention.

In FIG. 67, the video display device 700 comprises a light source control device 720, a video-displaying transmissive display 107, a synchronous control unit 109, a video display device control unit 110, an imaging device 701, a viewpoint position measurement unit 702, and a light beam emitting position determination unit 703. The light source control device 720 comprises a surface light source 101 for emitting parallel beams, a mask pattern part 102, a deflector 103, a slit 104, a vertical diffuser 105, a vertical diffuser 106, and a light source control unit 108.

This embodiment differs from Embodiment 1 with respect to the point that the mask pattern of the mask pattern part 102 is changed to match the movement of the viewer 111 by measuring the viewpoint position of the viewer 111, and the exit pupil forming position is dynamically changed. Thus, while this embodiment is basically the same as Embodiment 1, this embodiment differs from Embodiment 1 with respect to the point that an imaging device 701, a viewpoint position measurement unit 702 and a light beam emitting position determination unit 703 have been added.

The imaging device 701 is a camera comprising, for example, a CCD (Charge Coupled Device) or a CMOS (Complementary Metal Oxide Semiconductor), and a lens, and captures the viewable area of the video display device 700, and outputs the captured image to the viewpoint position measurement unit 702.

The viewpoint position measurement unit 702 detects, for instance, the left/right pupil positions of one or more persons (for instance, the viewer 111) appearing in the captured image acquired from the imaging device 701, and, as the left and right viewpoint positions, sends the left/right pupil positions of the viewer 111 to the light beam emitting position determination unit 703.

The light beam emitting position determination unit 703 determines the light beam emitting position for forming the exit pupil at the left and right viewpoint positions of the viewer 111, and, in accordance with the mode of the light source unit, sends, to the light source control unit 108, information for emitting light beams to the light beam emitting position. For example, in the case of the light source unit in Embodiment 1, the light beam emitting position determination unit 703 sends the mask pattern for determining the light beam emitting position to the light source control unit 108, and, in the case of the light source unit in Embodiment 6, creates a mirror movement pattern and sends the created mirror movement pattern to the light source control unit 108.

Based on the foregoing configuration, since the exit pupil forming position can be changed according to the left/right pupil positions of viewer 111 who moved, a stereoscopic view can be realized even when the viewer 111 moves.

Note that, in this embodiment, while the imaging device 701, the viewpoint position measurement unit 702, and the light beam emitting position determination unit 703 were added to the configuration of Embodiment 1, the exit pupil forming position can also be dynamically changed similar to the above by adding the imaging device 701, the viewpoint position measurement unit 702, and the light beam emitting position determination unit 703 to the configurations of Embodiments 2 to 6.

Moreover, preferably, the viewpoint position measurement unit 702 measures the visual line direction of the viewer in addition to the left/right pupil positions of the viewer. In the foregoing case, it is possible to display a video that matches the measured visual line direction.

Moreover, preferably, the viewpoint position measurement unit 702 measures the gazing position of the viewer in addition to the left/right pupil positions of the viewer, and the light source control unit 108 controls the surface light source 101 or the laser light source 601 so that the brightness of the screen other than the gaze point of the video-displaying transmissive display 107 is lowered according to the gazing position of the viewer measured by the viewpoint position measurement unit 702.

In the foregoing case, since the brightness of the screen other than the gaze point can be lowered to an extent which will not cause the viewer to feel any discomfort upon viewing the video displayed on the video-displaying transmissive display 107 based on the gazing position measured by the viewpoint position measurement unit 702 and the visual characteristics of human beings, the power consumption of the device can be reduced.

Moreover, preferably, the viewpoint position measurement unit 702 measures the gazing position of the viewer in addition to the left/right pupil positions of the viewer, and the light source control unit 108 determines whether the viewer is facing the direction of the video-displaying transmissive display 107 based on the gazing position of the viewer measured by the viewpoint position measurement unit 702, and lowers the output of the light beam emitted from the surface light source 101 or the laser light source 601 when the viewer is not facing the direction of the video-displaying transmissive display 107.

In the foregoing case, since the light beam output emitted from the surface light source 101 or the laser light source 601 can be lowered when the viewer is facing a direction other than the video-displaying transmissive display 107, the power consumption of the device can be reduced by lowering the brightness of the overall screen.

Moreover, preferably, the viewpoint position measurement unit 702 measures the gazing position of the viewer in addition to the left/right pupil positions of the viewer, and the light source control unit 108 determines whether the viewer is facing the direction of the video-displaying transmissive display 107 based on the gazing position of the viewer measured by the viewpoint position measurement unit 702, and turns OFF the parallel beams emitted from the surface light source 101 or the laser light source 601 when the viewer is not facing the direction of the video-displaying transmissive display 107.

In the foregoing case, since the light beams emitted from the surface light source 101 or the laser light source 601 can be turned OFF when the viewer is facing a direction other than the video-displaying transmissive display 107, the power consumption of the device can be reduced.

Based on each of the embodiments described above, the present invention can be summarized as follows. In other words, the light source control device according to the present invention is a light source control device for controlling a direction of a light beam in a predetermined first axial direction, comprising a light source unit which emits parallel beams from an arbitrary position along a second axial direction which is orthogonal to the first axial direction, a light source control unit which controls an emitting position of the parallel beams of the light source unit, one or more deflectors which deflects the parallel beams emitted from the light source unit, and a first diffuser which diffuses the light beam, deflected by the deflector, in a third axial direction which is orthogonal to the first axial direction and the second axial direction, wherein the deflector is disposed to be tilted relative to the first axial direction, and yields a different deflection operation in a first element direction which is orthogonal to the deflector's own optical axis direction and in a second element direction which is orthogonal to both the optical axis direction and the first element direction.

In this light source control device, since a deflector which yields a different deflection operation in a first element direction which is orthogonal to that deflector's own optical axis direction, and in a second element direction which is orthogonal to both the optical axis direction and the first element direction, is disposed in a manner of being tilted relative to the first axial direction, the direction of the light beam emitted from the deflector in the first axial direction can be changed by changing the entrance position of the parallel beams of the deflector. Here, since the entrance position of the parallel beams of the deflector can be controlled by controlling the emitting position of the parallel beams, the direction of the light beam in the first axial direction can be controlled according to the emitting position of the parallel beams, and the light beam in which its direction in the first axial direction was controlled can be diffused in the third axial direction.

Accordingly, since the foregoing light source control device can emit a light beam that diffuses in the third axial direction; for instance, the vertical direction, while controlling the direction in the first axial direction; for instance, the horizontal direction, when a video display device is configured from this light source control device and a display unit for displaying images, the exit pupil of vertical striped light beams emitted from the display unit can be simultaneously formed at the left/right viewpoint positions of a plurality of viewers. Consequently, a plurality of viewers can view a 3D video, without restriction, in the same manner as a 2D video display without having to use glasses or the like.

Desirably, the light source control device further comprises a first mirror which is disposed on a left-side face and a right-side face of the light source control device, and reflects the light beam emitted from the deflector into the device. In the foregoing case, the horizontal width of the overall device can be shortened.

Desirably, the light source control device further comprises a second mirror which is disposed on an upper face and a bottom face of the light source control device, and reflects the light beam emitted from the deflector into the device. In the foregoing case, the utilization efficiency of the light source can be enhanced.

Desirably, the light source unit includes a laser light source, a mirror configured to receive a laser beam from the laser light source and to be able to change a reflection direction of the laser beam, and a lens which converts the laser beam from the mirror into parallel beams, and the mirror is disposed at a focal position of the lens, and the light source control unit changing an emitting position of the parallel beams emitted from the lens by controlling the mirror and changing the reflection direction of the laser beam.

In the foregoing case, since the emitting position of the parallel beams emitted from the lens is changed by controlling the mirror and changing the reflection direction of the laser beam, vertical parallel beams can be emitted to the principal plane of the lens from an arbitrary position on the emitting side of the lens.

Desirably, the light source unit includes a surface light source which emits the parallel beams, and a mask pattern part which includes an opening and a light shielding part, and is configured such that a position of the opening is able to arbitrarily changed, and the light source control unit may change an emitting position of the parallel beams emitted from the mask pattern part by changing a position of the opening of the mask pattern part.

In the foregoing case, by changing the position of the opening of the mask pattern part, vertical parallel beams can be emitted to the principal plane of the mask pattern part from an arbitrary position of the mask pattern part.

Desirably, the light source control unit causes a diffusion distribution of a light beam emitted from the first diffuser to be uniform by gradually changing an aperture ratio of the opening of the mask pattern part.

In the foregoing case, by configuring a video display device from the foregoing light source control device and a display unit for displaying images, it is possible to alleviate the discontinuity of brightness on the display unit, and reduce the sense of uneven brightness felt by the viewer.

Desirably, the deflector includes a cylindrical lens having a curvature only in the first element direction. In the foregoing case, based on a simple configuration, the direction of the parallel beams in the first axial direction can be changed according to the emitting position of the parallel beams.

Desirably, the deflector includes a deflector array in which a plurality of cylindrical lenses having a curvature only in the first element direction are disposed in an array. In the foregoing case, since a plurality of parallel beams are emitted from a plurality of cylindrical lenses and the number of light beams emitted from the first diffuser is increased, the depth of the device can be shortened without having to increase the divergence angle of the first diffuser.

Desirably, the light source control device further comprises a slit which is disposed between the cylindrical lens and the first diffuser, and allows only a light beam passing near a focal position of the cylindrical lens, of the light beams emitted from the cylindrical lens, to pass through. In the foregoing case, it is possible to eliminate the influence of stray light that is generated from internal reflection and the like in the cylindrical lens.

Desirably, the first diffuser is disposed at a position for diffusing only the light beam that passed through the slit. In the foregoing case, since it is possible to diffuse light beams from which unwanted stray light has been eliminated, it is possible to generate light beams that are suitable for displaying a 3D video.

Desirably, the light source control device further comprises a second diffuser for additionally diffusing the light beam diffused by the first diffuser, in the third axial direction. In the foregoing case, since the light beam that was diffused by the first diffuser is additionally diffused in the third axial direction, by configuring a video display device from the foregoing light source control device and a display unit for displaying images, the overall screen of the display unit can be irradiated uniformly.

Desirably, the mask pattern part includes a transmissive display. In the foregoing case, it is possible to dynamically switch an arbitrary area of the transmissive display between an opening and a shielding part, generate a mask pattern of an intended shape and emit parallel beams from the opening of the mask pattern.

Desirably, the light source control unit stops the irradiation of the parallel beams from the surface light source during a screen transition which occurs upon changing the position of the opening and the light shielding part of the transmissive display, and resumes the irradiation of the parallel beams from the surface light source after the screen transition of the transmissive display is complete. In the foregoing case, it is possible to prevent unstable light beams from being emitted during screen transition.

The video display device according to the present invention comprises any one of the foregoing light source control devices, a second diffuser which additionally diffuses the light beam diffused by the first diffuser, in the third axial direction, and a display unit which displays images by using diffused light emitted from the second diffuser, wherein the light source control unit controls an emitting position of the parallel beams emitted from the light source unit so that the diffused light condenses at a viewpoint position of a viewer after passing through the display unit.

In this video display device, since the overall screen is uniformly irradiated with diffused light, and the emitting position of the parallel beams emitted from the light source unit is controlled so that the diffused light condenses at a viewpoint position of a viewer after passing through the display unit, the exit pupil of vertical striped light beams emitted from the display unit can be simultaneously formed at the left/right viewpoint positions of a plurality of viewers, and a plurality of viewers can view a 3D video, without restriction, in the same manner as a 2D video display without having to use glasses or the like.

Desirably, when a horizontal direction and a vertical direction are defined based on a video display screen of the display unit, and a focal length of the deflector is f1, a length of a direction in which the deflector has a curvature is cw, a length of the display unit in the vertical direction is H, a length of the display unit in the horizontal direction is W, and a preferred viewing distance which is predetermined based on a resolution of the display unit is Vd, a tilt angle θ of the deflector relative to the horizontal direction satisfies a following formula.

sin⁻¹((f1×W)/(cw×Vd))≦θ≦cos⁻¹(cw/H)

In the foregoing case, a viewer can view the overall video display screen of the display unit within the viewing area, and view a video that matches the resolution of the display unit.

Desirably, the video display device further comprises a display control unit which controls the display unit, and a synchronous control unit which controls a synchronous operation of the light source control unit and the display control unit, and the light source control unit controls an emitting position of the parallel beams of the light source unit so that the diffused light condenses at a left eye and a right eye of the viewer by switching the condensing position of the diffused light based on time division, and the display control unit controls the display unit to display a parallax image corresponding to the condensing position in synchronization with the switching of the condensing position by the light source control unit.

In the foregoing case, since an emitting position of the parallel beams of the light source unit is controlled so that the diffused light condenses at a left eye and a right eye of the viewer and a parallax image corresponding to the condensing position is displayed in synchronization with the switching of the condensing position, the exit pupil of vertical striped light beams emitted from the display unit can be simultaneously formed at the left/right viewpoint positions of a plurality of viewers, and a plurality of viewers can view a 3D video, without restriction, in the same manner as a 2D video display without having to use glasses or the like.

Desirably, the video display device further comprises a measurement unit which measures left/right pupil positions of the viewer, and a determination unit which determines a light beam emitting position of the light source unit according to the left/right pupil positions measured by the measurement unit, and the light source control unit controls an emitting position of the parallel beams of the light source unit so that the parallel beams are emitted from the light beam emitting position determined by the determination unit.

In the foregoing case, since the exit pupil forming position can be changed according to the left/right pupil positions of a viewer who moved, a stereoscopic view can be realized even when the viewer moves.

Desirably, the video display device further comprises a travelling direction changing element which is disposed between the second diffuser and the display unit, and changes the travelling direction of the diffused light that was diffused by the second diffuser. In the foregoing case, since the range that the diffused light can be irradiated can be expanded by changing the travelling direction of the diffused light, it is possible to expand the viewable range that the viewer can enjoy a stereoscopic view, as well as shorten the minimum viewing distance.

Desirably, the video display device broadens the width of the diffused light to be equal to or wider than the pupil distance of the viewer. In the foregoing case, the viewer can view a brighter video.

Desirably, the opening of the mask pattern part is a full-face opening. In the foregoing case, the video of the display unit can be viewed within the direction control range of the diffused light.

Desirably, the video display device broadens the width of the striped light beams formed by the diffused light to be equal to or wider than the pupil distance of the viewer, and displays the same video, as the video to be displayed on the display unit, regardless of the condensing position. In the foregoing case, a bright 2D video can be displayed even with the condensing position control based on time division.

Desirably, the measurement unit measures the visual line direction of the viewer in addition to the left/right pupil positions of the viewer. In the foregoing case, it is possible to display a video that matches the measured visual line direction.

Desirably, the measurement unit measures the gazing position of the viewer in addition to the left/right pupil positions of the viewer, and the light source control unit controls the light source unit so that the brightness of the screen other than the gaze point of the display unit is lowered according to the gazing position of the viewer measured by the measurement unit.

In the foregoing case, since the brightness of the screen other than the gaze point can be lowered to an extent which will not cause the viewer to feel any discomfort upon viewing the video displayed on the display unit based on the gazing position measured by the measurement unit and the visual characteristics of human beings, the power consumption of the device can be reduced.

Desirably, the measurement unit measures the gazing position of the viewer in addition to the left/right pupil positions of the viewer, and the light source control unit determines whether the viewer is facing the direction of the display unit based on the gazing position of the viewer measured by the measurement unit, and lowers the output of the light beam emitted from the light source unit when the viewer is not facing the direction of the display unit.

In the foregoing case, since the light beam output emitted from the light source unit can be lowered when the viewer is facing a direction other than the display unit, the power consumption of the device can be reduced by lowering the brightness of the overall screen.

Desirably, the measurement unit measures the gazing position of the viewer in addition to the left/right pupil positions of the viewer, and the light source control unit determines whether the viewer is facing the direction of the display unit based on the gazing position of the viewer measured by the measurement unit, and turns OFF the parallel beams emitted from the light source unit when the viewer is not facing the direction of the display unit.

In the foregoing case, since the parallel beams emitted from the light source unit can be turned OFF when the viewer is facing a direction other than the display unit, the power consumption of the device can be reduced.

### INDUSTRIAL APPLICABILITY

Since the light source control device and the video display device according to the present invention enable a viewer to view a 3D video, without restriction, in the same manner as a 2D video display without having to use glasses or the like, the present invention can be applied to a video display device such as a display, and to a light source control device that is used in such a video display device.

1. A light source control device for controlling a direction of a light beam in a predetermined first axial direction, comprising:
a light source unit which emits parallel beams from an arbitrary position along a second axial direction which is orthogonal to the first axial direction;
a light source control unit which controls an emitting position of the parallel beams of the light source unit;
one or more deflectors which deflects the parallel beams emitted from the light source unit; and
a first diffuser which diffuses the light beam, deflected by the deflector, in a third axial direction which is orthogonal to the first axial direction and the second axial direction,
wherein the deflector is disposed to be tilted relative to the first axial direction, and yields a different deflection operation in a first element direction which is orthogonal to the deflector's own optical axis direction and in a second element direction which is orthogonal to both the optical axis direction and the first element direction.

2. The light source control device according to claim 1, further comprising:
a first mirror which is disposed on a left-side face and a right-side face of the light source control device, and reflects the light beam emitted from the deflector into the device.

3. The light source control device according to claim 1, further comprising:
a second mirror which is disposed on an upper face and a bottom face of the light source control device, and reflects the light beam emitted from the deflector into the device.

4. The light source control device according to claim 1,
wherein the light source unit includes:
a laser light source;
a mirror configured to receive a laser beam from the laser light source and to be able to change a reflection direction of the laser beam; and
a lens which converts the laser beam from the mirror into parallel beams,
wherein the mirror is disposed at a focal position of the lens, and
wherein the light source control unit changes an emitting position of the parallel beams emitted from the lens by controlling the mirror to change the reflection direction of the laser beam.

5. The light source control device according to claim 1,
wherein the light source unit includes:
a surface light source which emits the parallel beams; and
a mask pattern part which includes an opening and a light shielding part, and is configured such that a position of the opening is able to be arbitrarily changed,
wherein the light source control unit changes an emitting position of the parallel beams emitted from the mask pattern part by changing a position of the opening of the mask pattern part.

6. The light source control device according to claim 5,
wherein the light source control unit causes a diffusion distribution of a light beam emitted from the first diffuser to be uniform by gradually changing an aperture ratio of the opening of the mask pattern part.

7. The light source control device according to claim 1,
wherein the deflector includes a cylindrical lens having a curvature only in the first element direction.

8. The light source control device according to claim 1,
wherein the deflector includes a deflector array in which a plurality of cylindrical lenses having a curvature only in the first element direction are disposed in an array.

9. The light source control device according to claim 7, further comprising:
a slit which is disposed between the cylindrical lens and the first diffuser, and allows only a light beam passing near a focal position of the cylindrical lens, of the light beams emitted from the cylindrical lens, to pass through.

10. The light source control device according to claim 9,
wherein the first diffuser is disposed at a position for diffusing only the light beam that passed through the slit.

11. The light source control device according to claim 1, further comprising:
a second diffuser for additionally diffusing the light beam, diffused by the first diffuser, in the third axial direction.

12. A video display device, comprising:
the light source control device according to claim 1;
a second diffuser which additionally diffuses the light beam, diffused by the first diffuser, in the third axial direction; and
a display unit which displays images by using diffused light emitted from the second diffuser,
wherein the light source control unit controls an emitting position of the parallel beams emitted from the light source unit so that the diffused light condenses at a viewpoint position of a viewer after passing through the display unit.

13. The video display device according to claim 12,
wherein, when a horizontal direction and a vertical direction are defined based on a video display screen of the display unit, and a focal length of the deflector is f1, a length of a direction in which the deflector has a curvature is cw, a length of the display unit in the vertical direction is H, a length of the display unit in the horizontal direction is W, and a preferred viewing distance which is predetermined based on a resolution of the display unit is Vd, a tilt angle θ of the deflector relative to the horizontal direction satisfies a following formula:
sin⁻¹((f1×W)/(cw×Vd))≦θ≦cos⁻¹(cw/H).

14. The video display device according to claim 12, further comprising:
a display control unit which controls the display unit; and
a synchronous control unit which controls a synchronous operation of the light source control unit and the display control unit,
wherein the light source control unit controls an emitting position of the parallel beams of the light source unit so that the diffused light condenses at a left eye and a right eye of the viewer by switching the condensing position of the diffused light based on time division, and
wherein the display control unit controls the display unit to display a parallax image corresponding to the condensing position in synchronization with the switching of the condensing position by the light source control unit.

15. The video display device according to claim 12, further comprising:
a measurement which measures left/right pupil positions of the viewer; and
a determination unit which determines a light beam emitting position of the light source unit according to the left/right pupil positions measured by the measurement unit,
wherein the light source control unit controls an emitting position of the parallel beams of the light source unit so that the parallel beams are emitted from the light beam emitting position determined by the determination unit.
